(19) United States
(12) Patent Application Publication
(10) Pub. No.: US 2026/0206719 A1
(43) Pub. Date: Jul. 23, 2026

(54) ANIMAL CONTAINMENT UNIT FOR A VEHICLE

(71) Applicant: JANI INTERNATIONAL PTE. LTD., Singapore (SG)

(72) Inventors: Joshua FERGUSON, Morgantown, PA (US); Clyde S. HARMES, Morgantown, PA (US); Patrick J.G. BOWERS, Morgantown, PA (US); Curtis M. Hartenstine, Morgantown, PA (US)

(21) Appl. No.: 19/138,564

(22) PCT Filed: Dec. 14, 2023
(86) PCT No.: PCT/US2023/084051

§ 371 Date: Jun. 12, 2025

Related U.S. Application Data
(60) Provisional application No. 63/476,842, filed on Dec. 22, 2022.
(60) Provisional application No. 63/502,812, filed on May 17, 2023.
(60) Provisional application No. 63/512,037, filed on Jul. 5, 2023.
(60) Provisional application No. 63/512,671, filed on Jul. 10, 2023.

(51) Int. Cl. A01K 1/02

(52) U.S. Cl. CPC A01K 1/0272

(57) ABSTRACT

A unit is for containing animals on a seat of a vehicle includes a base structure includes a base. The unit also includes a frame structure having a front member coupled to a front portion of base, a rear member coupled to a rear portion of the base, and containment materials extending at least partially about the frame structure. A webbing structure includes at least first and second spans of webbing. Each of the spans has a first end coupled to a first anchor point at the base structure and extends about an exterior of the frame structure and wraps around the front member. A second end of each of the spans is configured to couple to a rigid connection on or adjacent to the seat of the vehicle so that the webbing extends about the frame structure along a desired path to restrain a pet contained within the unit.

### CROSS REFERENCE TO RELATED APPLICATIONS

This application claims the benefit of U.S. Application No. 63/476,842, filed on Dec. 22, 2022; U.S. Application No. 63/502,812, filed on May 17, 2023; U.S. Application No. 63/512,037, filed on Jul. 5, 2023; and U.S. Application No. 63/512,671, filed on Jul. 10, 2023, which is incorporated herein by reference in its entirety.

### FIELD

The present disclosure relates to a containment unit or carrier for an animal for installation in a vehicle.

### BACKGROUND

A crate or another type of carrier can be used to transport animals in a vehicle. However, many existing carriers suffer from various deficiencies. For example, some carriers are insufficiently strong to contain and protect the animal in the event of a car crash, particularly larger animals. In another example, some carriers are difficult to ship, transport, or store outside of the vehicle. In still another example, some carriers are difficult to install in the vehicle.

### SUMMARY

According to an embodiment, a unit for containing animals on a seat of a vehicle includes a base structure including a base, the base including a front portion and a rear portion; a frame structure including a front member coupled to the front portion of base; a rear member coupled to the rear portion of the base; and containment materials extending at least partially about the frame structure. The unit also includes a webbing structure including at least first and second spans of webbing, each of the spans including a first end coupled to a respective first anchor point defined by the base structure, the spans extending from the respective first anchor point about an exterior of the frame structure and wrapping around the front member to respective second ends of the spans, the second end of each of the spans being configured to couple to a rigid connection on or adjacent to the seat of the vehicle so that the webbing extends about the frame structure along a desired path configured to restrain a pet contained within the unit.

In addition to one or more of the features described above, or as an alternative, in further embodiments the front member includes a first end coupled to the front portion of the base on a first side and a second end coupled to the front portion of the base on a second side, the front member of the frame structure being shaped in a curve to define in part a front of the unit and define in part a top of the unit and the rear member includes a first end coupled to the rear portion of the base on the first side and a second end coupled to the rear portion of the base on the second side, the rear member of the frame structure being shaped in a curve to define in part a rear of the unit and define in part the top of the unit, wherein the spans extend along a top portion of the containment materials covering the top of the unit to a second end coupled to a second anchor point.

In addition to one or more of the features described above, or as an alternative, in further embodiment the base structure further includes a base frame mounted to the base and wherein the base frame includes a front member and the first ends of the spans of webbing are coupled to the front member of the base frame interior to the base.

In addition to one or more of the features described above, or as an alternative, in further embodiments first ends of the spans of webbing are sewn to the front member of the base frame.

In addition to one or more of the features described above, or as an alternative, in further embodiments the containment materials include front containment materials defining in part the front of the unit and supported at least in part by the front member of the frame structure, a front potion of the containment materials covering the front of the unit, the front portion of the containment materials including an exterior surface and an interior surface, the unit further including a top portion of the containment materials covering the top of the unit and supported at least in part by the front member and the rear member of the frame structure.

In addition to one or more of the features described above, or as an alternative, in further embodiments the spans of webbing are woven through at least part of the front containment materials so that a portion the spans are exterior to the exterior surface of the front containment materials and a further portion of the spans are interior to the exterior surface of the front containment materials.

In addition to one or more of the features described above, or as an alternative, in further embodiments the containment materials comprise at least two layers and the spans of webbing are woven through a first one of the layers and are not woven through a second one of the layers.

In addition to one or more of the features described above, or as an alternative, in further embodiments the spans wrap around an exterior surface of the front member of the base frame.

In addition to one or more of the features described above, or as an alternative, in further embodiments the frame structure further includes a first middle member and a second middle member, each having a first end coupled to the front member and a second end coupled to the rear member, the first and second middle members being exterior to an exterior surface of the containment materials, and wherein the first span of webbing extends across the exterior surface of the containment materials along the first middle member and the second span of webbing extends across the exterior surface of the containment materials along the second middle member.

In addition to one or more of the features described above, or as an alternative, in further embodiments the first middle members and the second middle member of the frame structure each include ring structures through which the spans of webbing are run.

In addition to one or more of the features described above, or as an alternative, in further embodiments the first middle members and the second middle member of the frame structure each comprise a front middle member and a rear middle member detachable via a sliding actuator, the sliding actuator being translatable between a first position, where the sliding actuator is slid over the front middle member and detaches from the rear middle member, and a second position, where the sliding actuator is slid over the rear middle member and attaches the front middle member and the rear middle member, and wherein, when the sliding actuator is translated, the ring structures of the sliding actuator slide over the spans of webbing.

In addition to one or more of the features described above, or as an alternative, in further embodiments including a tether structure including at least two spans, each of the spans of the tether structure having a first end coupled to the rear member, the second ends of the spans joining together at a joint, the tether structure further including a unitary span extending from a first end at the joint to a second end on which a tether latch is adjustably positioned, wherein the tether latch is configured to attach to the rigid connection on or adjacent to the seat of the vehicle.

In addition to one or more of the features described above, or as an alternative, in further embodiments the first ends of the spans of the tether structure are adjacent to the second ends of the spans of webbing.

In addition to one or more of the features described above, or as an alternative, in further embodiments the first ends of the spans of the tether structure are sewn around the rear member.

In addition to one or more of the features described above, or as an alternative, in further embodiments the first ends of the spans of webbing are coupled to rigid brackets at the rear portion of the base.

In addition to one or more of the features described above, or as an alternative, in further embodiments the spans extend from the first end interior to the base structure, wrap around a front portion of the base structure and continue exterior to the exterior surface of a front portion of the containment materials covering the front of the unit.

In addition to one or more of the features described above, or as an alternative, in further embodiments the rigid connection on or adjacent to the seat of the vehicle is a first rigid connection, the unit further including latches coupled to the frame structure, the latches being configured to couple the frame structure to a second rigid connection on or adjacent to the seat of the vehicle.

In addition to one or more of the features described above, or as an alternative, in further embodiments the second rigid connection is spaced from the first rigid connection.

In addition to one or more of the features described above, or as an alternative, in further embodiments the second ends of the first and second spans of webbing are configured to directly couple to the rigid connection on or adjacent to the seat of the vehicle.

According to an embodiment, a unit for containing animals on a seat of a vehicle includes a base structure including a base, the base including a front portion and a rear portion; and a frame structure that transitions between an expanded state and a collapsed state. The frame structure includes a front member having a first end and a second end, the first and second ends of the front member being rotatably coupled to the front portion of the base, the front member being shaped to define in part a front of the unit and define in part a top of the unit when the frame structure is in the expanded state, a rear member having a first end and a second end, the first and second ends of the rear member being rotatably coupled to the rear portion of the base, the rear member being shaped to define in part a rear of the unit and define in part the top of the unit when the frame structure is in the expanded state, at least one middle member including a first end rotatably coupled to either the front member or the rear member via a rotating joint and a second end that, when the frame structure is in the expanded state, is attached to a corresponding part of the frame structure such that a connection is made between the front member and the rear member via the at least one middle member and, when the frame structure is to be transitioned into the collapsed state, the front member and the rear member are rotated to a collapsed position in which the at least one middle member is within or substantially flush with the front member or the rear member.

In addition to one or more of the features described above, or as an alternative, in further embodiments when the frame structure is to be transitioned into the collapsed state, the second end of the at least one middle member is detached from the corresponding part of the frame structure.

In addition to one or more of the features described above, or as an alternative, in further embodiments the at least one middle member includes two middle members, each having a front middle member and a rear middle member detachable via a sliding actuator, the sliding actuator being translatable between a first position in which the sliding actuator is slid over the front middle member and detached from the rear middle member, and a second position in which the sliding actuator is slid over the rear middle member and to attach the front middle member to the rear middle member.

In addition to one or more of the features described above, or as an alternative, in further embodiments the sliding actuator includes a first opening and a second opening for receiving a button extending off an exterior of the front middle member, wherein, in the first position, the button is received in the first opening and, in the second position, the button is received in the second opening.

In addition to one or more of the features described above, or as an alternative, in further embodiments including a first front rotating actuator rotatably coupled to the front portion of the base on a first side, a second front rotating actuator rotatably coupled to the front portion of the base on a second side, a first rear rotating actuator rotatably coupled to the rear portion of the base on the first side, and a second rear rotating actuator rotatably coupled to the rear portion of the base on the second side.

In addition to one or more of the features described above, or as an alternative, in further embodiments, after the at least one middle member is brought to the collapsed position, the first and second front rotating actuators are rotated to a stowed position in which the front member is within or flush with the base structure or with the rear member and the first and second rear rotating actuators are rotated to bring the rear member within or flush with the base structure or with the front member.

In addition to one or more of the features described above, or as an alternative, in further embodiments the first and second rear rotating actuators are positioned relative to the base higher than the first and second front rotating actuators so that, when the frame structure is in the collapsed state, the rear member lies flush on top of the front member.

In addition to one or more of the features described above, or as an alternative, in further embodiments the first and second front rotating actuators are lockable in a first position in which the front member of the frame structure extends orthogonally to the base and a second position in which the front member extends parallel to the base and wherein the first and second rear rotating actuators are lockable in a first position in which the rear member of the frame structure extends orthogonally to the base and a second position and wherein the rear member extends parallel to the base.

In addition to one or more of the features described above, or as an alternative, in further embodiments the at least one middle member is detachable from either the front member or the rear member while remaining attached to the other one of the front member or the rear member so that the at least one middle member can be rotated with the rotating joint.

In addition to one or more of the features described above, or as an alternative, in further embodiments the at least one middle member is detachable from either the front member or the rear member via a release actuator mounted to the at least one middle member.

In addition to one or more of the features described above, or as an alternative, in further embodiments the release actuator withdraws at least one pin extending off the at least one middle member from a corresponding recess in the front member or the rear member.

According to an embodiment, a unit for containing animals on a seat of a vehicle includes a base structure including a base and a base frame, the base including a front portion and a rear portion and the base frame including a front member mounted to the front portion of the base and a rear member mounted to the rear portion of the base; and a latch carriage slidably coupled to the front member and the rear member of the base frame so that the latch carriage can translate within the base in a direction parallel to the front and rear members from a first position on a first side of the unit to a second position on a second side of the unit, the latch carriage including latches configured to be rigidly coupled to the unit to anchor points within the vehicle.

In addition to one or more of the features described above, or as an alternative, in further embodiments the latch carriage is slidably coupled to the front member of the base frame via front guides extending from a front member of the latch carriage coupled to the front member of the base frame and the latch carriage is slidably coupled to the rear member of the base frame via rear guides extending from a rear member of the latch carriage coupled to the rear member of the base frame.

In addition to one or more of the features described above, or as an alternative, in further embodiments the latch carriage is translatable relative to the base in a direction parallel to the front and rear members.

In addition to one or more of the features described above, or as an alternative, in further embodiments the base includes a front portion and a rear portion, the front member being arranged at the front portion and the rear member being arranged at the rear portion, the unit includes a first side actuator coupled to the base structure and accessible from an exterior of the unit for locking the latch carriage in a first position so that the latches extend out the rear portion of the base on a first side and a second side actuator coupled to the base structure and accessible from the exterior of the unit for locking the latch carriage in a second position so that the latches extend out the rear portion of the base on a second side. The latch carriage is releasable from the first or second side actuator by pulling the first or second side actuator out relative to the base structure.

In addition to one or more of the features described above, or as an alternative, in further embodiments the first and second side actuators include features for receiving a correspondingly shaped feature of the latch carriage to lock the latch carriage.

In addition to one or more of the features described above, or as an alternative, in further embodiments the latches can be transitioned into an extended position extended out the rear portion of the base frame or a withdrawn position withdrawn into the rear portion of the base frame.

In addition to one or more of the features described above, or as an alternative, in further embodiments the latches are telescopic.

According to an embodiment, a unit for containing animals on a seat of a vehicle includes a base structure including a base, the base including a rear cutout portion; and a latch system mounted in the rear cutout portion of the base and accessible from a bottom of the unit, the latch system including a rod extending across the rear cutout portion and fixed to the base, the latch system further including a plurality of latches slidably and rotatably coupled to the rod for rigidly coupling the unit to the anchor points within the vehicle, wherein the latches are coupled to one another so that a desired distance is maintained between the latches, the latch system further including brackets around the rod for preventing the latches from sliding when the latches are adjacent to the brackets. The latches are positionable in a first position along the rod on a first side of the unit or a second position along the rod on a second side of the unit.

In addition to one or more of the features described above, or as an alternative, in further embodiments the latches are transitionable from a retracted position where the latches are withdrawn into the base to an extended position where the latches are pivoted around the rod and extend out from the base.

In addition to one or more of the features described above, or as an alternative, in further embodiments including a latch release actuator connected to a projection and configured to translate the projection, wherein at least one latch includes a slot for receiving the projection, the latch release actuator being configured so that, when the latch release actuator is actuated, the projection is translated so that the latches are released from the anchor points to which the latches were attached.

In addition to one or more of the features described above, or as an alternative, in further embodiments when the latches are in the extended position, the brackets prevent the latches from sliding along the rod and, when the latches are in the retracted position, the brackets do not prevent the latches from sliding along the rod.

In addition to one or more of the features described above, or as an alternative, in further embodiments the latches are lockable in the retracted position in the base.

In addition to one or more of the features described above, or as an alternative, in further embodiments including a latch unlock actuator in the base structure connected to a projection and configured to translate the projection, wherein a first one of the latches includes a slot for receiving the projection, the latch unlock actuator being configured so that, when the latch unlock actuator is actuated, the projection is translated so that the first latch is released from the retracted position and free to transition into the extended position.

In addition to one or more of the features described above, or as an alternative, in further embodiments the latches are lockable in the extended position in the base.

In addition to one or more of the features described above, or as an alternative, in further embodiments including a latch unlock actuator in the base structure connected to a pin and configured to translate the pin, wherein a first one of the latches includes a hole for receiving the pin, the latch unlock actuator being configured so that, when the latch unlock actuator is actuated, a projection is translated so that the first latch is released from the extended position and free to transition into the retracted position.

According to an embodiment, a unit for containing animals on a seat of a vehicle includes a base structure including a base and a base frame, the base including a front portion and a rear portion and the base frame including a front member mounted to the front portion of the base and a rear member mounted to the rear portion of the base; a latch system coupled to the front member and the rear member of the base frame, the latch system including a plurality of latches configured to releasably couple the unit to anchor points within the vehicle, the latches being mounted to respective medial members slidably coupled to respective side members of the latch system so that the latches can be transitioned between an extended position in which the latches extend out of the rear portion and a retracted position in which the latches are withdrawn into the rear portion; and an actuator coupled to the latch system and accessible from an exterior of the unit for locking the medial members relative to the side members so that the latches are locked in the extended position or the withdrawn position, the actuator being operable to unlock the medial members relative to the side members so that the latches can be transitioned between the extended and withdrawn positions.

In addition to one or more of the features described above, or as an alternative, in further embodiments the actuator is mounted to a front member through the front portion of the base.

In addition to one or more of the features described above, or as an alternative, in further embodiments the latch system is translatable within the base in a direction parallel to the front member of the base frame, wherein a slot is formed in the front portion of the base so that the actuator can translate along with the latch system.

According to an embodiment, unit for containing animals on a seat of a vehicle includes a base structure including a base, the base including a rear portion; and a latch system mounted in the rear portion of the base, the latch system including a rod fixed to the base, the latch system further including latches rotatably coupled to the rod for rigidly coupling the unit to anchor points within the vehicle. The latches are coupled to one another so that a distance is maintained between the latches. The latches can be transitioned from an extended position out the base to a retracted position within the base by rotating the latches about the rod.

In addition to one or more of the features described above, or as an alternative, in further embodiments the latch system further includes brackets around the rod for preventing the latches from sliding when the latches are adjacent to the brackets.

In addition to one or more of the features described above, or as an alternative, in further embodiments the latches are lockable in the retracted position in the base via a lock accessible on a bottom of the base.

According to an embodiment, a unit for containing animals on a seat of a vehicle includes a base including a front portion and an opposing rear portion; and a latch system coupled to the base. The latch system includes a plurality of latches configured to releasably couple the unit to anchor points within the vehicle, the latches being movably to the base so that the latches can be transitioned between an extended position in which the latches extend out of the rear portion, and a retracted position in which the latches are withdrawn into the rear portion; and an actuator coupled to the base and accessible from an exterior of the unit, the actuator being configured to release the latches from the anchor points within the vehicle.

In addition to one or more of the features described above, or as an alternative, in further embodiments the actuator is configured to release each of the plurality of latches simultaneously.

In addition to one or more of the features described above, or as an alternative, in further embodiments the latch system includes a latch carriage, the plurality of latches being coupled to the latch carriage, wherein the latch carriage can translate within the base in a direction parallel to the front and rear portion of the base from a first position on a first side of the unit to a second position on a second side of the unit, and wherein the actuator is configured to release the latches when the latch carriage is in either one of the first and second positions.

In addition to one or more of the features described above, or as an alternative, in further embodiments the unit includes body panels defining an inflated shape for an exterior of the unit.

In addition to one or more of the features described above, or as an alternative, in further embodiments the latch system includes a secondary latch release mechanism including an actuator on the rigid latch having attach/release indicators and an indicator window on the rigid latch.

In addition to one or more of the features described above, or as an alternative, in further embodiments the unit includes a lead-in for securing the latch in a connect position for connecting the unit to a support structure of the vehicle.

In addition to one or more of the features described above, or as an alternative, in further embodiments the lead-in includes an angled surface so that, as the latch is rotated to the connect position, contact between the latch and the angled surface causes the lead-in to translate toward an unlocked position.

In addition to one or more of the features described above, or as an alternative, in further embodiments the lead-in translates toward a locked position when the latch is in the connect position.

In addition to one or more of the features described above, or as an alternative, in further embodiments the lead-in is biased toward the locked position.

In addition to one or more of the features described above, or as an alternative, in further embodiments the unit includes a position release actuator for transitioning the lead-in from the locked position to the unlocked position to rotate the latches out of the connect position.

In addition to one or more of the features described above, or as an alternative, in further embodiments the rigid latches are at an angle relative to the base to level the unit on a seat of a vehicle.

In addition to one or more of the features described above, or as an alternative, in further embodiments a frame structure of the unit includes an X-bar, and the X-bar has a release actuator attached to the front member or rear member including pins that can be slidably received in corresponding holes on ends of members of the X-bar to lock the X-bar relative to the front member or rear member.

In addition to one or more of the features described above, or as an alternative, in further embodiments the unit includes a folding lock for attaching the base to the containment materials with the unit in a collapsed state.

In addition to one or more of the features described above, or as an alternative, in further embodiments the folding lock includes a protrusion that connects with a corresponding notch or recess located on the base.

In addition to one or more of the features described above, or as an alternative, in further embodiments the folding lock includes a recess that connects with a corresponding protrusion located on the base.

In addition to one or more of the features described above, or as an alternative, in further embodiments the unit includes a handle.

In addition to one or more of the features described above, or as an alternative, in further embodiments the handle extends through first and second openings defined by the base and into the interior of the base.

In addition to one or more of the features described above, or as an alternative, in further embodiments ends of the handle within the base connect with a corresponding boss on the interior of the base to secure the handle to the base.

In addition to one or more of the features described above, or as an alternative, in further embodiments the unit includes a foot on the base for the unit to stand upright.

In addition to one or more of the features described above, or as an alternative, in further embodiments the containment materials can be removed from the unit by disconnecting the top portion of the base from a bottom portion, disconnecting the containment materials from the top portion and frame structure, and sliding the containment materials off the frame structure.

In addition to one or more of the features described above, or as an alternative, in further embodiments the unit includes a tether disconnect including first and second connectors connected to ends of a first tether portion slidably connected to a second tether portion.

In addition to one or more of the features described above, or as an alternative, in further embodiments the slidable connection between the first and second tether portion allows the first tether portion to move to a position relative to the second tether portion to maintain a taut connection between the first tether portion and the tethers.

In addition to one or more of the features described above, or as an alternative, in further embodiments the tether disconnect can remain in the vehicle while the unit is removed from the vehicle.

In addition to one or more of the features described above, or as an alternative, in further embodiments the unit includes tether guides connected to the frame structure for receiving the tethers to align the tethers on the unit.

In addition to one or more of the features described above, or as an alternative, in further embodiments the unit includes step members on the base to tailor the containment materials to form the first and second sides of the unit.

According to an embodiment, a unit for containing animals on a seat of a vehicle includes a base structure, a frame structure coupled to the base, and containment materials extending at least partially about the frame structure. The base structure, the frame structure and the containment materials cooperate to define an enclosed area of the unit. An opening is formed in the containment materials to provide access to the enclosed area. An impact absorption pad is removably mountable to the unit proximate the opening.

In addition to one or more of the features described above, or as an alternative, in further embodiments the impact absorption pad is removably connectable to the door, the impact absorption pad being movable with the door relative to the opening.

In addition to one or more of the features described above, or as an alternative, in further embodiments the door is integrally formed with the containment materials.

In addition to one or more of the features described above, or as an alternative, in further embodiments the impact absorption pad is removably connectable to the containment materials directly adjacent to the opening.

In addition to one or more of the features described above, or as an alternative, in further embodiments including a door movable relative to the containment material to selectively seal the opening.

In addition to one or more of the features described above, or as an alternative, in further embodiments the door is movable relative to the impact absorption pad.

In addition to one or more of the features described above, or as an alternative, in further embodiments the impact absorption pad is formed from a foam material.

In addition to one or more of the features described above, or as an alternative, in further embodiments the impact absorption pad is removably mountable to the unit hook and loop fasteners.

In addition to one or more of the features described above, or as an alternative, in further embodiments the impact absorption pad is removably mountable to the unit via magnets.

In addition to one or more of the features described above, or as an alternative, in further embodiments the impact absorption pad is removably mountable to the unit via snaps.

According to an embodiment, a unit for containing animals on a seat of a vehicle includes a base structure, a frame structure coupled to the base, and containment materials extending at least partially about the frame structure. The base structure, the frame structure, and the containment materials cooperate to define an enclosed area of the unit. An opening is formed in the containment materials to provide access to the enclosed area. A safety net is removably mountable to the unit in overlapping arrangement with the opening.

In addition to one or more of the features described above, or as an alternative, in further embodiments the safety net includes a plurality of pieces of webbing, the plurality of pieces of webbing being arranged to block the opening.

In addition to one or more of the features described above, or as an alternative, in further embodiments the safety net is removably connectable to the unit via at least one quick disconnect mechanism.

In addition to one or more of the features described above, or as an alternative, in further embodiments the at least one quick connect mechanism includes a connector attached to the unit and a clasp arranged at an end of the safety net.

In addition to one or more of the features described above, or as an alternative, in further embodiments the connector is rigidly attached to the frame structure.

In addition to one or more of the features described above, or as an alternative, in further embodiments the connector is rigidly attached to the base structure.

### BRIEF DESCRIPTION

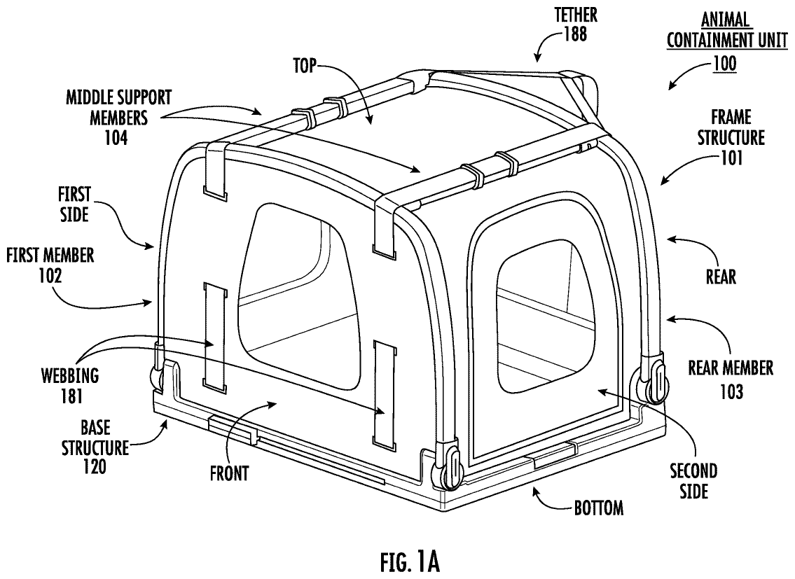

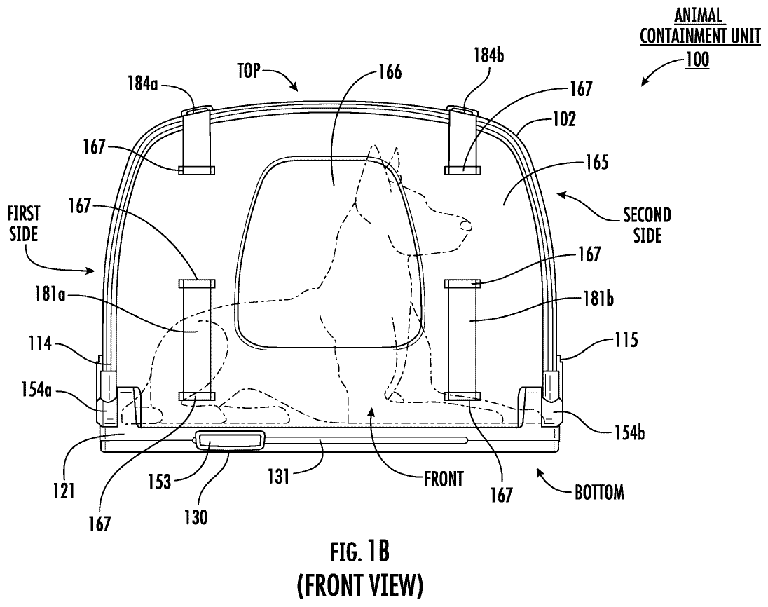

FIG. 1a shows a perspective view of an animal containment unit according to a first exemplary embodiment.

FIG. 1b shows a front view of the animal containment unit of the first exemplary embodiment.

FIG. 1c shows a side view of the animal containment unit of the first exemplary embodiment.

FIG. 1d shows a top view of the animal containment unit of the first exemplary embodiment.

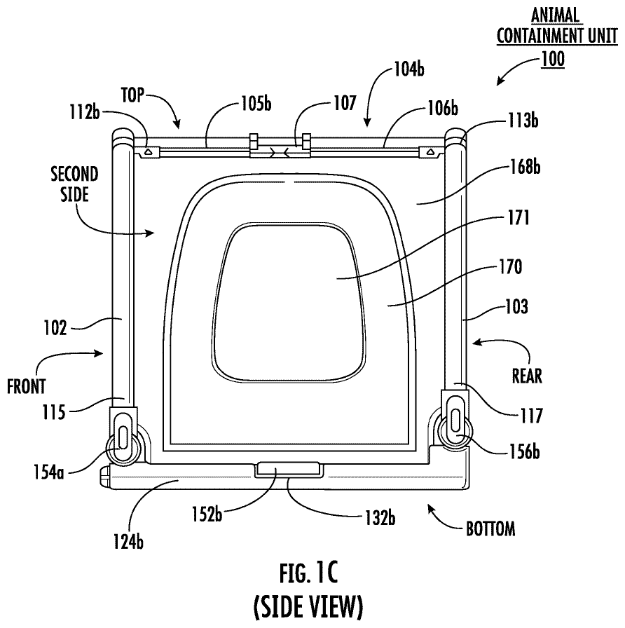

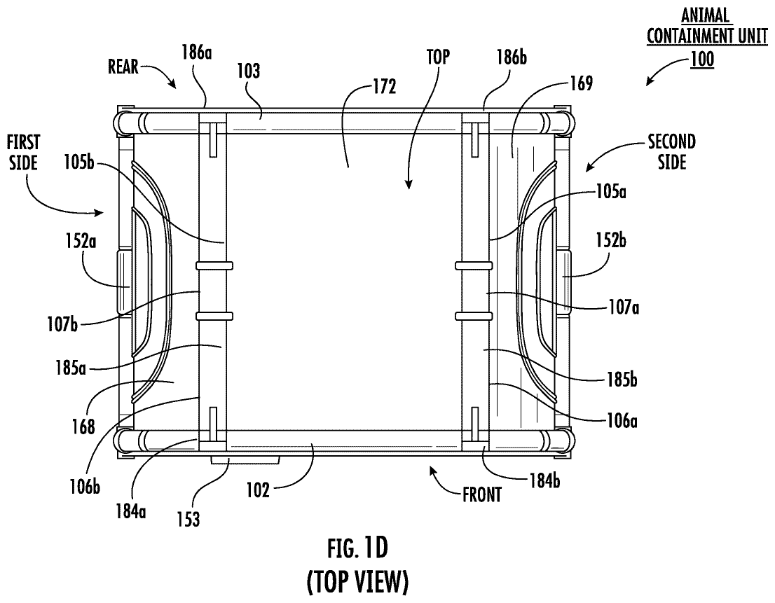

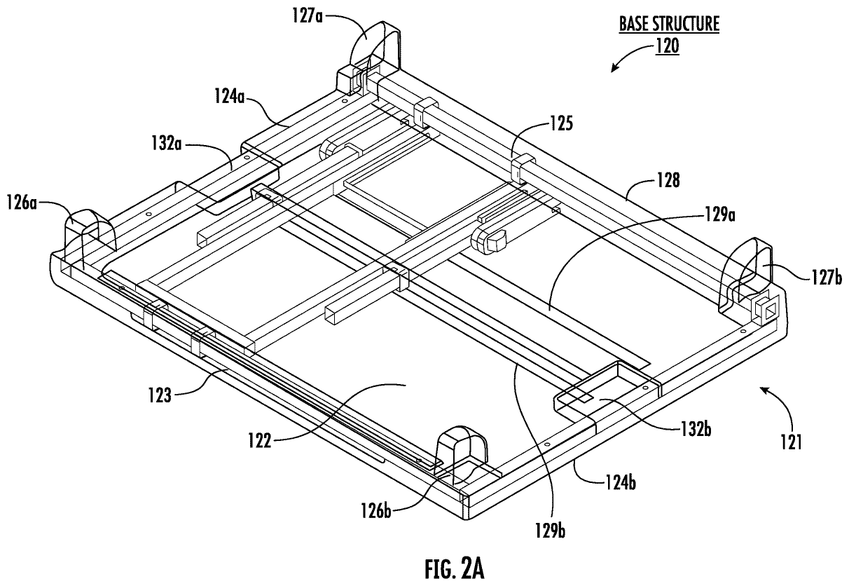

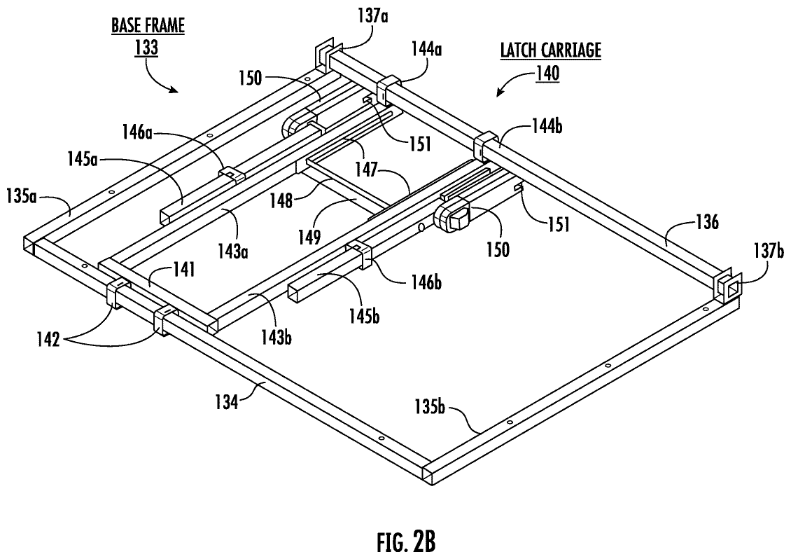

FIG. 2a shows a base structure of the animal containment unit of the first exemplary embodiment.

FIG. 2b shows a base frame and latch carriage of the base structure of the animal containment unit of the first exemplary embodiment.

FIG. 2c shows a side view of the base structure of the animal containment unit of the first exemplary embodiment.

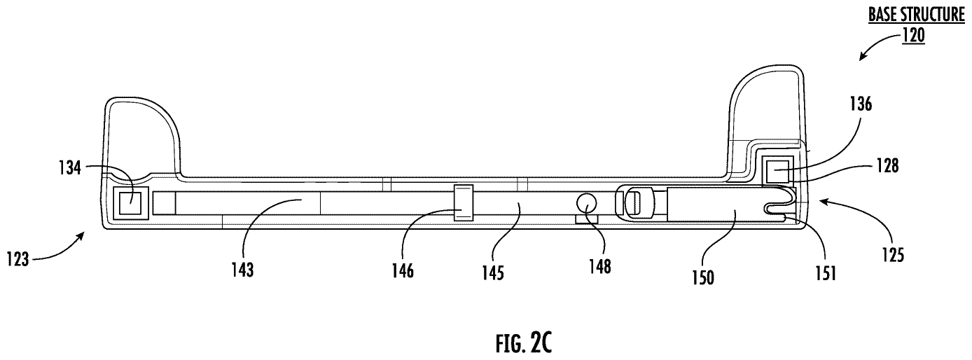

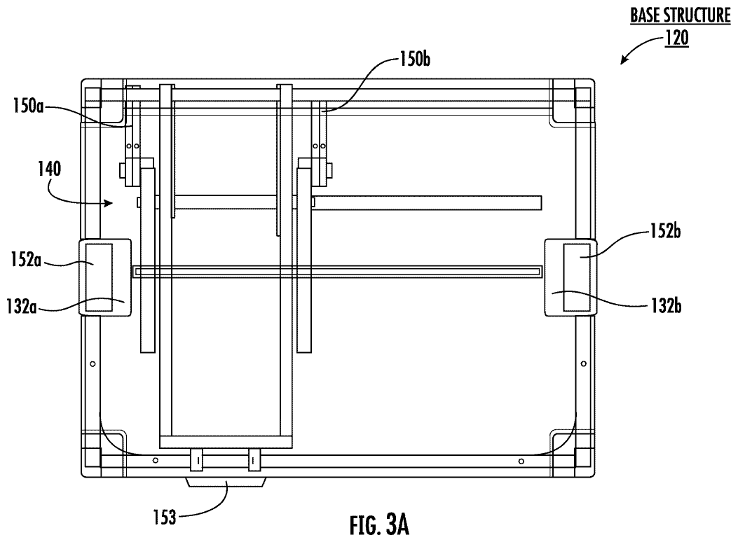

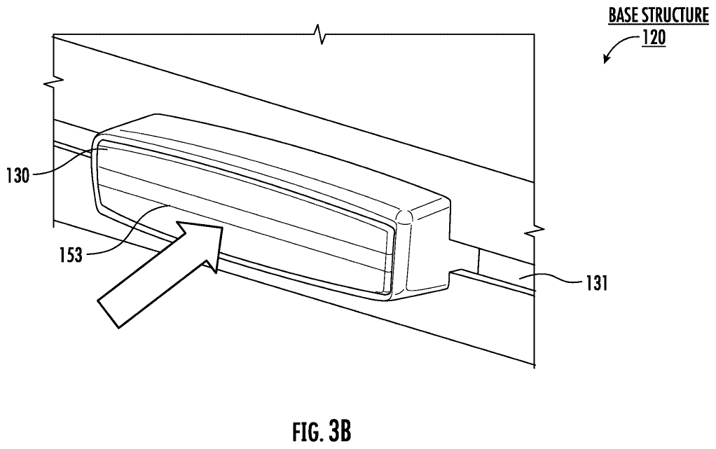

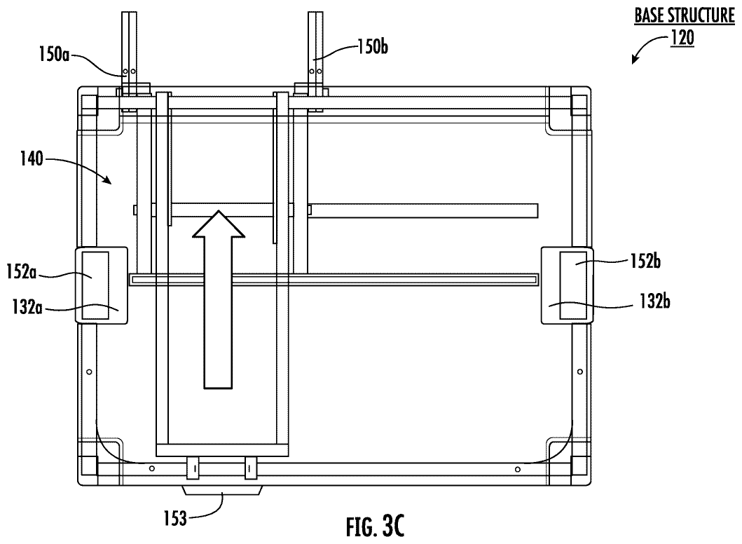

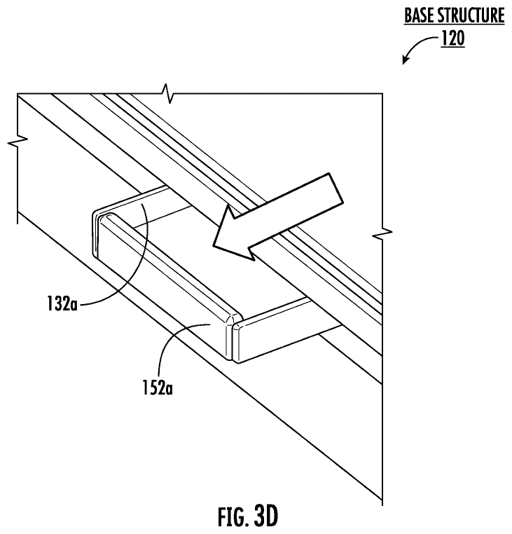

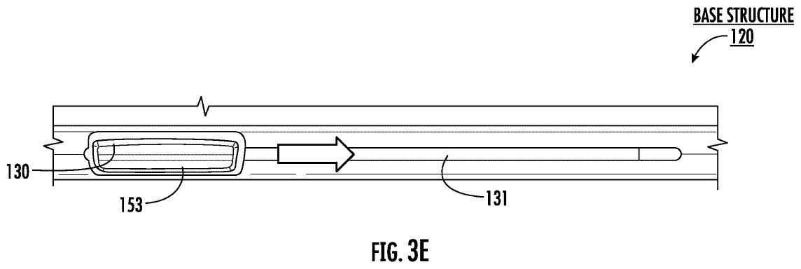

FIG. 3a shows the base structure of the first exemplary embodiment with the latch carriage in a first position toward a first side of the animal containment unit.

FIG. 3b shows a front button of the base structure of the first exemplary embodiment extending through a front cavity in the front portion of the molded base.

FIG. 3c shows the base structure of the first exemplary embodiment with the latch carriage in the first position and with the latches extended out the rear cavity.

FIG. 3d shows a first side actuator of the base structure of the first exemplary embodiment positioned in the first side cavity in the first side portion of the molded base.

FIG. 3e shows a front button of the base structure of the first exemplary embodiment sliding within the front slot.

FIG. 3f shows the base structure of the first exemplary embodiment with the latch carriage in the second position toward the second side of the unit.

FIG. 3g shows the base structure of the first exemplary embodiment with the latch carriage in the second position and with the latches withdrawn into the rear cavity.

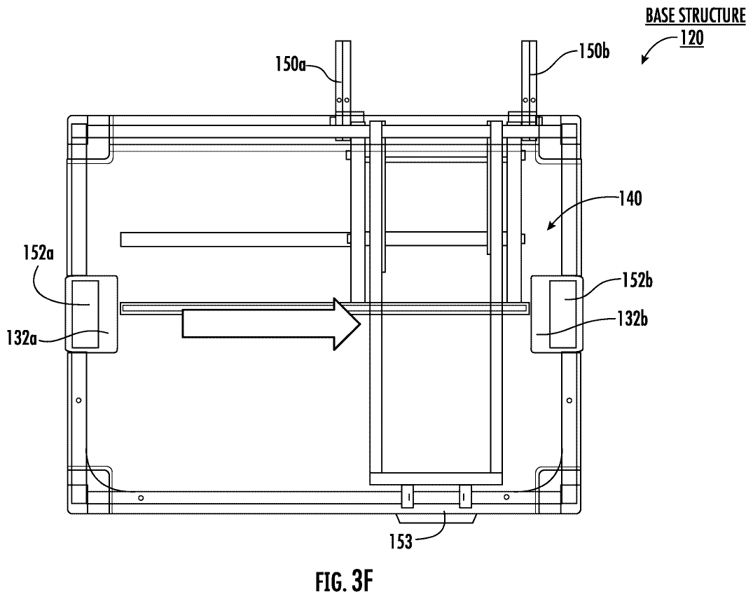

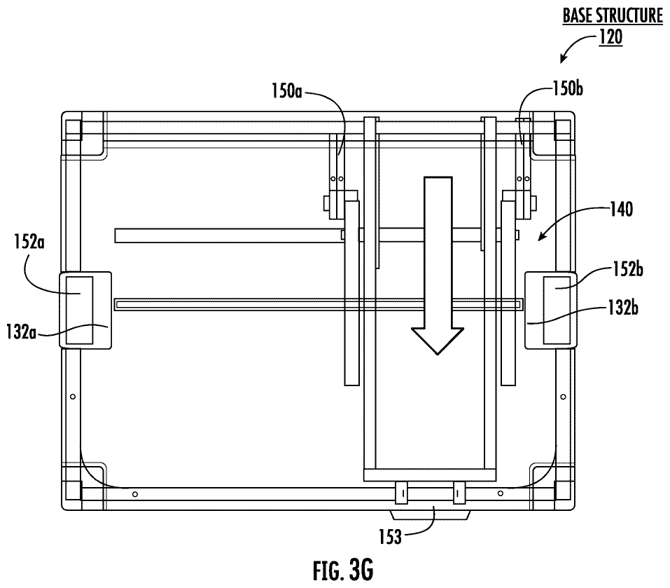

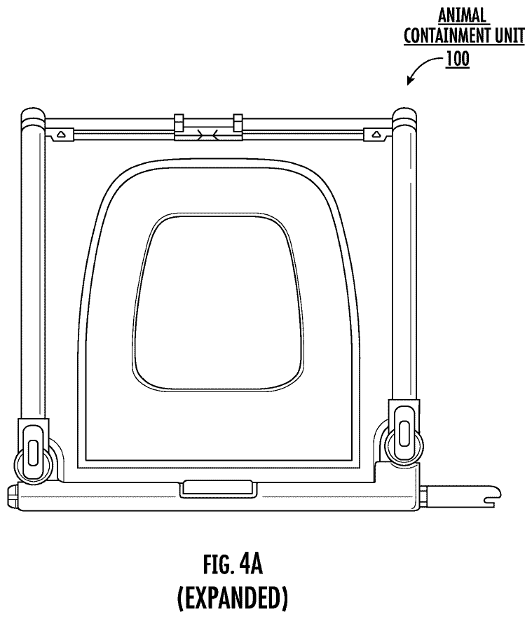

FIG. 4a shows the animal containment unit of the first exemplary embodiment in the expanded state.

FIG. 4b shows the animal containment unit of the first exemplary embodiment transitioning to the collapsed state.

FIG. 4c shows the animal containment unit of the first exemplary embodiment in the collapsed state.

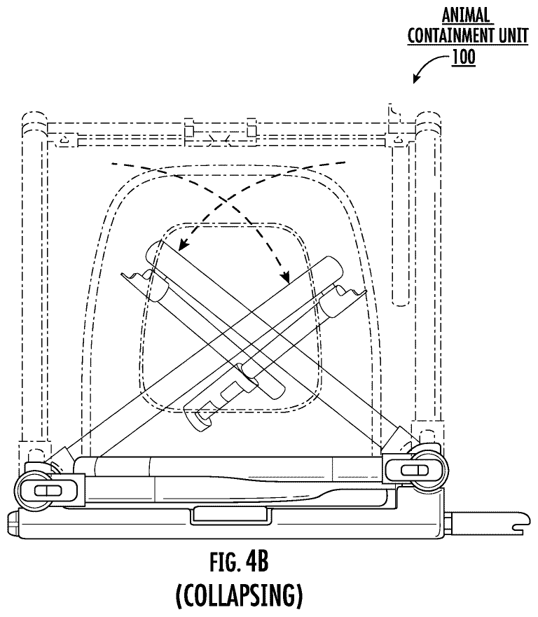

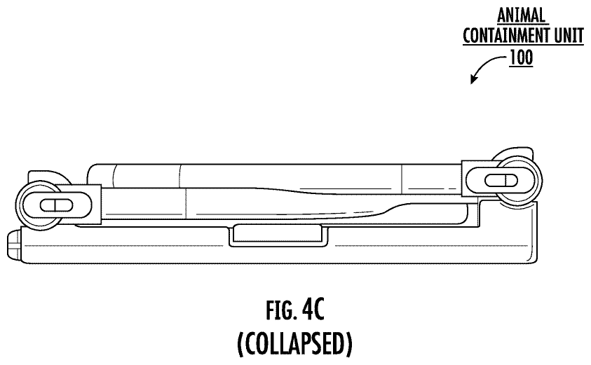

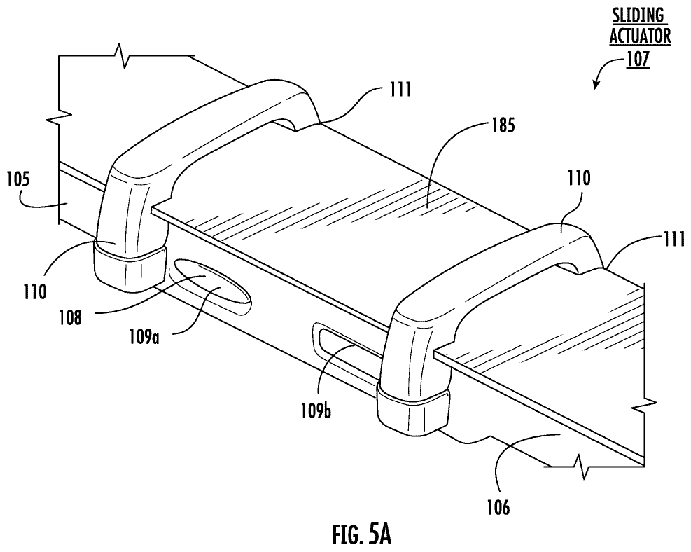

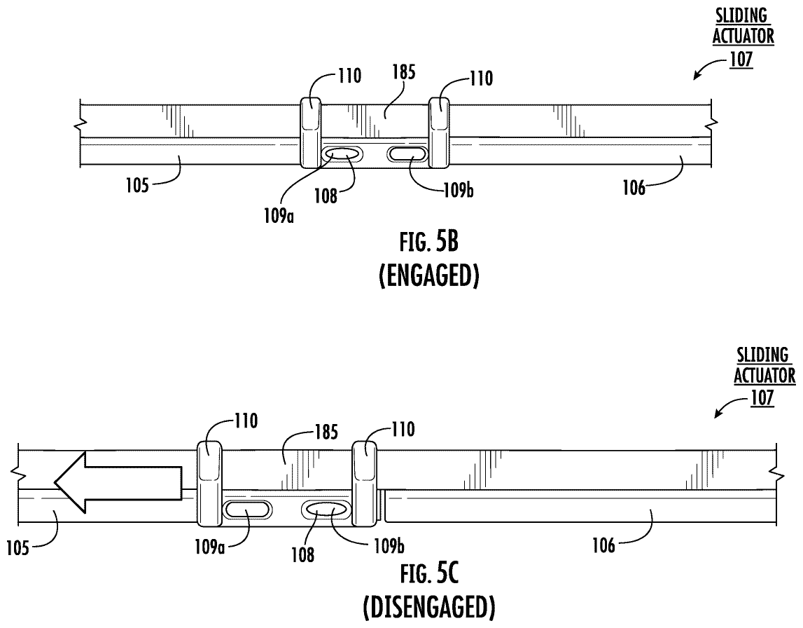

FIG. 5a shows a perspective view of a sliding actuator of the first exemplary embodiment in a first state with the front middle support member and the rear middle support member connected via the sliding actuator.

FIG. 5b shows a side view of the sliding actuator of the first exemplary embodiment in the first state.

FIG. 5c shows a side view of the sliding actuator of the first exemplary embodiment in the second state with the front middle support member and the sliding actuator disconnected from the rear middle support member.

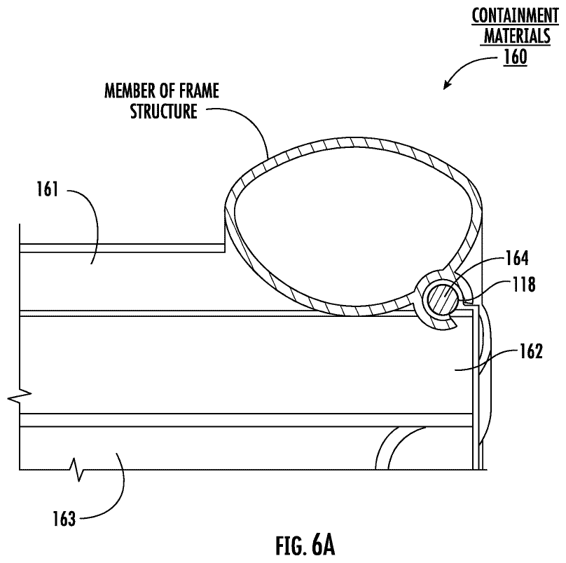

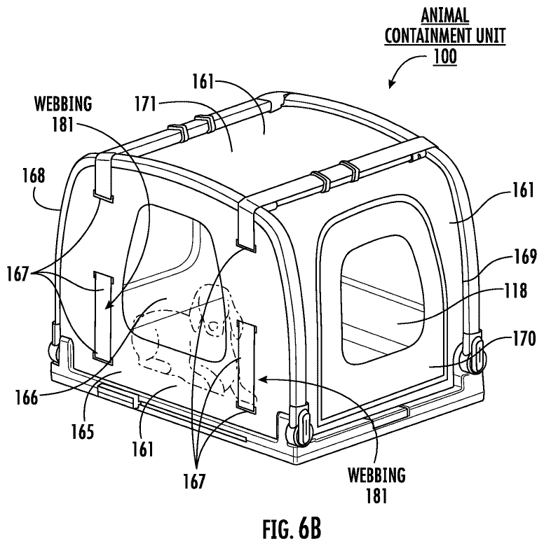

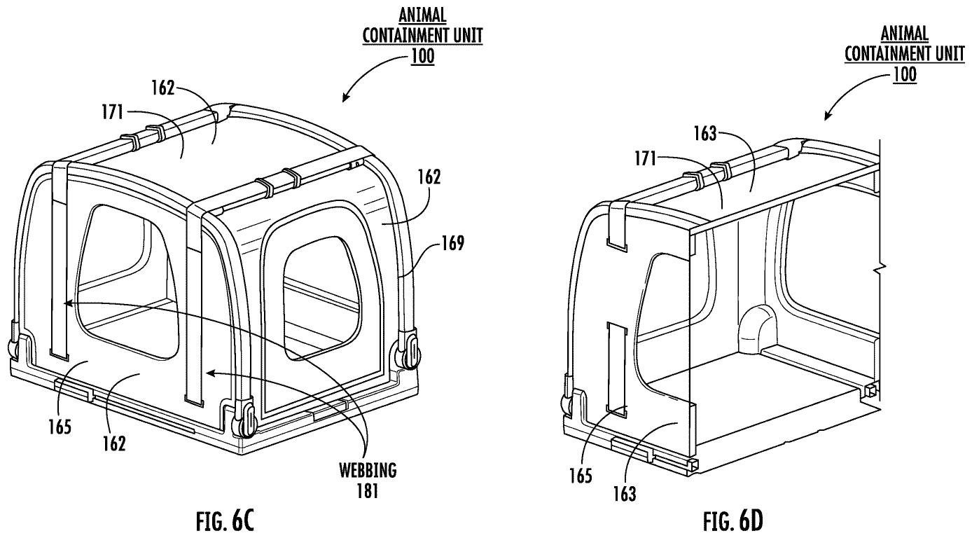

FIG. 6a shows a cross-sectional view of the containment materials of the first exemplary embodiment.

FIG. 6b shows the exterior layer for the containment materials of the first exemplary embodiment with the animal containment unit in the expanded state.

FIG. 6c shows the stiffener layer for the containment materials of the first exemplary embodiment with the animal containment unit in the expanded state.

FIG. 6d shows the interior layer for the containment materials of the first exemplary embodiment with the animal containment unit in the expanded state.

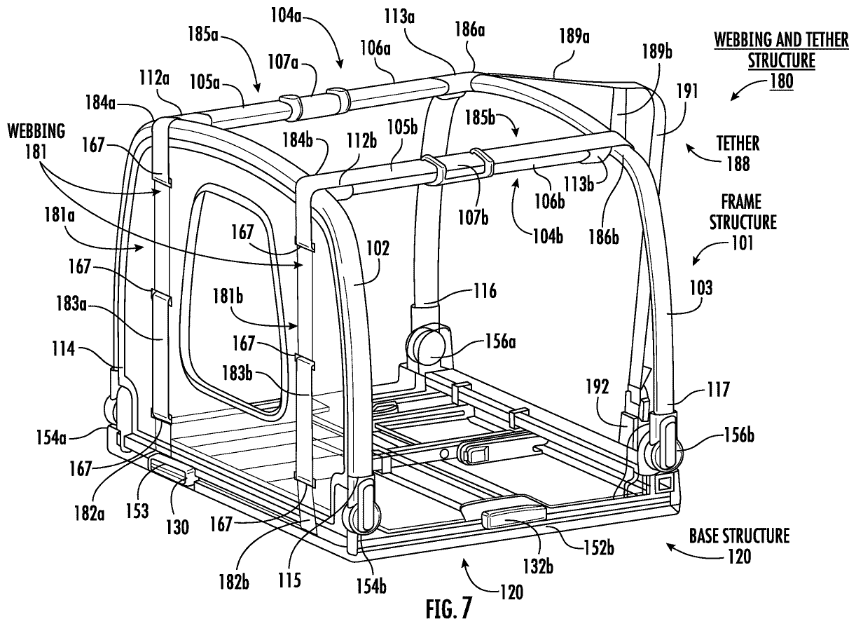

FIG. 7 shows a webbing and tether structure for the animal containment unit of the first exemplary embodiment assembled with the frame structure and the base structure.

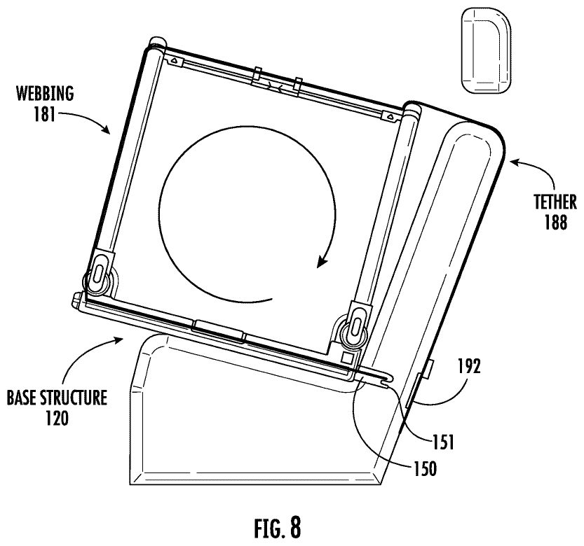

FIG. 8 shows a diagram of the animal containment unit of the first exemplary embodiment installed in a vehicle.

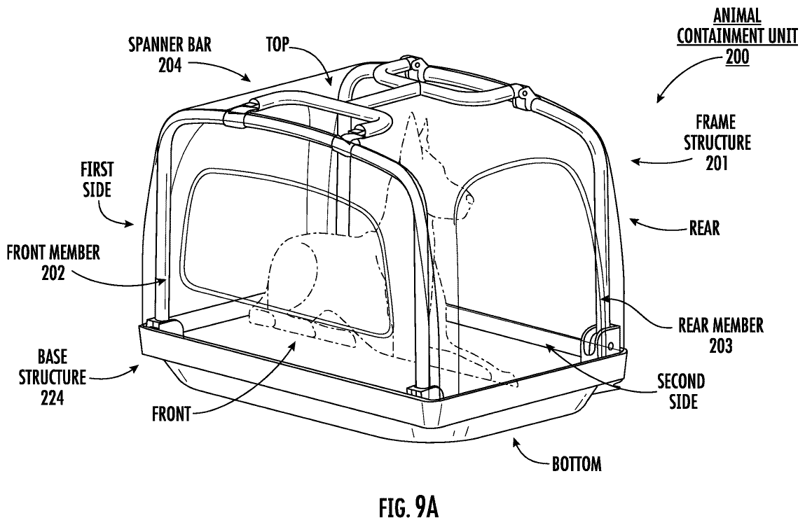

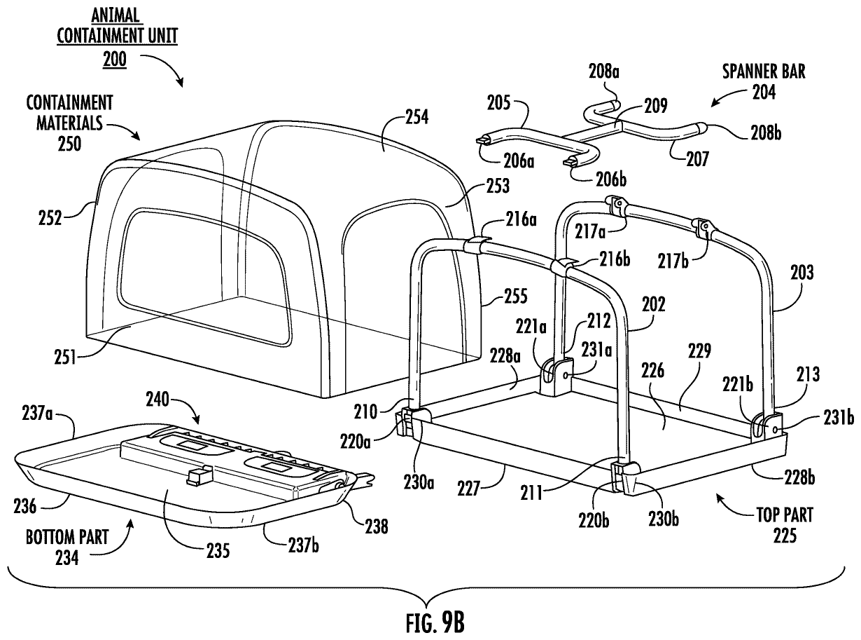

FIG. 9a shows a perspective view of an animal containment unit according to a second exemplary embodiment.

FIG. 9b shows an exploded view of the animal containment unit according to the second exemplary embodiment.

FIG. 9c shows a top view of the animal containment unit according to the second exemplary embodiment.

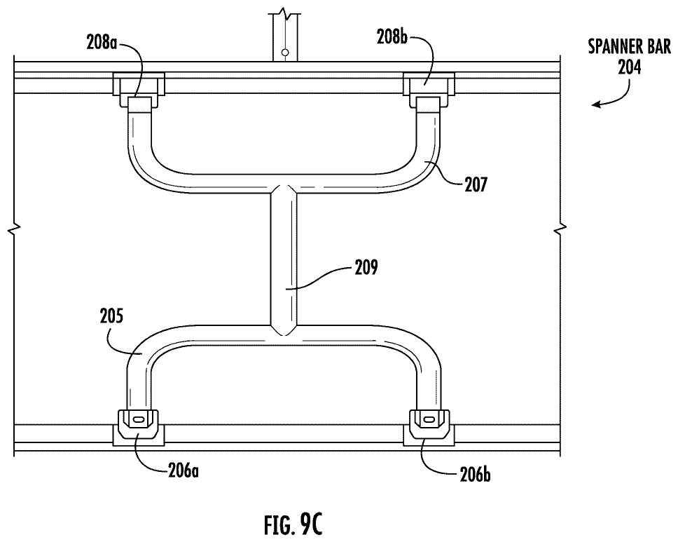

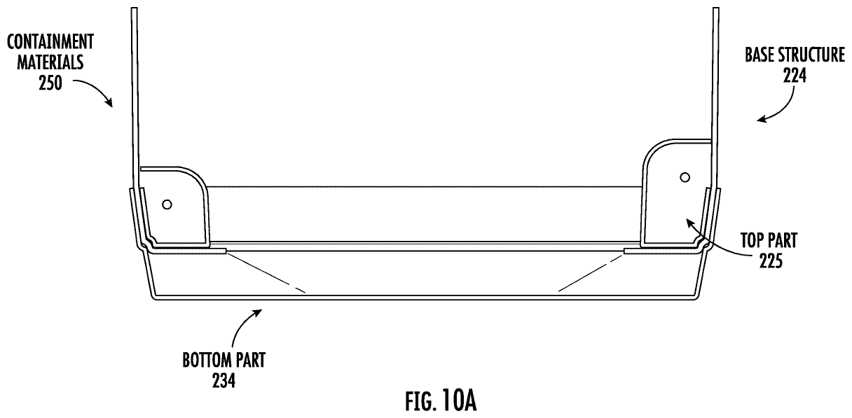

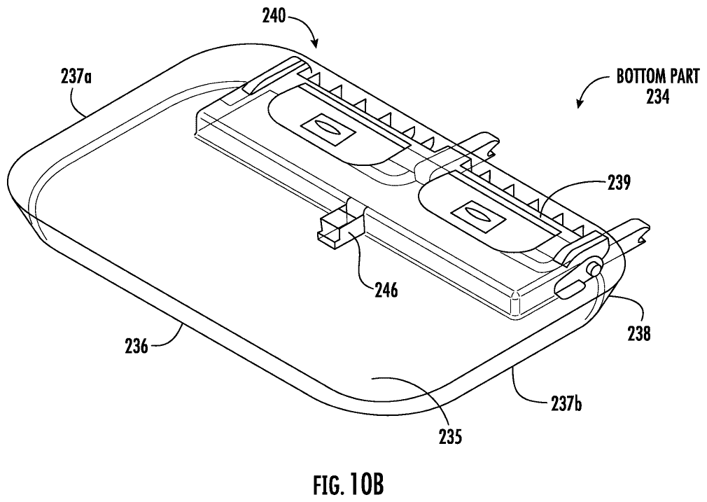

FIG. 10a shows a base structure of the second exemplary embodiment with a top part nested with a bottom part.

FIG. 10b shows the bottom part of the base structure of the second exemplary embodiment.

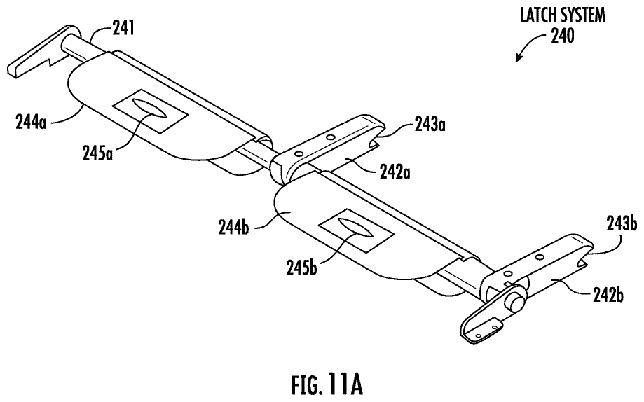

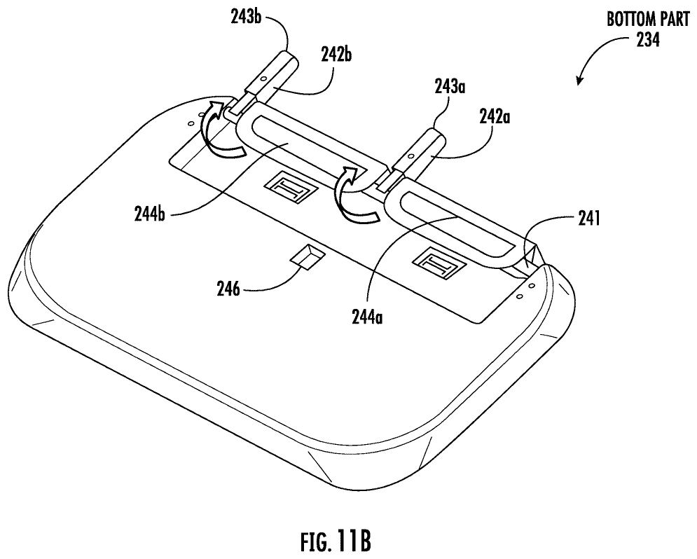

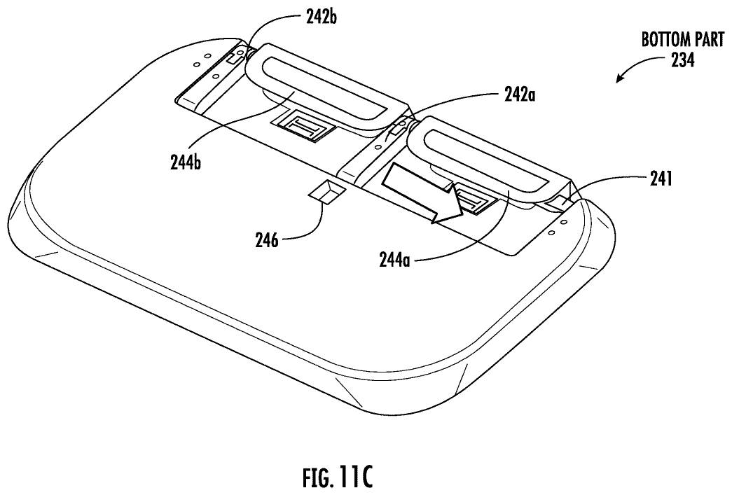

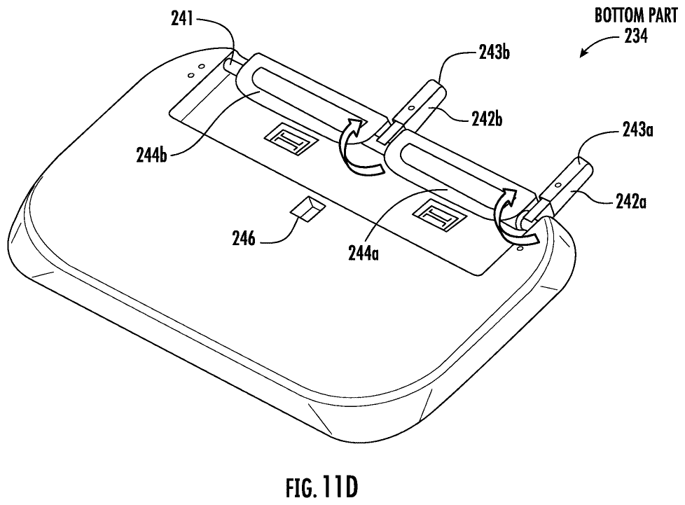

FIG. 11a shows the latch system of the second exemplary embodiment without the base structure.

FIG. 11b shows a bottom view of the latch system mounted in the bottom part of the base structure with the latches pivoted into the extended position on a first side of the unit of the second exemplary embodiment.

FIG. 11c shows a bottom view of the latch system with the latches pivoted into the retracted position on the first side of the unit of the second exemplary embodiment.

FIG. 11d shows a bottom view of the latch system with the latches pivoted into the extended position on a second side of the unit of the second exemplary embodiment.

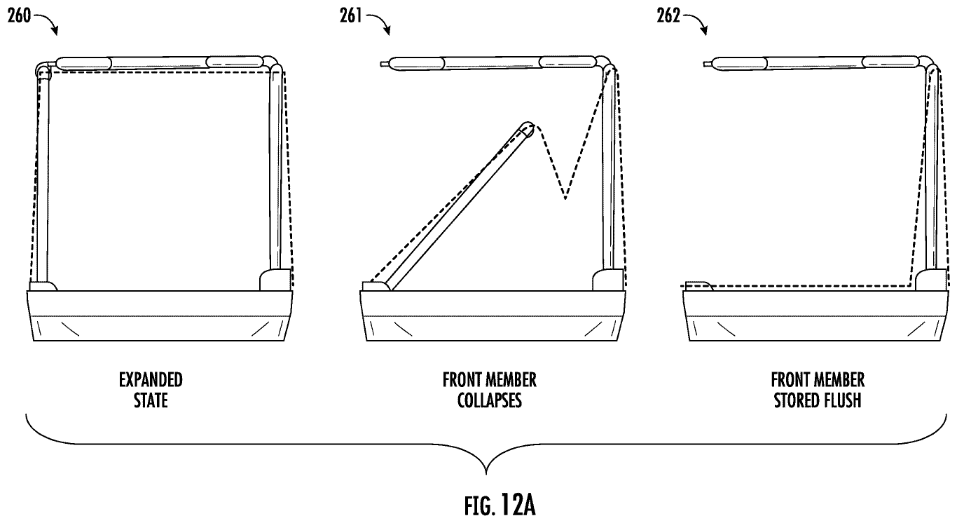

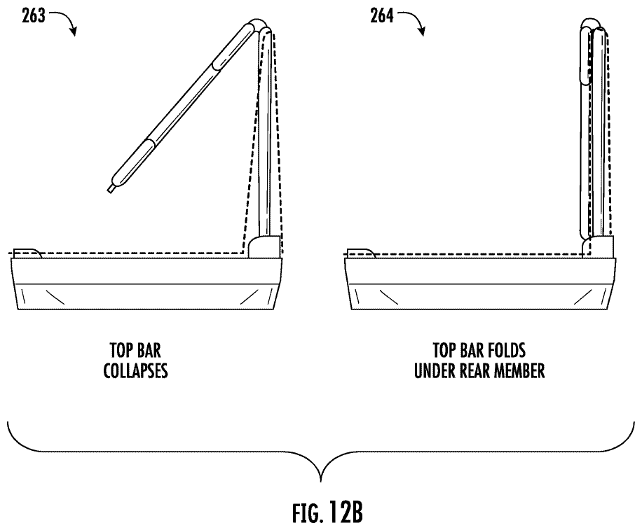

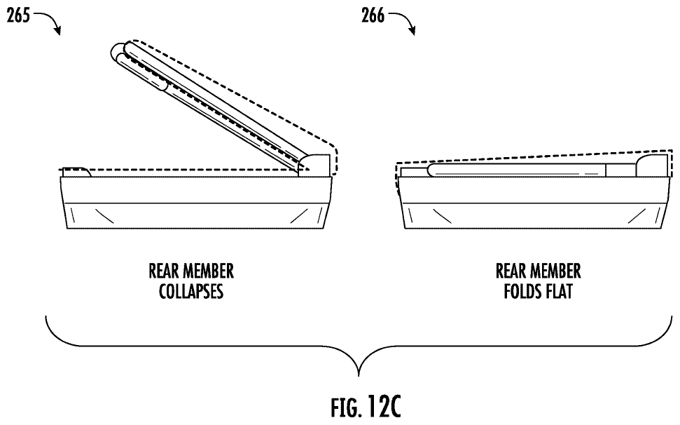

FIGS. 12a, 12b, and 12c shows the animal containment unit of the second exemplary embodiment transitioning from an expanded state into a collapsed state.

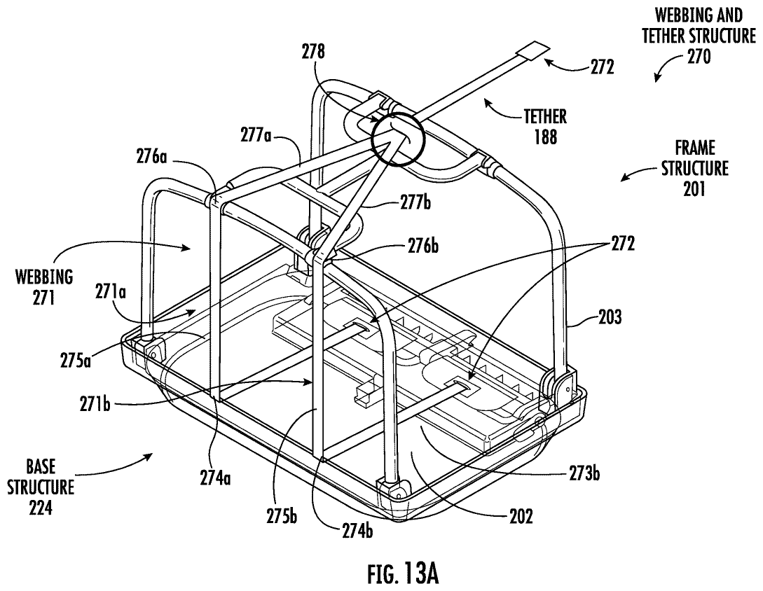

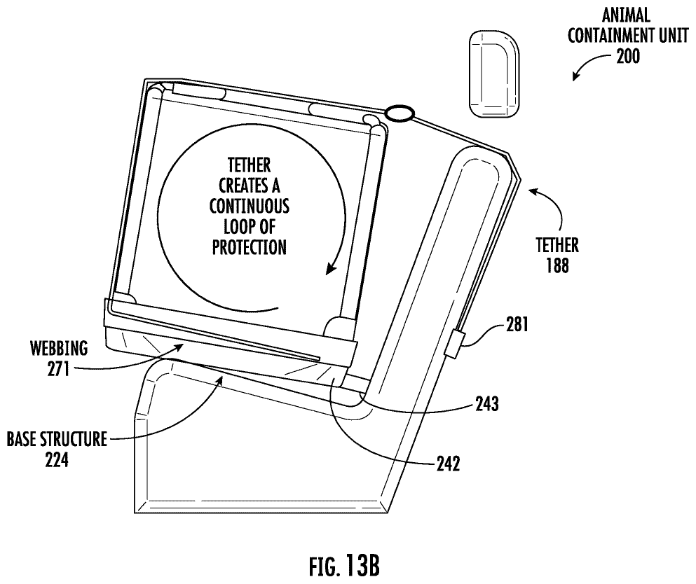

FIG. 13a shows the webbing and tether structure for the animal containment unit of the second exemplary embodiment assembled with the frame structure and the base structure.

FIG. 13b shows a diagram of the animal containment unit of the second exemplary embodiment installed in a vehicle.

FIG. 13c shows the animal containment unit of the second exemplary embodiment deflecting under the force of a car crash.

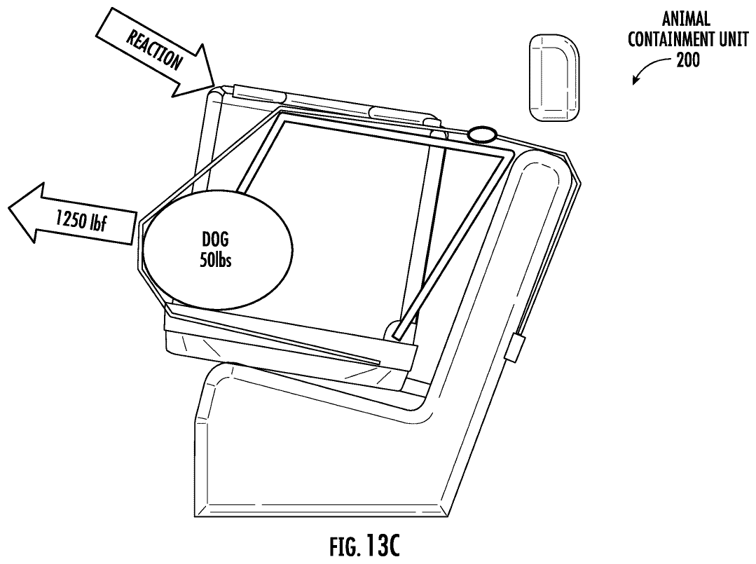

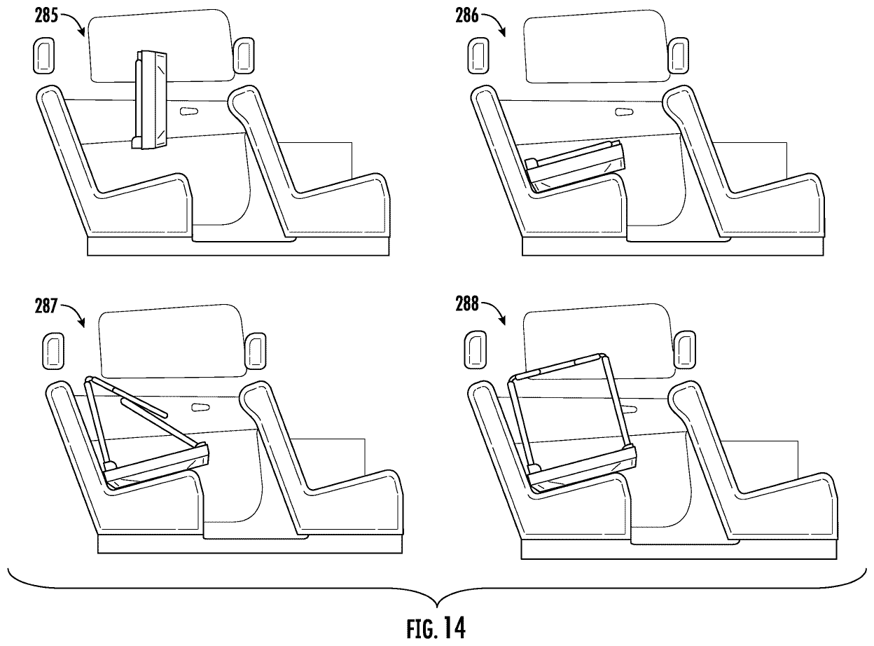

FIG. 14 shows the animal containment unit of the second exemplary embodiment being installed in a vehicle.

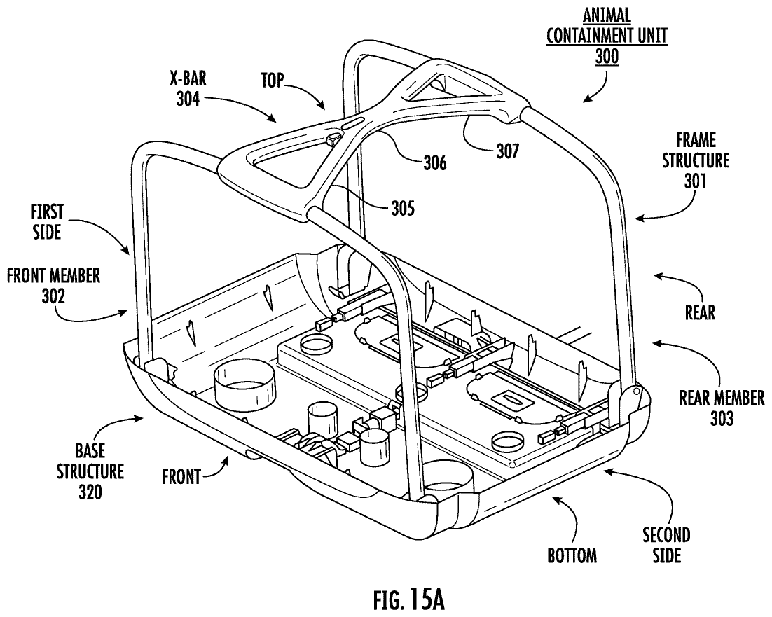

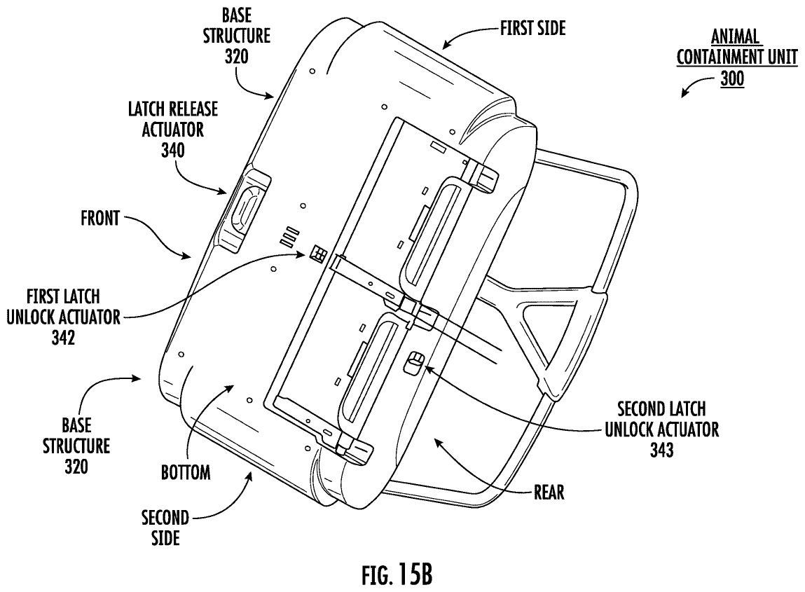

FIG. 15a shows a perspective view of an animal containment unit according to a third exemplary embodiment.

FIG. 15b shows a bottom view of the animal containment unit of the third exemplary embodiment.

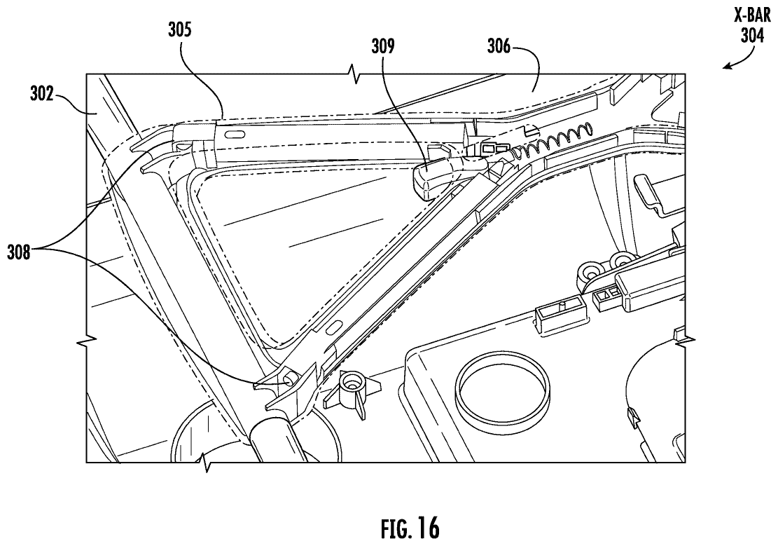

FIG. 16 shows the X-bar of the frame structure of the animal containment unit of the third exemplary embodiment.

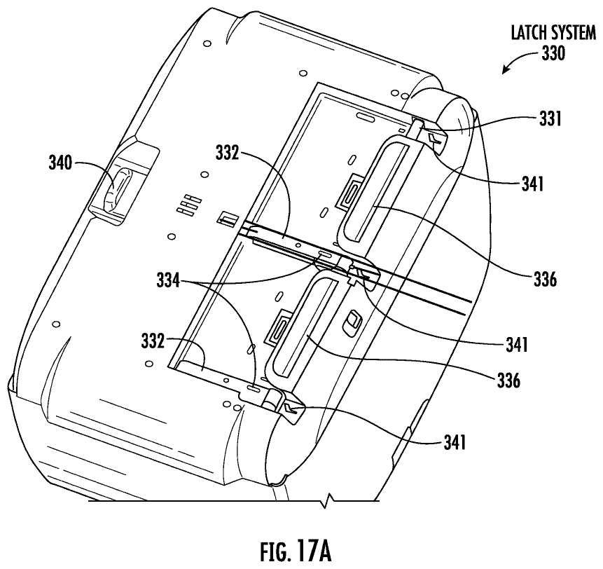

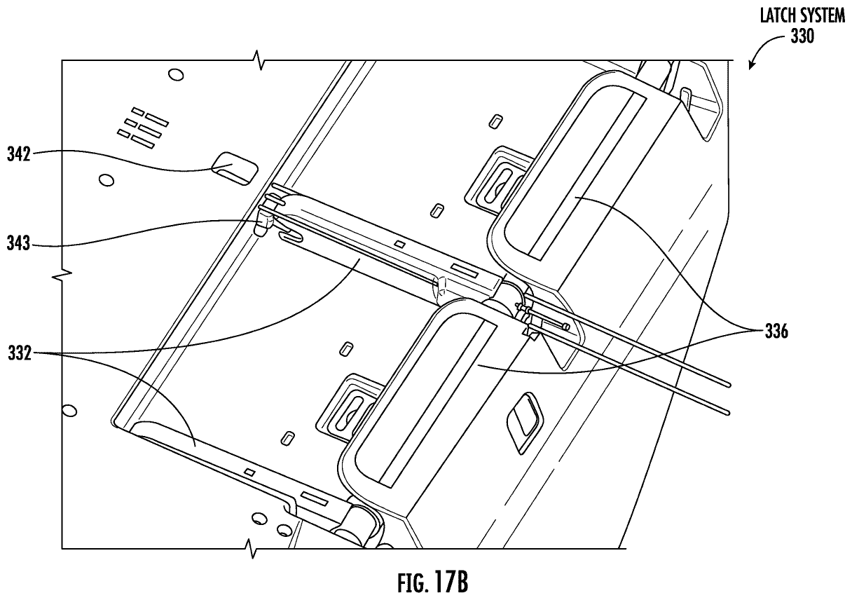

FIG. 17a shows an arrangement for a latch release actuator of the third exemplary embodiment.

FIG. 17b shows an arrangement for a first latch unlock actuator of the third exemplary embodiment.

FIG. 17c shows an arrangement for a second latch unlock actuator of the third exemplary embodiment.

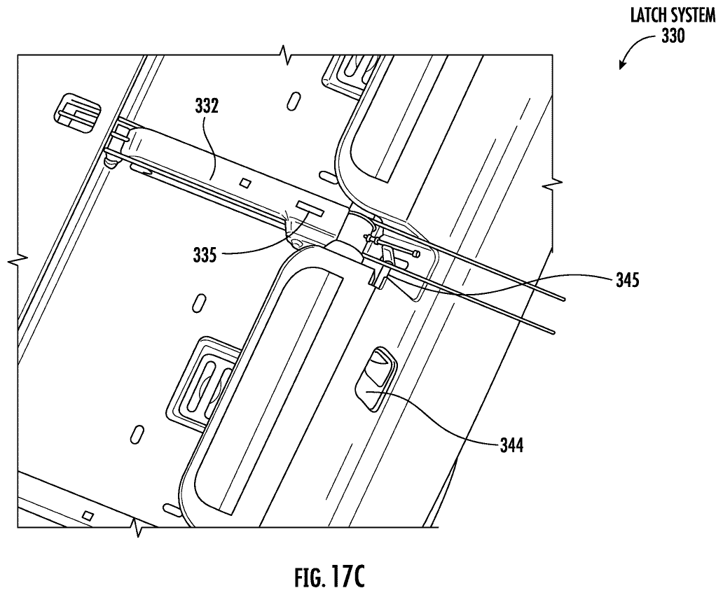

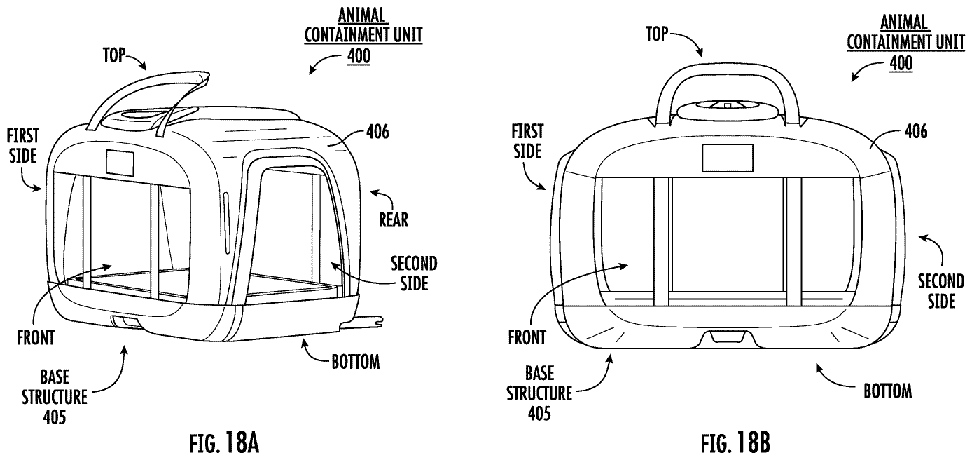

FIGS. 18a, 18b, 18c and 19 show various views of an animal containment unit according to a fourth exemplary embodiment.

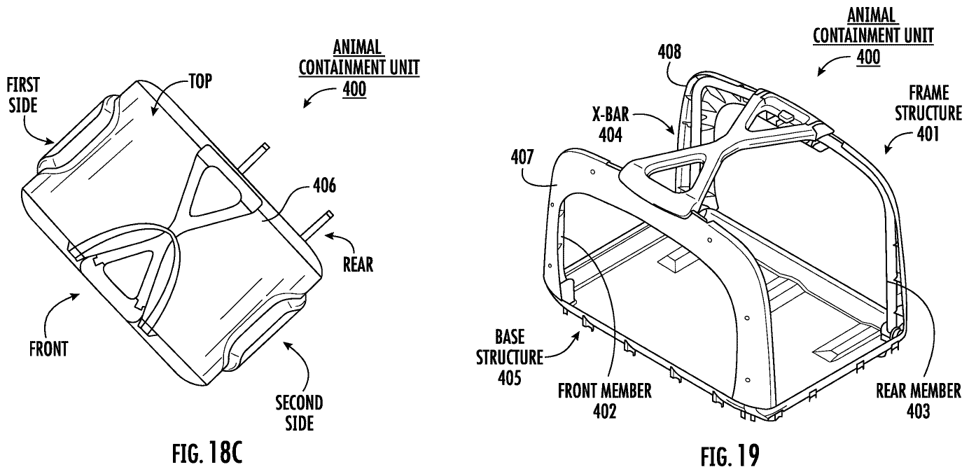

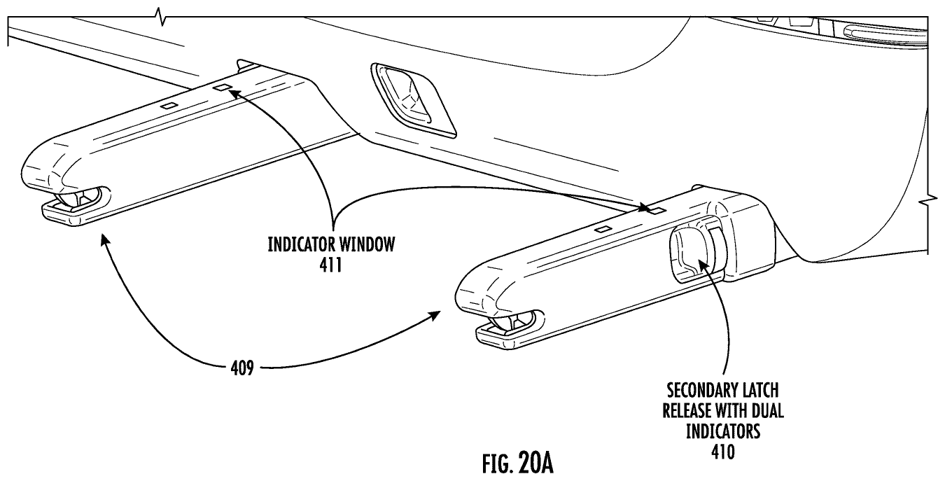

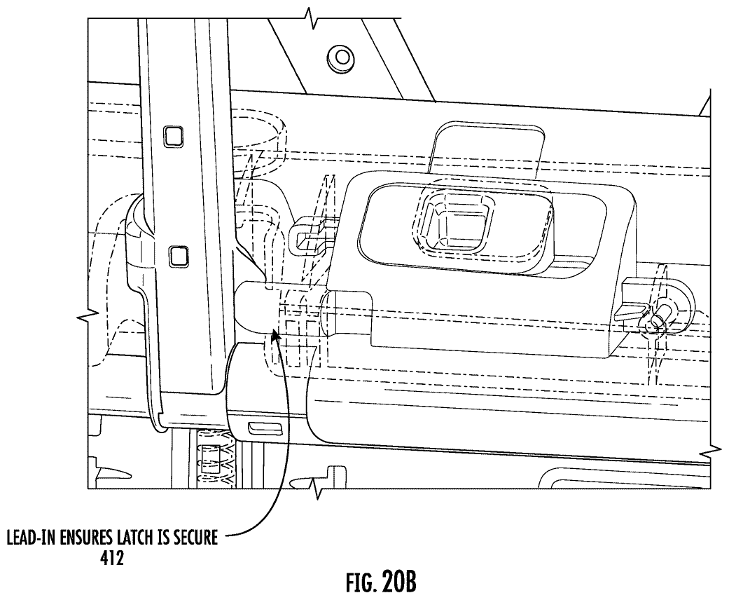

FIGS. 20a and 20b show a secondary latch release mechanism of the unit of the fourth exemplary embodiment.

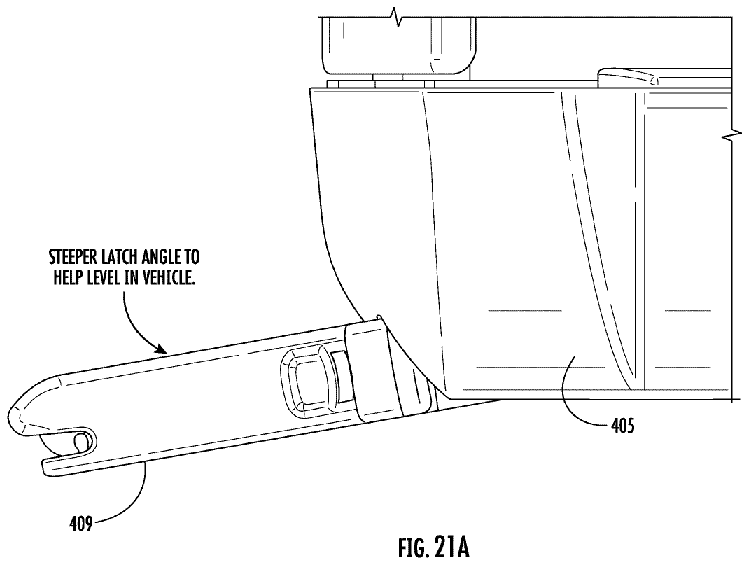

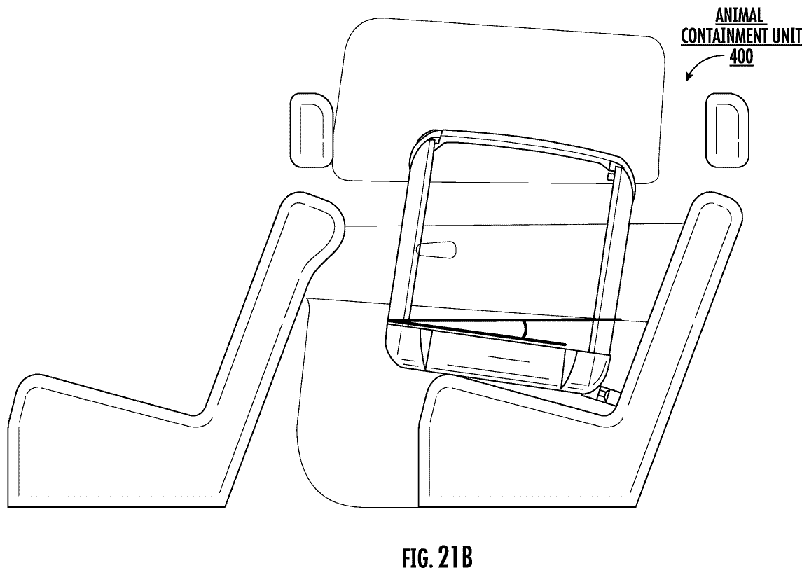

FIGS. 21a and 21b show a steep latch angle of the unit of the fourth exemplary embodiment.

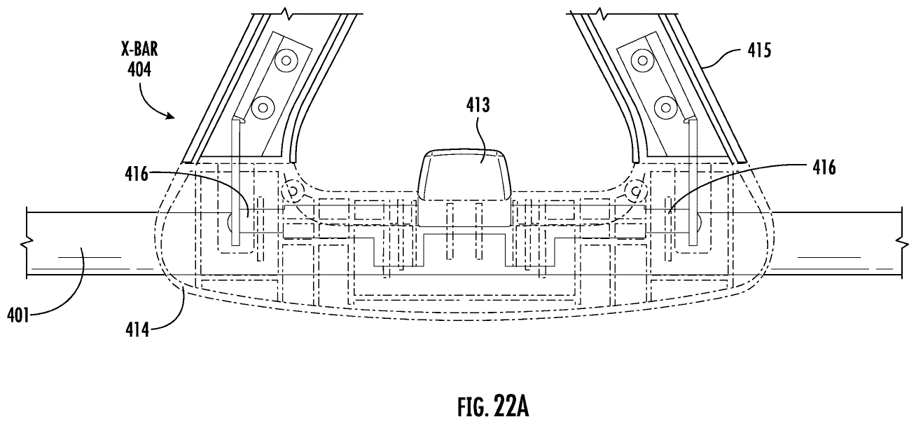

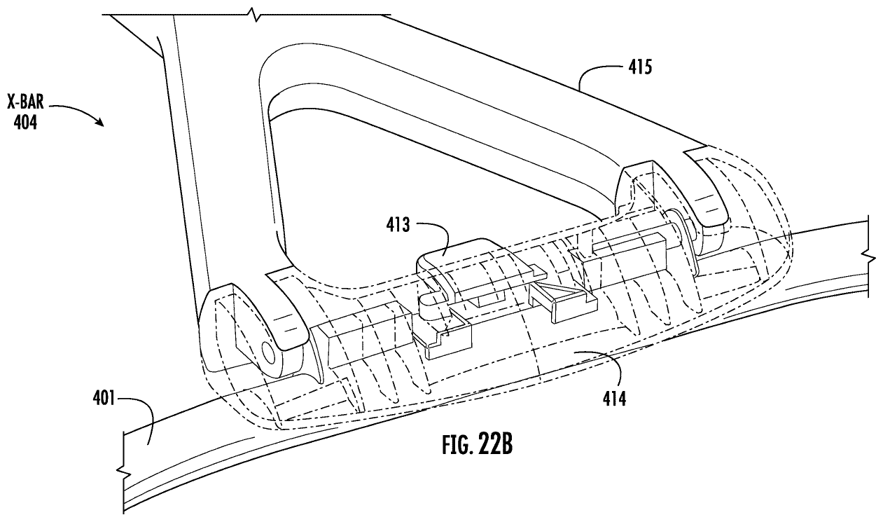

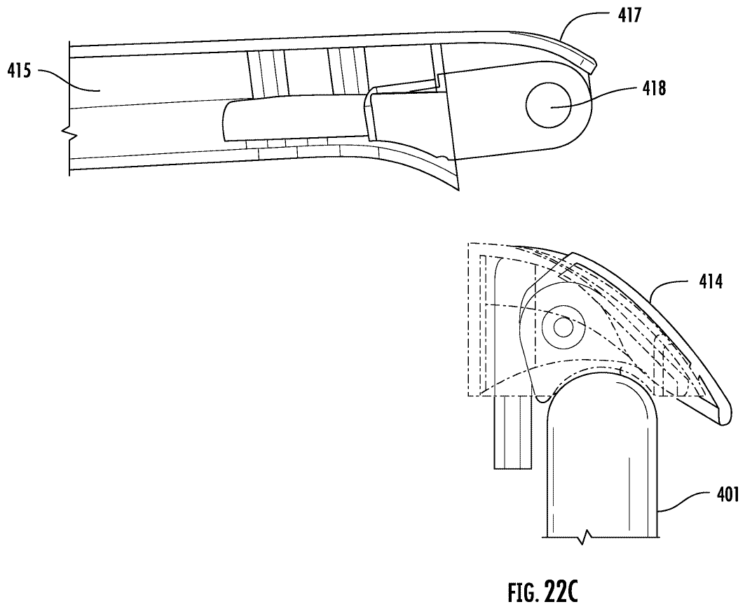

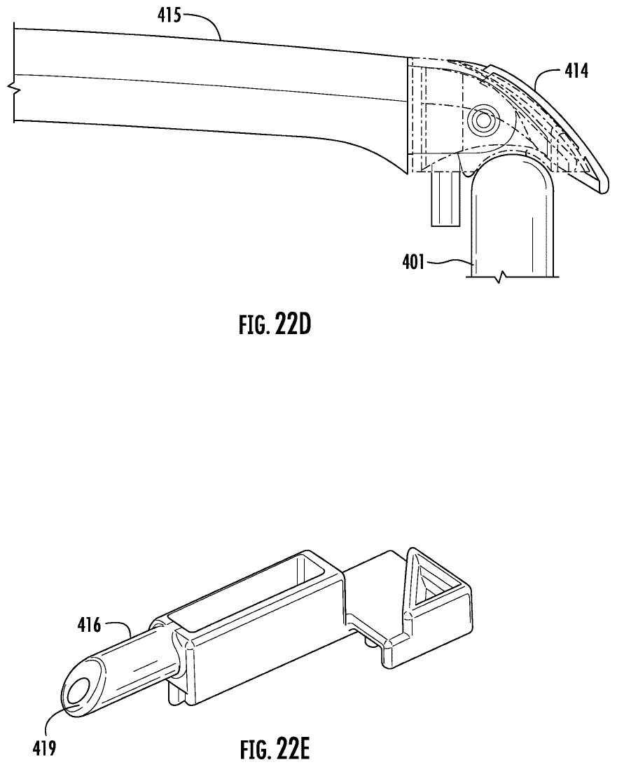

FIGS. 22a, 22b, 22c, 22d, and 22e show an actuator of the unit of the fourth exemplary embodiment.

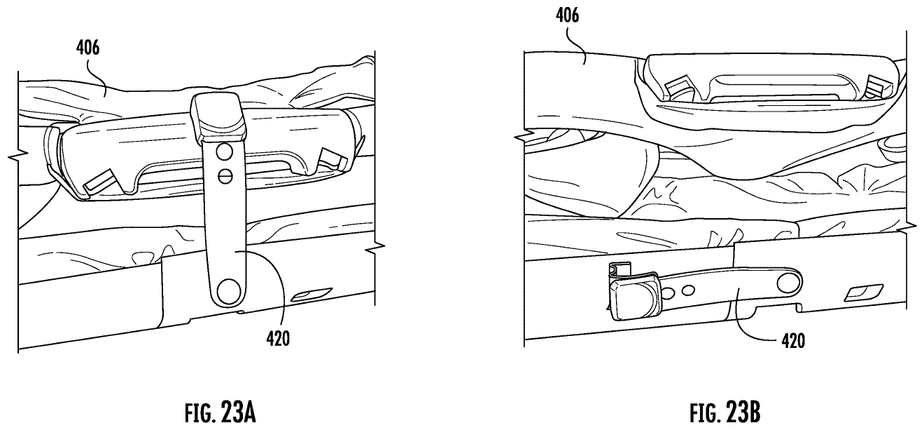

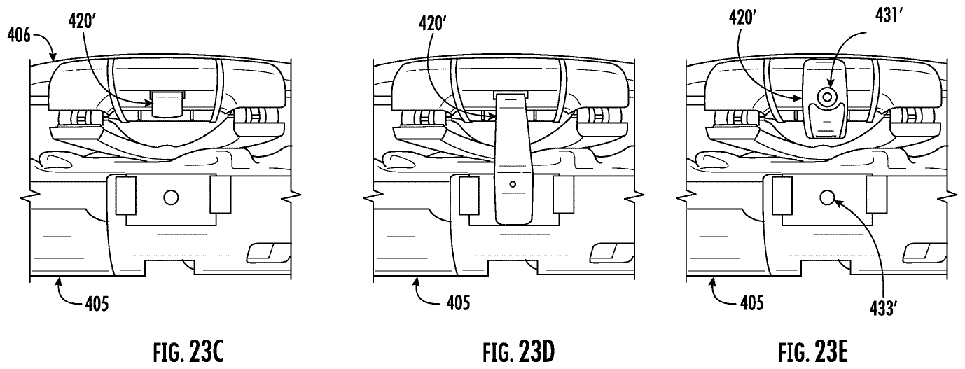

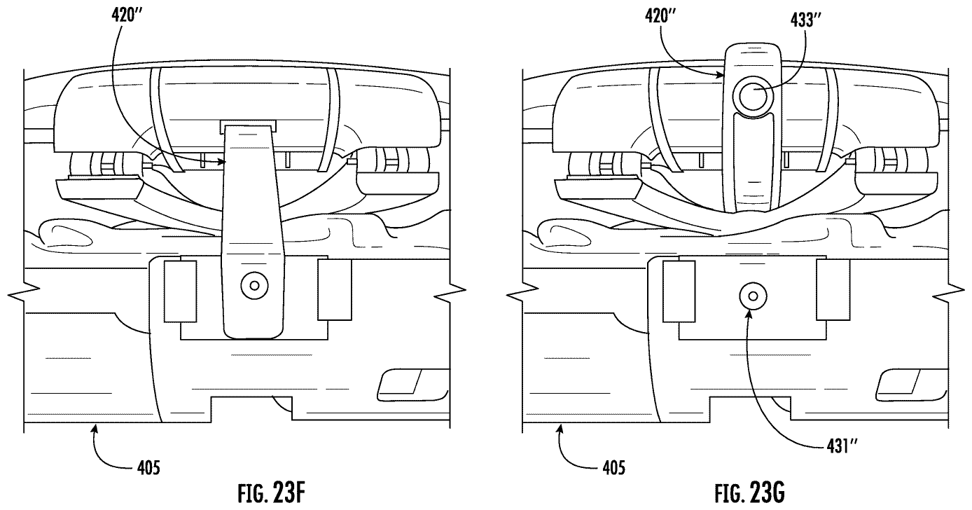

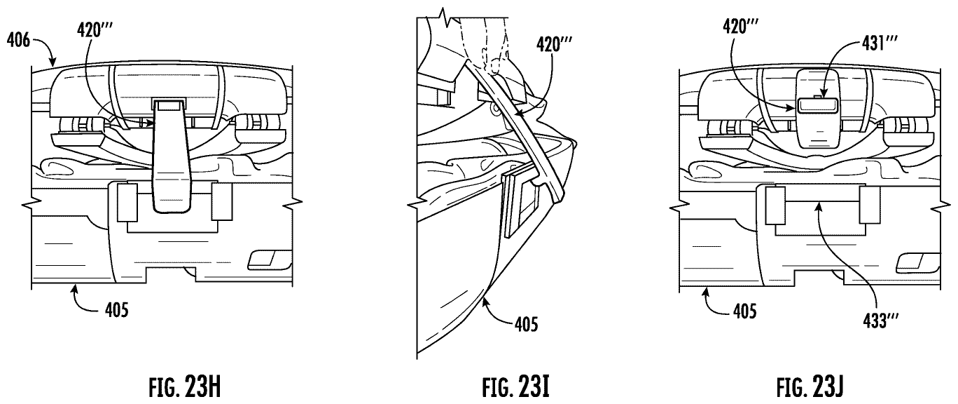

FIGS. 23a, 23b, 23c, 23d, 23e, 23f, 23g, 23h, 23i, and 23j show a flexible folding lock fixed to the base of the unit.

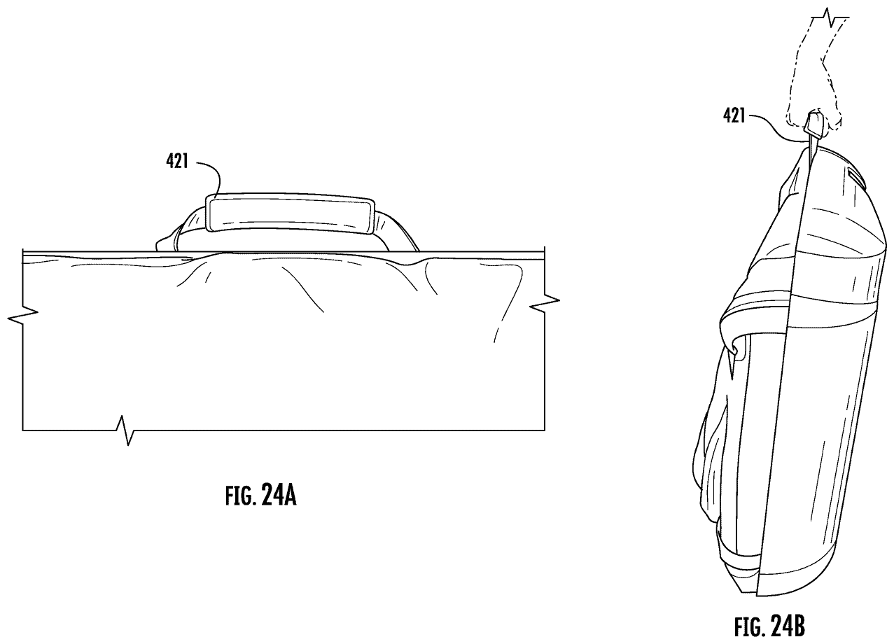

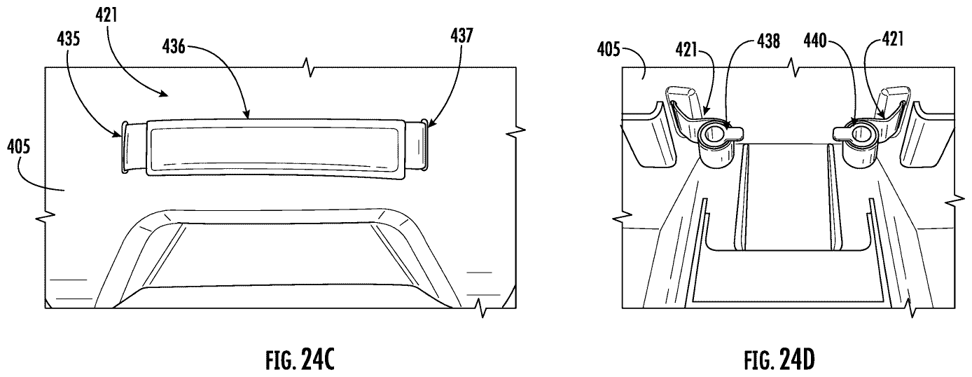

FIGS. 24a, 24b, 24c, and 24d show a handle on the front of the unit.

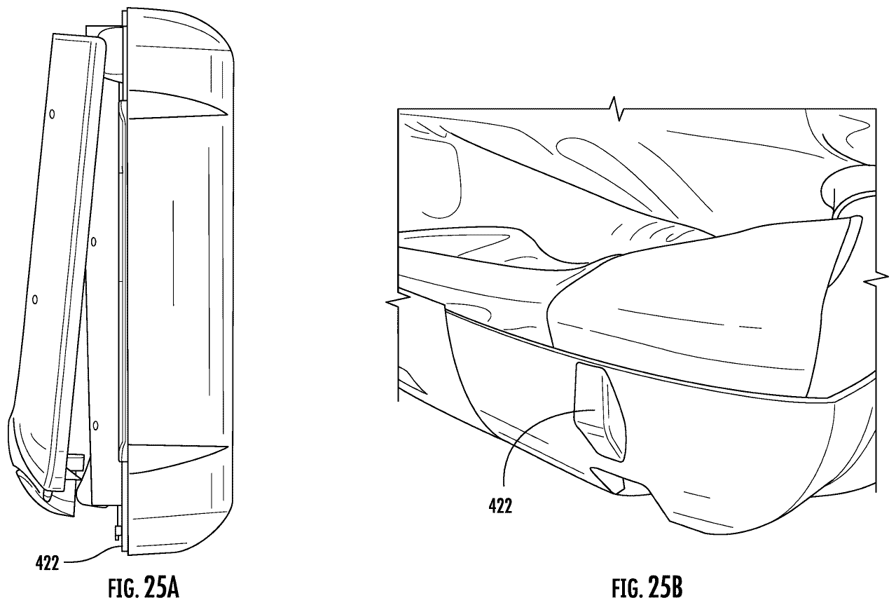

FIGS. 25a and 25b show a foot 422 on the base of the unit 400.

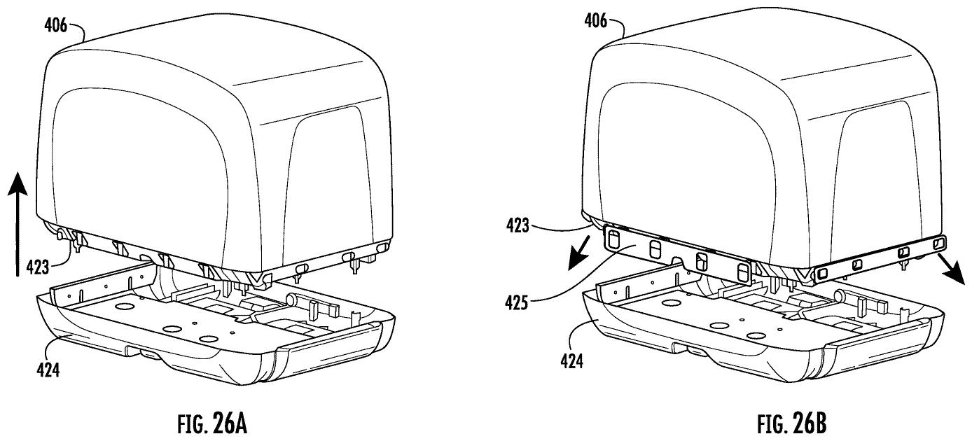

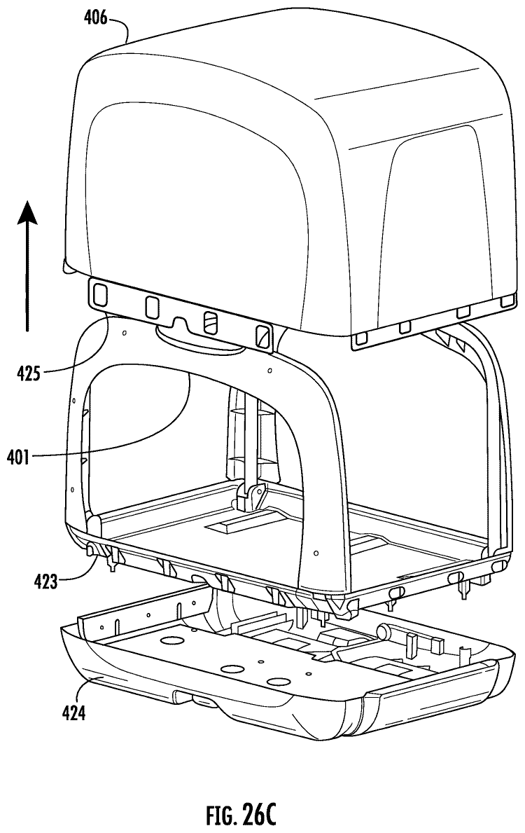

FIGS. 26a, 26b, and 26c show a progression of steps for removing the containment materials from the unit.

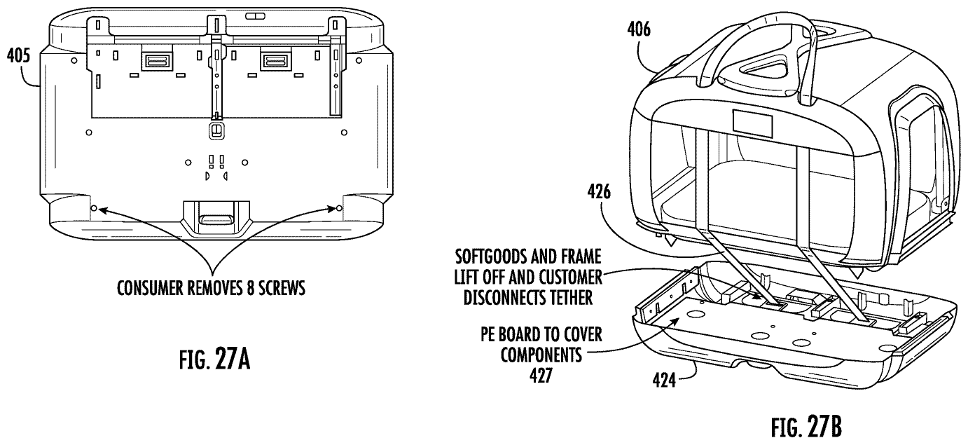

FIGS. 27a and 27b show details for removing the containment materials from the unit.

FIGS. 28a, 28b, and 28c show details of tether disconnect extending between the unit and a vehicle seat in various positions.

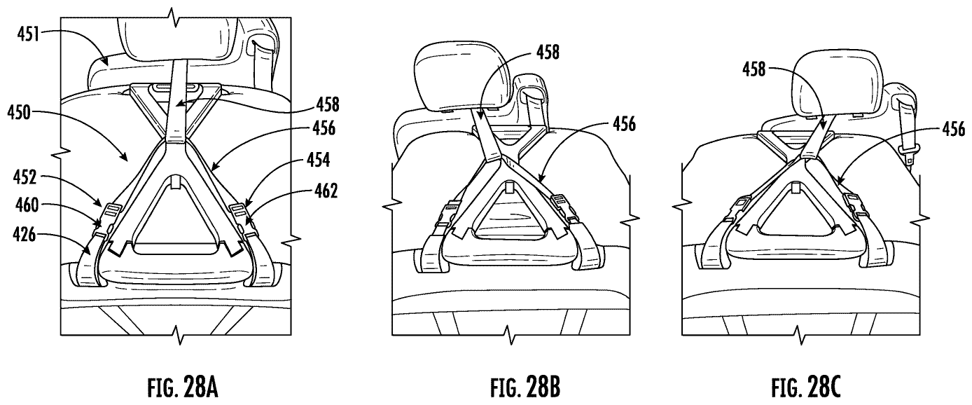

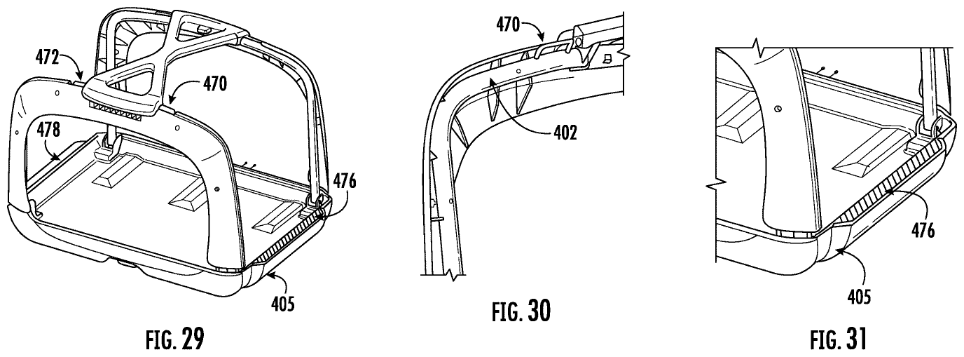

FIG. 29 shows tether guides connected to the frame structure of the unit.

FIG. 30 shows a tether guide connected to the front member of the frame structure.

FIG. 31 shows a step member positioned on the base of the unit.

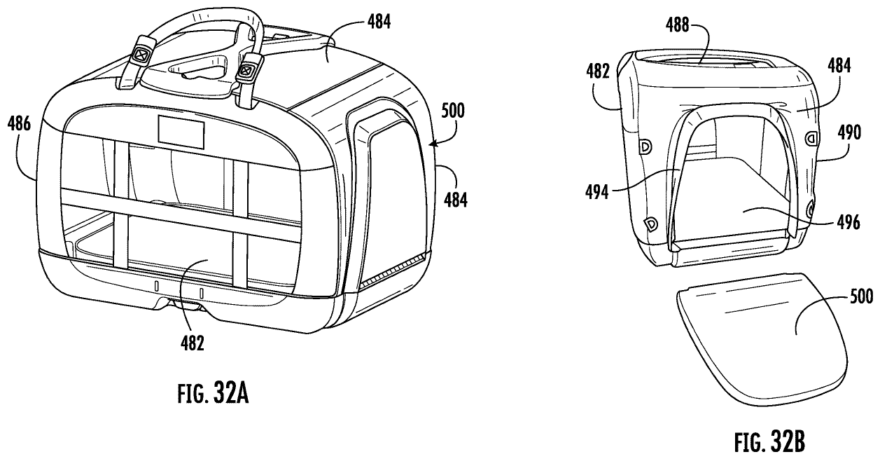

FIGS. 32a and 32b show a unit having an impact absorption.

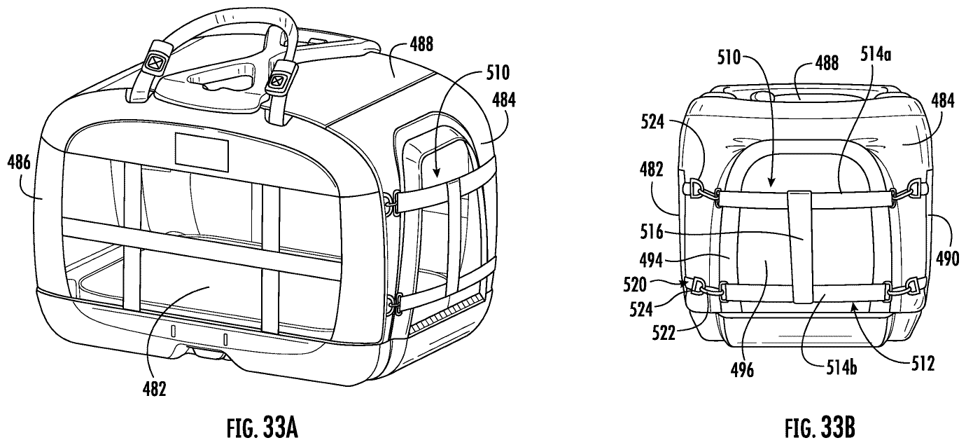

FIGS. 33a and 33b show a unit having a safety net.

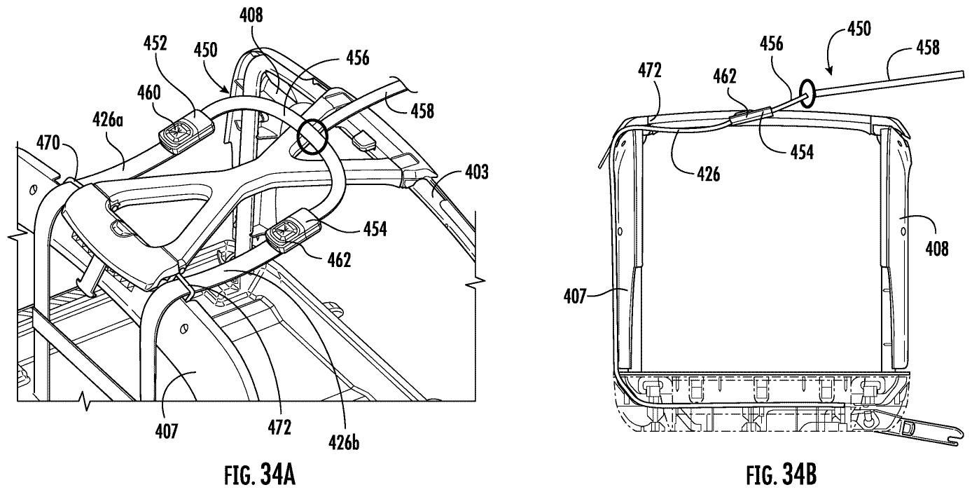

FIGS. 34a and 34b show details of an interface between a tether and a tether disconnect.

FIGS. 35a and 35b show details of a tether having a connector connectable to a tether disconnect.

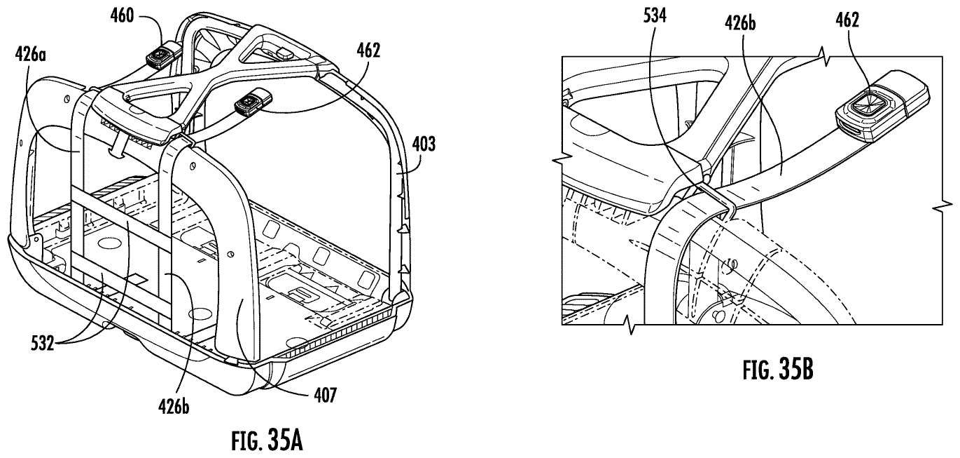

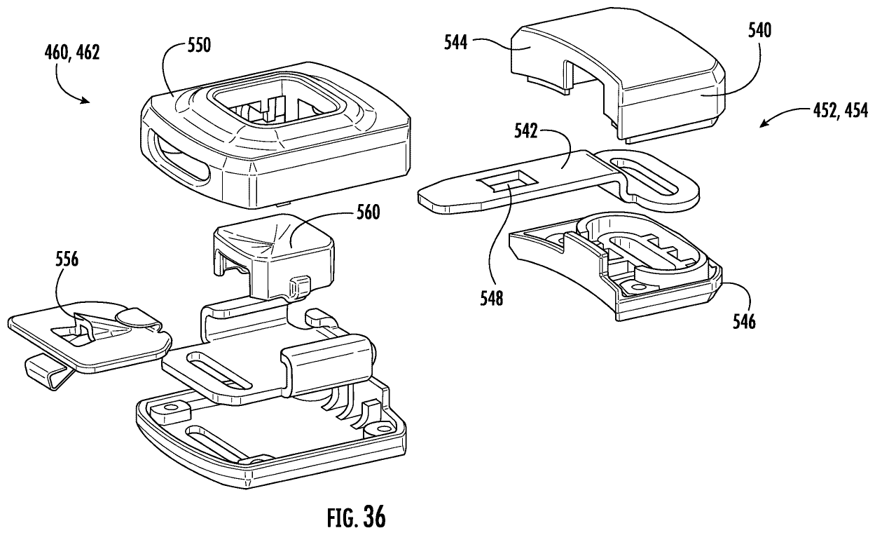

FIG. 36 shows an exploded perspective view of an interface between a tether and a tether disconnect.

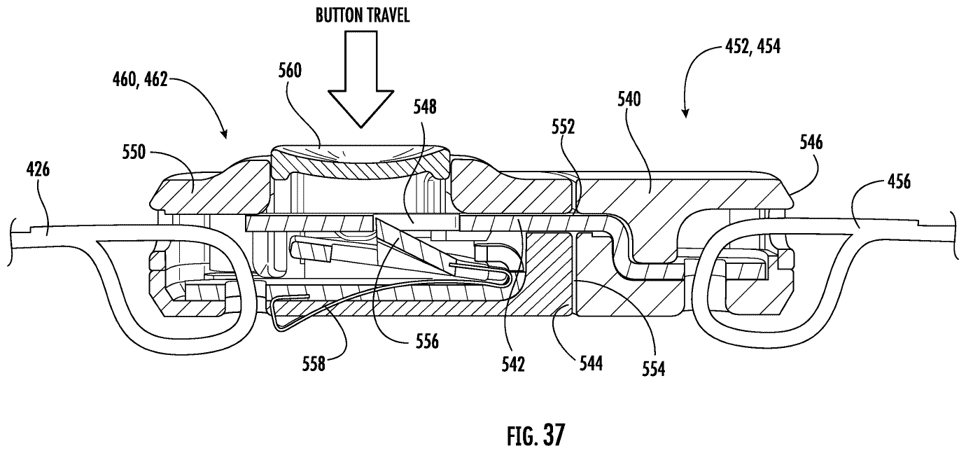

FIG. 37 shows a cross-sectional view of an interface between a tether and a tether disconnect.

### DETAILED DESCRIPTION

The present disclosure may be further understood with reference to the following description and the appended drawings, wherein like elements are referred to with the same reference numerals. The present disclosure relates to animal containment units for safely holding animals for transportation in a vehicle. The exemplary animal containment units are designed to have strength sufficient to hold larger animals, e.g., up to 50 lbs., during a car crash event without failing while maintaining flexibility sufficient to cushion the animal.

In one aspect, the unit is reinforced with webbing across its front and top sides to absorb forces that would be applied to the unit in the event of a car crash, e.g., as the animal inside is thrown against the interior of the unit. In another aspect, a latch system includes multiple latches rigidly mounted to the base of the unit is used to secure the bottom/rear of the unit to anchor points in the vehicle, (i.e., rigid elements coupled to the frame of the vehicle) accessible e.g., through gaps in the vehicle seat. In still another aspect, a tether on the top/rear of the unit is secured, e.g., to a further anchor point in the vehicle, e.g., on a rear of a vehicle seat on which the unit is mounted. These features provide a continuous loop of protection around the unit, e.g., 360 degrees of support in a longitudinal (front-back) and transverse (up-down) plane.

The units described herein generally comprise a frame structure supported by a base structure. The frame structure for the first and second exemplary embodiments includes a front member and a rear member curved in the shape of a U, with ends that couple to the base structure and extend substantially orthogonally from the base structure and a top portion formed therebetween. In a first exemplary embodiment, the frame structure further includes two middle support members connecting the front and rear members. In a second exemplary embodiment, a spanner bar is used to connect the front and rear members. The frame structure supports containment materials (e.g., soft goods) defining portions of the exterior surface of the unit and the interior surface defining the space within which the animal is contained. In some embodiments, the containment materials include at least two layers, such as a heavy-duty outer layer, a middle stiffener layer, and an interior waterproof layer that can be removed, e.g., for cleaning. In some embodiments, the webbing can be woven into one or more layers of the containment materials to provide a secure but flexible surface that can absorb the forces applied thereto in a car crash event.

The base structure for the first and second exemplary embodiments comprises a molded base (e.g., molded from plastic) and a latch system. The first exemplary embodiment additionally includes a rigid base frame, e.g., assembled from steel. The latch system comprises at least one latch, for example multiple rigid latches (e.g., two latches) that can be projected or pivoted out the bottom/rear of the base so that the latches can be rigidly coupled to anchor points in the vehicle to install the unit in the vehicle. The latches can be withdrawn into the base, e.g., when the unit is being uninstalled, carried, or stored.

In one embodiment, the latch system comprises a latch carriage coupled to the base frame that supports the latches and facilitates the actuation of the latches. The latch carriage can be translated (e.g., slid) from a first side of the unit to a second side of the unit so that the latches can be extended from the base/rear in different positions, in view of the locations in the vehicle seat where the seat frame is accessible, so that the unit can be installed on either side of the rear car seat, e.g., driver side or passenger side. Additionally, the latch carriage can be coupled with a button on the frame that can, e.g., lock the latches in the projected position or the withdrawn position and/or release the latches to transition the latches in and out of the base. In another embodiment, the latches can be pivoted into and out of the rear of the base. Similar to above, the latches can be locked or unlocked and translated to either side of the unit, to be described in greater detail below.

In still another aspect, the unit can be transitioned between an expanded state and a collapsed state. In one embodiment, the middle support members can comprise two members (a front middle support member and a rear middle support member) that can be attached to provide rigid support between the front member and rear member of the frame structure and define the top of the unit in the expanded state. The front and rear members of the middle support members can be detached from each other via a sliding actuator, whereupon the front middle support members can be rotated, relative to the front member, into a position flush with the front member and the rear middle support members can be rotated, relative to the rear member, into a position flush with the rear member. The front member (and front middle support member) can then be rotated toward the base structure (collapsed) via front rotating actuators and positioned flush with or within the base structure, whereupon the rear member (and rear middle support member) can be rotated toward the base structure (collapsed) via rear rotating actuators and positioned flush with the front member.

The sliding actuator of one embodiment comprises a length of tubing slidable over the front and rear members that can be locked in either a first position extended toward the opposing member so that the opposing member can slide thereinto or a second position retracted from the opposing member so that the opposing member is released and free to collapse. In another embodiment, the spanner bar can be detached from one or both the front member and/or the rear member, after which the front and rear members can be collapsed toward the base structure.

It is noted that a first animal containment unit according to a first exemplary embodiment, a second animal containment unit according to a second exemplary embodiment and a third animal containment unit according to a third exemplary embodiment are described herein and depicted in the Figures. However, it should be understood that various features described for the units of the first and second exemplary embodiments can be interchanged among the embodiments in any suitable manner or may be implemented in other designs for animal containment units, to be described in further detail below, and the present disclosure is not limited to the specific arrangements described in the first, second and third exemplary embodiments and depicted in the Figures.

It should be further understood that the units described herein are generally six-sided and are described with regard to a front, a rear, a first side (e.g., left side, relative to a front view), a second side (e.g., right side, relative to a front view), a bottom and a top. When the units are installed in a vehicle, the front of the unit faces the front of the vehicle, the rear of the unit faces the rear of the vehicle, etc. However, it should be understood that reference to a “side” of the units is used for ease of explanation, and that multiple different components of the unit define the exterior of the unit. For example, the “front” of the unit can comprise multiple components including the front member of the frame structure, the front of the containment materials, a front portion of the base structure, etc. Additionally, the terms “inside” and/or “interior” and/or “internal” may refer to features in a direction toward the center of the unit, relative to a certain component of the unit, and the terms “outside” and/or “exterior” and/or “external” may refer to features in a direction away from the center of the unit, relative to a certain component of the unit.

### First Exemplary Embodiment

FIGS. 1a-d show views of an animal containment unit 100 according to a first exemplary embodiment. The unit 100 is generally six-sided and is described with regard to a front, a rear, a first side (e.g., left side, relative to a front view), a second side (e.g., right side, relative to a front view), a bottom and a top. These sides are labeled in FIGS. 1a-d and these labels are omitted in the subsequent figures. FIG. 1a shows a perspective view of the unit 100; FIG. 1b shows a front view of the unit 100; FIG. 1c shows a side view of the unit 100; and FIG. 1d shows a top view of the unit 100.

### Frame Structure

The unit 100 comprises a frame structure 101 coupled to and supported by a base structure 120, to be described further below with regard to FIGS. 2a-c. The unit 100 includes containment materials 160 (e.g., soft goods) forming the exterior of the unit 100, to be described in further detail below with regard to FIGS. 6a-d. The unit 100 further includes a webbing and tether structure 180 for containing the force of an animal during a vehicle crash, to be described in further detail below with regard to FIG. 7. FIG. 7 shows the frame structure 101 and the webbing and tether structure 180 in greater detail with the containment materials 160 removed.

The frame structure 101 includes a front member 102, a rear member 103, and middle support members 104 (a first middle support member 104a and a second middle support member 104b) connecting the front member 102 and the rear member 103 when the unit 100 is in the expanded state, to be described in further detail below with regard to FIGS. 4a-c. The front member 102 is curved in a shape similar to a U and couples to the base structure 120 at both a first end 114 and a second end 115 via front rotating actuators 154a, 154b. The rear member 103 is shaped similarly to the front member 102 in a shape similar to a U and couples to the base structure 120 at both a first end 116 and a second end 117 via rear rotating actuators 156a, 156b. It is noted that, in this example, the rear member 103 is slightly shorter than the front member 102 and is mounted to the base structure 120 at a position slightly higher than the front member 102 to facilitate the collapse of the unit 100 and the definition of a rear cavity 128 in the base structure 120 for latch extension and withdrawal, to be described in further detail below.

The front member 102 extends from the first end 114 toward the top of the unit 100, curves approximately 90 degrees toward the second side and across the top of the unit 100, and curves approximately 90 degrees toward the bottom of the unit 100 and to the second end 115. The rear member 103 extends from the first end 116 toward the top of the unit 100, curves approximately 90 degrees toward the second side and across the top of the unit 100, and curves approximately 90 degrees toward the bottom of the unit 100 and to the second end 117. The front member 102 of this embodiment comprises one unitary piece that extends from the first end 114 to the second end 115. Alternatively, the front member 102 may comprise multiple pieces (e.g., having different curvatures to define the curvature of the front member 102) joined together during assembly of the unit 100. Similarly, the rear member 103 can comprise one unitary piece or can comprise multiple pieces (e.g., having different curvatures to define the curvature of the rear member 103) joined together during assembly.

In the present example, the middle support members 104 comprise two pieces, e.g., a front, middle support member 105 (a first front middle support member 105a of the first middle support member 104a and a second front middle support member 105b of the second middle support member 104b) and a rear middle support member 106 (a first rear middle support member 106a of the first middle support member 104a and a second rear middle support member 106b of the second middle support member 104b) that can be joined and/or separated through operation of respective sliding actuators 107 (a first sliding actuator 107a of the first middle support member and a second sliding actuator 107b of the second middle support member), to be described further below with regard to FIGS. 4a-c. The front middle support members 105a, 105b are coupled to the front member 102 at respective front rotating joints 112 (a first front rotating joint 112a of the front member 102 and a second front rotating joint 112b of the front member) and the rear middle support members 106 are coupled to the rear member 103 at respective rear rotating joints 113 (a first front rotating joint 112a of the front member 102 and a second front rotating joint 112b of the front member).

It is noted that, in this example, the front and rear middle support members 105, 106 are not detachable from their respective rotating joints 112, 113 and the collapsibility of the unit 100 is provided via the actuators 107 for separating the front and rear middle support members 105, 106. However, in other embodiments, the middle support members may comprise unitary pieces that are not separable into front and rear middle support members, and the collapsibility of the unit 100 may be facilitated via a mechanism for detaching the middle support members from the rotating joints to separate the middle support members from the front and/or rear members, as will be described in greater detail below.

In the present example, when the middle support members 104 are joined, e.g., when the unit 100 is in the expanded state for transporting an animal in a vehicle, the middle support members 104 extend rigidly from the front rotating joints 112 of the front member 102 to the rear rotating joints 113 of the rear member 103. The front rotating joints 112 are oriented generally orthogonally to the front member 102 to direct the middle support members 104 toward the rear, where the middle support members 104 are received in the rear rotating joints 113 that are also oriented generally orthogonally to the rear member 103 toward the front. When the middle support members 104 are separated (the front middle support members 105 are detached from the rear middle support members 106 via the actuator 107), e.g., to collapse the unit 100, the front rotating joints 112 may be rotated 90 degrees and oriented toward the bottom of the unit 100 so that the front middle support members 105 are brought flush with the front member 102 and the rear rotating joints 113 can be rotated 90 degrees and oriented toward the bottom of the unit 100 so that the rear middle support members 106 are flush with the rear member 103.

The front rotating actuators 154 can then be rotated 90 degrees and oriented toward the rear so that the front middle support members 105 and front member 102 are received within or flush with the base structure 120, whereupon the rear rotating actuators 156 can be rotated 90 degrees and oriented toward the front so that the rear middle support members 106 and the rear member 103 are flush with the collapsed front member 102, as will be described in greater detail below with regard to FIGS. 4a-c. As noted above, the rear member 103 is slightly shorter than the front member 102 and the rear rotating actuators 156 are raised relative to the front rotating actuators 154, as shown, e.g., in FIG. 1c, such that, when the unit 100 is collapsed (FIG. 4c), the rear member 103 and/or rear middle support members 106 fit snugly against and/or within the collapsed front member 102 and/or front middle support members 105.

The front and rear rotating actuators 154, 156 can be locked in either of the positions described above, e.g., oriented so that the front member 102 extends toward the top of the unit 100 and defines a front surface of the unit 100 and the rear member 103 extends toward the top of the unit 100 and defines a rear surface of the unit 100 (the expanded state) or oriented so that the front member 102 extends toward the rear of the unit 100 and the rear member 103 extends toward the front of the unit 100 (the collapsed state). Thus, the frame structure 101 can be locked in the expanded state to provide a rigid frame defining the interior/exterior of the unit 100 and the frame structure 101 can be locked in the collapsed state for ease of transportation and/or storage of the unit 100.

With reference to FIGS. 6a-d, the frame structure 101 supports the containment materials 160 defining the exterior and interior surfaces of the unit 100, including containment materials 160 for the front 165, the first side 168, the second side 169, the top 172 and the rear 173 of the unit 100. Some or all members of the frame structure 101 may be formed to include an extrusion channel 118, as shown in FIG. 6a, extending along the length of the member for receiving a plastic rod 164 running through an end of the containment materials 160. The plastic rod 164 of the containment materials 160 can be slid or snapped into the extrusion channel 118 to mount the containment materials 160 onto the members of the frame structure 101, to be described further below with regard to FIGS. 6a-d. In the present example, only the front and rear members 102, 103 comprise the extrusion channel 118 and the middle support members 104 do not directly support the containment materials 160 for, e.g., the first side 168, the second side 169 or the top 172. However, in other embodiments, the middle support members 104 may also include extrusion channels 118 to support the containment materials 160.

With reference to FIGS. 2b and 7, the frame structure 101 further supports a webbing and tether structure 180 comprising webbing 181 fixed at a first end to a front member 134 of the base frame 133 and run up the front of the unit 100, around the front member 102 of the frame structure 101, and across the top of the unit 100 to a second end fixed to the rear member 103 of the frame structure 101. As would be understood by those skilled in the art, the webbing 181 is formed of a material similar to that of which seatbelts are formed so that it is capable of withstanding the forces that will be exerted thereon when a pet is thrown against the webbing in a vehicle accident.

The webbing 181 includes two spans, 181a and 181b, extending from front attachment points 182 on the front member 134 of the base frame 133, toward the top of the unit 100, around the exterior of the front member 102 at wrap points 184, and toward the rear of the unit 100 to rear attachment points 186 on the rear member 103, to be described further below with regard to FIG. 7. The webbing 181 has fix points at the bottom-front and the top-rear of the unit 100, as described above, to provide a force containment structure extending across the front and top of the unit 100. The frame structure 101 further supports a tether 188 fixed at a first end (comprising two spans) to the rear member 103 of the frame structure 101 at locations similar to those at which the webbing 181 is fixed to the rear member 103 (e.g., rear attachment points 186). The tether 188 of this embodiment extends from the top/rear of the unit 100 and is connectable to an anchor structure in the vehicle, e.g., a vehicle frame structure on the rear of the vehicle seat, as will be described in greater detail below with regard to FIG. 8. It will be appreciated that the webbing 181 can be directly connected to the tether 188 such that the webbing 181 and tether 188 combination is fixed to the base frame 133 on one end and can be attached to an anchor structure in the vehicle on another end.

The frame structure 101 can be formed from any suitably strong material such as, for example, extruded metal tubing (e.g., aluminum). The aluminum tubing provides a rigid frame structure 101 that is sufficiently strong to make the unit 100 robust but sufficiently flexible to absorb the force of an animal impact and deform to reduce the impact on the animal. The sliding actuators 107 can comprise metal tubing shaped similarly to the frame structure 101, but with internal dimensions slightly larger than the external dimensions of the middle support members 104 so that the middle support members 104 (the rear ends of the front middle support members 105 and the front ends of the rear middle support members 106) can be slidably received therewithin and the sliding actuators 107 can slide thereon to engage and/or disengage (e.g., join or separate) the front and rear middle support members 105, 106, to be described in greater detail below with regard to FIGS. 5a-c.

### Base Structure

FIGS. 2a-c shows a base structure 120 of the unit 100 of the first exemplary embodiment. The base structure 120 includes a base 121 and a base frame 133 mounted to the base 121. A latch carriage 140 is slidably coupled to the base frame 133. FIG. 2a shows the base structure 120 and describes the base 121 in greater detail. FIG. 2b shows the base frame 133 and a latch carriage 140 of the base structure 120. FIG. 2c shows a side view of the base structure 120.

The base 121 may, for example, be molded from plastic. The base 121 comprises a bottom 122 and frame (not to be confused with the base frame 133 described below) including a front portion 123, side portions 124 (a first side portion 124a and a second side portion 124b) and a rear portion 125. The front portion 123, side portions 124 and rear portion 125 are shaped with internal channels to receive corresponding members of the base frame 133 to mount the base frame 133 on the base 121. On the front corners of the base 121 (on the front portion 123 near the intersection of the front portion 123 and the first side portion 124a; and on the front portion 123 near the intersection of the front portion 123 and the second side portion 124b) are respective front recesses 126 (a first front recess 126a and a second front recess 126b) extending toward the top of the unit 100 for receiving and coupling to the front rotating actuators 154, to be described in greater detail below with regard to FIGS. 5a-c. Similarly, on the rear corners of the base 121 (on the rear portion 125 near the intersection of the rear portion 125 and the first side portion 124a; and on the rear portion 125 near the intersection of the rear portion 125 and the second side portion 124b) are respective rear recesses 127 (a first rear recess 127a and a second rear recess 127b) extending toward the top of the unit 100 for receiving and coupling to the rear rotating actuators 156.

The interior channel formed in the rear portion 125 of the base 121 (for mounting the base frame 133 (rear member 136) to the base 121) is raised relative to the channels formed in the front portion 123 and the side portions 124, as shown in detail in FIG. 2c. In the rear portion 125, below the channel for the base frame 133, is a rear cavity 128 through which the latches 150 of the latch carriage 140 can be extended, to be described further below.

The base 121 further includes a first slot 129a formed therein extending side-to-side (left-right) across the bottom 122 and a second slot 129b formed therein extending side-to-side (left-right) across the bottom 122. The first slot 129a is located further toward the rear of the unit 100 than the second slot 129b. The first and second slots 129 facilitate the side-to-side translation of the latch carriage 140, as will be described further below.

The base frame 133, as shown in detail in FIG. 2b, includes the front member 134, two side members 135 (a first side member 135a and a second side member 135b) and a rear member 136. The front member 134, the side members 135 and the rear member 136 of this embodiment are formed from metal, e.g., steel. In the present example, these members are formed from square stock steel and welded at the connections between the members. The rear member 136 is raised relative to the front member 134 and the side members 135. The rear member 136 is joined to the first side member 135a and the second side member 135b via respective brackets 137a, 137b that can be formed of, e.g., bent sheet metal. The front member 134, side members 135 and rear member 136 of this embodiment include through-holes for mounting the base frame 133 to the base 121. In some embodiments, only the front and side members 134, 135 can include the through-holes. In the present example, the members of the base frame 133 are formed from the same size of square stock steel. However, in other embodiments, the respective members of the base frame 133 can have different cross-sectional sizes, e.g., the rear member 136 of the base frame 133 can be formed of higher stock steel than the front and side members 134, 135.

The base frame 133 provides a structure for the unit 100 that is constructed to withstand the large forces applied thereto, e.g., as would be experienced if the vehicle within which the unit 100 were mounted were to crash. As will be described in greater detail below, the base frame 133 provides a rigid structure to which the rigid latches 150 are attached at the rear and the webbing 181 is attached at the front. The webbing 181 wraps around the front and top to the rear, and the tether 188 extends from the rear to an anchor point within the vehicle (in some embodiments, behind the vehicle seat), effectively providing a full loop of protection around the unit 100.

The latch carriage 140 includes a front member 141 coupled to the front member 134 of the base frame 133 via two front guides 142 slidably coupled to the front member 134. The latch carriage 140 further includes two side members 143 (a first side member 143a and a second side member 143b) extending from first ends on the interior surface of the front member 141 toward the rear of the latch carriage 140 to second ends. Each side member 143 of the latch carriage 140 has a rear guide 144 fixed thereto (to the top of the side members 143) to couple the side member 143 to the rear member 136 of the base frame 133 (which is raised relative to the rest of the base frame 133 and the latch carriage 140). The first rear guide 144a on the first side member 143a and the second rear guide 144b on the second side member 143b are slidably coupled to the rear member 136. The front and rear guides 142, 144 allow the latch carriage 140 to translate along (in a direction parallel to) the front member 134 and the rear member 136 toward and/or away from the first side and/or the second side of the unit 100, e.g., left-right. The front guides 142 of this embodiment are formed, for example, from square stock steel having inner dimensions slightly larger than the outer dimensions of the front member 134 and the rear guides 144 can be formed from square stock having inner dimensions slightly larger than the outer dimensions of the rear member 136. In the present example, the members of the base frame 133 and the members of the latch carriage 140 are formed from the same size of square steel stock and the front and rear guide 142, 144 have the same size. It will be appreciated that the front and rear guides 142, 144 and the corresponding front and rear members 134 and 136 can include stock steel having other configurations (e.g., rectangular, cylindrical, or still other configurations).

The two side members 143 are coupled to two respective medial members 145 (a first medial member 145a and a second medial member 145b) via two medial guides 146 (a first medial guide 146a and a second medial guide 146b) slidably coupled to the medial members 145. The medial guides 146 allow the medial members 145 to translate (slide) relative to the side members 143 toward and/or away from the front and/or the rear of the unit 100. The first medial member 145a is coupled to the outside of the first side member 143a (relative to the center of the latch carriage 140) and the second medial member 145b is coupled to the outside of the second side member 143b (relative to the center of the latch carriage 140).

A rod 148 is fixed on its first end to the first medial member 145a, extends through slots 147 in the side members 143, and is fixed on its second end to the second medial member 145b. The side members 143 each have slots 147 extending therethrough (relative to a left-right direction) and further extending through a rear portion of the side members 143 toward the rear of the latch carriage 140 (e.g., a first slot 147a extends through the first side member 143a and a second slot 147b extends through the second side member 143b). A sliding member 149 is hung from the rod 148. When the unit 100 is assembled and the latches 150 are withdrawn into the rear cavity 128 in the position shown in FIG. 2a, the sliding member 149 is received in the first slot 129a on the bottom 122 of the molded base 121 and can slide within the first slot 129a as the latch carriage 140 is translated side-to-side to reposition the latches 150. When the latches 150 are extended out the rear of the unit 100, the sliding member 149 is brought out of the first slot 129a. As shown in FIG. 2c, the medial guides 146 coupling the medial members 145 to the side members 143 of the latch carriage can slide side-to-side within the second slot 129b.

A respective latch 150 is fixed to each of the rear ends of the two medial members 145 (a first latch 150a is fixed to the first medial member 145a and a second latch 150b is fixed to the second medial member 145b). The latches 150 each have latching ends 151 shaped to engage a support structure in the vehicle, e.g., a rigid member coupled to a steel frame within the seats, such as an isofix anchor point for example, to be described further below with regard to FIG. 8. The latches can be extended out of the rear cavity 128 of the rear portion 125 of the molded base 121 or can be withdrawn into the rear cavity 128.

In the non-limiting embodiments disclosed herein, the at least one latch 150 may be considered to be a “rigid latch.” A rigid latch is not mounted by a flexible structure (e.g., a strap) and, when deployed, extends a fixed distance from the device. In this manner, when installed in a vehicle and connected to isofix anchor points, any relative movement between the unit 100 and the vehicle seat are minimized or eliminated. Other example embodiments of any of the animal containment unit 100 disclosed herein may have at least one non-rigid or “soft” latch mounted by a flexible structure such as one or more straps, which may be adjustably tightened by a user for a secure fit in the vehicle.

To be described in further detail below with regard to FIGS. 3a-g, a front button 153 can be fixed or coupled to the latch carriage 140 via a front slot 131 formed in the front portion 123 of the molded base 121. In this example, the front button 153 is mounted directly to the front guides 142 fixed to the front member 141 of the latch carriage 140 and slidably coupled to the front member 134 of the base frame 133. The front button 153 is coupled to the latches 150 so that operation of the front button locks or unlock the latches 150, so that the latches 150 may be locked in or transitioned to the extended position (extending out the rear of the unit 100 for installation in a vehicle) or retracted to the withdrawn position (retracted into the rear cavity 128 in the rear portion 125 of the molded base 121).

Additionally, two side actuators 152 (a first side actuator 152a on the first side portion 124a of the base 121 and a second side actuator 152b on the second side portion 124b of the base 121) can be coupled to or disengaged from the latch carriage 140 to lock the latch carriage 140 on either the first side or the second side of the unit 100. The side actuators 152 can be pushed in to lock the latch carriage 140 or pulled out to release the latch carriage 140. When the latches 150 and/or the latch carriage 140 are unlocked (via the front button 153 or the side actuator 152), a user may manually move the latches or the latch carriage into a desired position, e.g., by removing the interior removable cushion 175 covering the base structure 120 and accessing the latch carriage 140. In an alternative embodiment, the latches 150 can be connected to a biasing member that biases the latches 150 toward the extended position so that, when the front button 153 is pushed, the latches 150 transition from the withdrawn position to the extended position.

### Actuation of the Latches and Repositioning Latch Carriage

As described above, the latches 150 of the unit 100 are fixed to the medial members 145 that are slidably coupled to the side members 143. The medial members 145 can be released from the side members 143 and slid toward and/or away from the rear and/or the front of the unit 100. The front button 153 is fixed to the front guides 142 (the front guides 142 fixed to the front member 141 of the latch carriage 140 and slidably coupled to the front member 134 of the base frame 133) via a front slot 131 in the molded base 121. The front button 153 of this embodiment is spring-loaded (provided in a cavity 130 comprising a spring) and can be depressed to either lock the medial members 145 to prevent forward/backward translation or to release the medial members 145 to allow forward/backward translation, e.g., to extend the latches 150 out the rear of the unit 100 or withdraw the latches 150 within the rear of the unit 100.

The medial members 145 can then be locked to lock the latches 150, e.g., in the extended position, by depressing the front button 153 a further time. The front button 153 can be depressed to lock the latches 150 in the extended position or the withdrawn position and to unlock the latches 150 from the extended position or the withdrawn position. Any appropriate mechanism can be used to lock the medial members 145 to the side members 143. For example, the front button 153 can be connected to a cable that is connected to a pin extending off the side members 143 toward the medial members 145. The pin can be received in a corresponding hole in the medial members 145 to lock the medial members 145 relative to the side members 143 and, accordingly, lock the latches 150 in the extended position or the withdrawn position. Those skilled in the art will ascertain that other mechanisms may also be used to lock/unlock the medial members 145.

In the present example, actuation of the front button 153 locks/unlocks the latches 150. However, in alternative embodiments, the front button 153 may be configured to automatically extend and/or withdraw the latches 150 without manual involvement by the user. In an alternative embodiment, the latches 150 can be connected to a biasing member that biases the latches 150 toward the extended position so that, when the front button 153 is pushed, the latches 150 transition from the withdrawn position to the extended position.

Independently from the mechanism described above for locking/releasing the latches 150 for forward-backward movement, the latch carriage 140 as a whole can be locked and or released with regard to side-to-side movement. As described above, the latch carriage 140 can be positioned towards the first side of the unit 100 or towards the second side of the unit 100. When the latch carriage 140 is positioned towards the first side of the unit 100, the latch carriage 140 can be locked in place using a first side actuator 152a located in a side cavity 132a of the molded base 121. The first side actuator 152a can, e.g., have an internal component that is coupled to the medial guide 146a of the latch carriage 140 when the medial guide 146a is pushed into the first side actuator 152a. The latch carriage 140 can be released by pulling the first side actuator 152a and disengaging the latch carriage 140 from the first side actuator 152a.

The latch carriage 140 can be slid toward the second side of the unit 100 with the sliding member 149 in the first slot 129a and the medial guides 146 in the second slot 129b. When the latch carriage 140 is positioned towards the second side of the unit 100, the latch carriage 140 can be locked in place using a second side actuator 152b located in a side cavity 132b of the molded base 121 that has an internal component that couples to the medial guide 146b of the latch carriage 140 when the medial guide 146b is pushed into the first side actuator 152b. It will be appreciated that either side actuator 152a, 152b can be actuated to release the latch carriage 140. For example, regardless of whether the latch carriage 140 is positioned at the first side or the second side of the unit 100, actuating either of the side actuators 152a, 152b can release the latch carriage 140 so that the latch carriage 140 can transition to the other of the first and second side of the unit 100.

FIGS. 3a-g show the actuation of the latches 150 and the operation of the latch carriage 140 to reposition the latches 150 of the unit 100 of the first exemplary embodiment. FIG. 3a shows the base structure 120 with the latch carriage 140 in a first position toward the first side of the unit 100. The latches 150a, 150b are withdrawn into the rear cavity 128 of the rear portion 125 of the base 121. In this example, the latches 150a, 150b are locked in the withdrawn position.

FIG. 3b shows the front button 153 coupled to the latch carriage 140 so that depressing the front button 153 releases the latches 150. The latches 150 can be slid out to their desired length (e.g., manually) extending out of the rear cavity 128. FIG. 3c shows the base structure 120 with the latch carriage 140 in the first position and with the latches 150 extended out the rear cavity 128. The front button 153 can be depressed a second time to lock the latches 150 in the extended position. Alternatively, after the latches 150 are transitioned from the withdrawn position to the extended position, the latches 150 can be automatically locked into the extended position. To release the latches 150, the front button 153 can be actuated, and the latches can transition back to the withdrawn position from the extended position.

FIG. 3d shows the first side actuator 152a positioned in the first side cavity 132a in the first side portion 124a of the molded base 121. The first side actuator 152a can be pulled out to release the latch carriage 140 from the first side. The latch carriage 140 can then be translated toward the second side. As the latch carriage 140 moves, the front button 153 slides within the front slot 131 as shown in FIG. 3e.

FIG. 3f shows the base structure 120 with the latch carriage 140 in the second position toward the second side of the unit 100. When the latch carriage 140 has been brought to the second position it can be locked into the second side actuator 152b. When desired, the user can withdraw the latches 150 back into the rear cavity 128 by depressing the front button 153 to release the latches 150. FIG. 3g shows the base structure 120 with the latch carriage 140 in the second position and with the latches 150 withdrawn into the rear cavity 128. The front button 153 can be depressed a second time to lock the latches 150 in the withdrawn position.

### Expanding/Collapsing Animal Containment Unit

The unit 100 of this embodiment may be transitioned between an expanded state and a collapsed state. The unit 100 can be locked into either of the two states using front and rear rotating actuators 154, 156 and the actuators 107 of the middle support members 104 of the frame structure 101. In the expanded state, the frame structure 101 provides a rigid frame for supporting the containment materials 160 and the webbing and tether structure 180 and defining aspects of the interior/exterior of the unit 100. In the collapsed state, the frame structure 101, the containment materials 160 and the webbing and tether structure 180 are folded into, substantially flush with, or adjacent to the base structure 120 to provide a slim profile for ease of portability.

FIGS. 4a-c show the unit 100 of the first exemplary embodiment transitioning from an expanded state into a collapsed state. FIG. 4a shows the unit 100 in the expanded state; FIG. 4b shows the unit 100 transitioning to the collapsed state; FIG. 4c shows the unit 100 in the collapsed state.

In the expanded state, the unit 100 is configured so that the middle support members 104 are engaged and form a rigid connection between the front member 102 and the rear member 103. To disengage the middle support members 104, the actuators 107 (first sliding actuator 107a of the first middle support member 104a and second sliding actuator 107b of the second middle support member 104b) are slid toward the front member 102 to uncover the rear middle support members 106. FIGS. 5a-c show the actuator 107 of a middle support member 104 being transitioned from a first position, engaged with the rear middle support member 106, to a second position, disengaged from the rear middle support member 106, to allow the unit 100 to collapse. FIG. 5a shows a perspective view of the actuator 107 in a first state with the front middle support member 105 and the rear middle support member 106 connected via the actuator 107; FIG. 5b shows a side view of the actuator 107 in the first state; FIG. 5c shows a side view of the actuator 107 in the second state with the front middle support member 105 and the actuator 107 disconnected from the rear middle support member 106.

The actuators 107 comprise a length of tubing having an internal diameter slightly larger the external diameter of the middle support members 104 so that the actuators 107 slide over the front middle support members 105 and the rear middle support members 106. The actuators 107 of this embodiment are coupled to the front middle support members 105 at two different positions over the front middle support member 105. The front middle support member 105 has a spring-loaded button 108 attached to its side surface and each of the sliding actuators 107 has two openings 109, e.g., a front opening 109a and a rear opening 109b, through which the button 108 can project (e.g., snap/pop in). When the button 108 is snapped into the front opening 109a, the actuator 107 extends off the front middle support member 105 toward the rear of the unit 100. The distance between the front middle support member 105 and the rear middle support member 106 is such that, when the actuator 107 is extended toward the rear off the rear end of the front middle support member 105, the front of the rear middle support member 106 can slide into the tubing of the actuator 107. This provides a rigid engagement that completes the rigid structure of the frame structure 101 when the unit 100 is expanded.

To disengage the actuator 107 from the rear middle support member 106 the button 108 can be depressed and the actuator 107 can be slid toward the front and the button 108 can be engaged with the rear opening 109b of the actuator 107. The position of the button 108 relative to the rear opening 109b of the actuator 107 is such that, in this position, the rear middle support member 106 is uncovered by the tubing of the actuator 107, thus disengaging the front middle support member 105 from the rear middle support member 106. This allows the front middle support member 105 and the rear middle support member 106 to collapse towards their respective sides. As described previously, the front middle support members 105 are coupled to the front member 102 at front rotating joints 112 and the rear middle support members 106 are coupled to the rear member 103 at rear rotating joints 113. When the middle support members 104 are disengaged via the actuator 107, a user is free to rotate the respective members toward their respective sides by rotating the rotating joints 112, 113. It is noted that the webbing 181 can be run through the channels 111 formed by the plastic loops 110 of the actuators. In other embodiments, the front middle support member 105 and the rear middle support member 106 may be connected by a rotating joint (not shown) that is released by the actuator 107 or similar structure, allowing the front middle support member 105 and the rear middle support member 106 to remain connected to each other while collapsing toward their respective sides.

As described previously, the front member 102 of the frame structure 101 is coupled to the base structure 120 via front rotating actuators 154 and the rear member 103 of the frame structure 101 is coupled to the base structure 120 via rear rotating actuators 156. The front rotating actuators 154 and the rear rotating actuators 156 include spring-loaded buttons that can be depressed to rotate the actuators 154, 156. When the buttons of both front rotating actuators 154 are depressed, the front rotating actuator 154 is freed to rotate towards the base of the unit 100. When the buttons of both rear rotating actuators 156 are depressed, the rear rotating actuators 156 are freed to rotate toward the base of the unit 100. The buttons can be released to lock the rotating actuators 154, 156, and the members of the frame structure 101 coupled to the rotating actuators 154, 156, in position.

FIG. 4a shows the unit 100 in the expanded state. The front rotating actuators 154 are locked with the front member 102 (e.g., a longitudinal plane thereof) positioned orthogonal to the base 121. The rear rotating actuators 156 are locked with the rear member 103 positioned orthogonal to the base 121. The front middle support members 105 are engaged with the rear middle support members 106 via the actuators 107.

FIG. 4b shows the unit 100 transitioning to the collapsed state. The sliding actuator 107 has disengaged the front middle support members 105 from the rear middle support members 106. The front middle support members 105 have rotated down so that the front middle support members 105 (e.g., a longitudinal plane thereof) are parallel with the front member 102. The rear middle support members 106 have rotated down so that the rear middle support members 106 (e.g., a longitudinal plane thereof) are parallel with the rear member 103. The front member 102 is rotated toward the base and collapsed first, and the rear member 103 is rotated toward the base and collapsed next, following the front member 102.

As described previously, the base 121 is shaped so that the front recesses 126 for the front rotating actuators 154 are positioned closer to the bottom 122 than the rear recesses 127 for the rear rotating actuators 156. Thus, when the front member 102 and attached front middle support members 105 are rotated toward the bottom 122, these members can rotate 90 degrees from their original position and lie flat across the top of the latch carriage 140 and partially or fully within the base 121. When the rear member 103 and attached rear middle support members 106 are rotated toward the bottom 122, these members can rotate 90 degrees from their original position and lie flat across the top of the front member 102.

FIG. 4c shows the unit 100 in the collapsed state. The unit 100 can be locked into the collapsed state for ease of storage, shipping, portability, etc.

### Materials

As described above, the frame structure 101 supports the containment materials 160 (e.g., soft goods) defining exterior surfaces of the unit 100 and interior surfaces of the unit 100 defining the space within which the animal is contained. The containment materials can have a number of layers of material. In this example, the containment materials include a heavy-duty outer layer, a middle stiffener layer, and an interior waterproof layer that can be removed, e.g., for cleaning.

FIGS. 6a-d show the containment materials 160 of the unit 100. FIG. 6a shows a cross-sectional view of the containment materials 160. The containment materials 160, as shown in FIG. 6a, generally include an exterior layer 161, a stiffener layer 162, and an interior layer 163. The exterior layer 161 may, for example, be a heavy-duty material while the stiffener layer 162 is a softer material to protect the animal from harmful contact with the vehicle and the metal frame, e.g., foam. The interior layer 163 may, for example, be a heavy-duty waterproof fabric. The interior layer 163 can be removable for washing. It should be understood that additional layers can be provided. FIG. 6b shows the exterior layer 161 for the containment materials 160 with the unit 100 in the expanded state; FIG. 6c shows the stiffener layer 162 for the containment materials 160 with the unit 100 in the expanded state; FIG. 6d shows the interior layer 163 for the containment materials 160 with the unit 100 in the expanded state.

The containment materials 160 additionally include a plastic rod 164 running through a side of the containment materials 160. For certain portions of the containment materials, the plastic rod 164 may be included to attach the containment materials 160 to the base structure 120. As described above, some or all members of the frame structure 101 can be formed with an extrusion channel 118, as shown in FIG. 6a, extending along the length of the member for receiving the plastic rod 164 running through the containment materials 160. The plastic rod 164 can be slid or snapped into the extrusion channel 118 to mount the containment materials 160 onto the members.

The containment materials 160 and the frame structure 101 can be designed in various ways, e.g., so that the containment materials 160 for the first side 168, top 172 and second side 169 comprise one piece that has plastic rods 164 coupling to extrusion channels 118 in the front and rear members 102, 103. In another example, the containment materials 160 for each side (top, first side, second side, front, back) can be separate pieces, each supported via separate extrusion channels 118 on the members of the frame structure 101. In the present example, only the front and rear members 102, 103 include an extrusion channel 118 and the middle support members 104 do not directly support the containment materials 160 for, e.g., the first side 168, the second side 169 or the top 172. However, in other embodiments, the middle support members 104 could also include extrusion channels 118 to support the containment materials 160.

The containment materials 160 for the unit 100 include a front 165, a first side 168, a second side 169, a top 172, and a rear 173. As previously noted, the containment materials 160 may be connectable to the base structure 120 or to the frame structure 101. In an embodiment, the base structure 120, frame structure 101, and containment materials 160 cooperate to define an enclosure or space within which an animal may be contained. The front 165 includes a window 166 allowing for air flow for seeing in and out of the unit 100. The front 165 further includes slits 167 (e.g., a first slit, a second slit and a third slit) to weave the webbing 181 into the front 165, to be described in greater detail below with regard to FIG. 7. The first side 168 and the second side 169 can both include a door 170 for accessing the interior of the unit 100, e.g., to place an animal inside or remove the animal. In such embodiments, a door may be connectable to the first side 168 and/or the second side 169 via a zipper. In another example, only the first side 168 or the second side 169 has a door 170. The first side 168 and/or the second side 169 and/or the rear 173 can also have windows 171, similar to the window 166 in the front 165.

In this example, the webbing 181 is interlaced with (e.g., woven into) the slits 167 in the exterior layer 161 only (e.g., not woven into the middle or interior layers 162). In other embodiments, the webbing 181 is woven into additional layers. Additionally, the unit 100 includes an interior cushion 174 on the base that can be removed to access the latch carriage 140.

### Webbing and Tether

As discussed above, the unit 100 is reinforced with a webbing and tether structure 180 that provides additional reinforcement to the unit 100 when it is installed in a vehicle. The webbing 181 extends across the front and top of the unit 100 to restrain the animal by absorbing and transmitting to the frame of the vehicle forces applied to the unit 100 in the event of a car crash (e.g., as an animal inside is thrown against the interior of the unit 100). In use, the tether 188 on the top/rear of the unit 100 is secured to one or more anchor points in the vehicle, e.g., on the rear of the vehicle seat. These features, in combination with the latches 150 rigidly mounted to the base 121 of the unit 100 and the rigid base frame 133, provide a continuous loop of protection around the unit 100 (e.g., 360 degrees of support).

FIG. 7 shows the webbing and tether structure 180 for the unit 100 assembled with the frame structure 101 and the base structure 120. The webbing 181 includes two spans (e.g., a first span 181a and a second span 181b) that extend from front attachment points 182 (a first front attachment point 182a and a second front attachment point 182b) on the front member 134 of the base frame 133 to rear attachment points 185 (a first rear attachment point 185a and a second rear attachment point 185b) on the rear member 103. Each of the first and second spans 181a, 181b includes a front portion 183 woven through at least one layer of the front 165 containment materials 160. A first end of the front portion 183 is attached to the front member 134 of the base frame 133, and is run within a first portion of the front 165 to extend outside the front 165 at the first slit so that the webbing continues to the second slit, is run within a second portion of the front 165 to the third slit, at which point the remainder of the span of webbing 181 is run outside the containment materials 160.

The webbing 181 continues to wrap around the top of the front member 102 at the wrap points 184. The webbing 181 continues to a top portion and is routed through the channels 111 of the actuators 107 on the middle support members 104 to a rear attachment point 185 are on the rear member 103. In an aspect, the webbing 181 can continue along the top portion without being routed through the channels 111 of the actuators 107.

A tether 188 includes two spans 189 sewn at a first end around the rear member 103, e.g., at the rear attachment points 185 for the webbing 181. The two spans 189 are brought together at an attachment point 190. From the attachment point 190 the tether 188 continues to a rear span 191 with a connector 192 at its end for an anchor point in the vehicle. In an aspect, one end of the two spans 189 of the tether 188 connect directly to the respective spans 181a, 181b, and the other end of the two spans 189 of the tether 188 are brought together at the attachment point 190.

In some vehicles, the rear-facing side of the rear seats may have anchoring locations for the tether 188. In other vehicles, the anchoring locations may be located elsewhere in the vehicle.

FIG. 8 shows a diagram of the unit 100 of the first exemplary embodiment installed in a vehicle. As shown, the latches 150 are connected at their latching ends 151 to the steel frame of the car. The connector 192 at the end of the tether 188 is wrapped from the rear member 103 of the frame structure 101 to an anchor point on the back of the vehicle seat. This forms a full loop of protection from the latches 150 through the base frame 133, through the webbing 181, and finally through the tether 188 attached to the anchor on the back of the seat.

### Second Exemplary Embodiment

FIGS. 9a-c show views of an animal containment unit 200 according to a second exemplary embodiment. Similar to the unit 100 described above, the unit 200 is generally six-sided (although any other arrangement that provides the desired space for containing the animal may be used) and is described with regard to a front, a rear, a first side (e.g., left side, relative to a front view), a second side (e.g., right side, relative to a front view), a bottom and a top. These sides are labeled in FIG. 9a and omitted in the subsequent figures. FIG. 9a shows a perspective view of the unit 200; FIG. 9b shows an exploded view of the unit 200; FIG. 9c shows a top view of the unit 200.

### Frame Structure

The unit 200 comprises a frame structure 201 coupled to and supported by a base structure 224, as will be described further below with regard to FIGS. 10a-b. The unit 200 includes containment materials 250 (e.g., soft goods) forming the exterior of the unit 200, which may be similar to the containment materials 160 described with regard to the first exemplary embodiment. The unit 200 further includes a webbing and tether structure 270 (not shown in FIGS. 9a-c) for containing the force of an animal during a vehicle crash, similar to the webbing and tether structure 180 of the first exemplary embodiment, as will be described in further detail below with regard to FIGS. 13a-c.

The frame structure 201 includes a front member 202, a rear member 203, and a spanner bar 204 connecting the front member 202 and the rear member 203 when the unit 200 is in the expanded state, to be described in further detail below with regard to FIG. 12. The front member 202 is curved in a shape similar to a U and couples to the base structure 224 at both a first end 210 and a second end 211 via front rotating actuators 220a, 220b. The rear member 203 is shaped similarly to the front member 202 in a shape similar to a U and couples to the base structure 224 at both a first end 212 and a second end 213 via rear rotating actuators 221a, 221b. The front member 202 and the rear member 203 may be shaped similarly to the front member 102 and the rear member 103 of the first exemplary embodiment.

The front member 202 extends from the first end 210 toward the top of the unit 200, curves approximately 90 degrees toward the second side and across the top of the unit 200, and curves approximately 90 degrees toward the bottom of the unit 200 and to the second end 211. The rear member 203 extends from the first end 212 toward the top of the unit 200, curves approximately 90 degrees toward the second side and across the top of the unit 200, and curves approximately 90 degrees toward the bottom of the unit 200 and to the second end 213. The front member 202 and rear member 203 can each comprise one unitary piece or can each comprise multiple pieces joined together during assembly.

The spanner bar 204 comprises a front middle support member 205, a rear middle support member 207, and a center middle support member 209. The front middle support member 205 is curved in a shape similar to a U and couples to the front member 202 at both a first end 206a and a second end 206b via front rotating joints 216a, 216b. The rear member 203 is shaped similarly to the front member 202 in a shape similar to a U and couples to the base structure 224 at both a first end 212 and a second end 213 via rear rotating actuators 221a, 221b. Similar to the first exemplary embodiment described above, the rear member 203 is slightly shorter than the front member 202 and is mounted to the base structure 224 at a position slightly higher than the front member 202 to facilitate the collapse of the unit 200.

The spanner bar 204 of the present example is not separable into multiple pieces, as contrasted to the middle support members 104 described above for the first exemplary embodiment, which are separable into the front middle support member 105 and the rear middle support member 106 via the actuator 107 to collapse the frame structure 101. Rather, the spanner bar 204 is detachable from either one or both of the front member 202 and/or the rear member 203 to collapse the frame structure 201. The first and second ends 206a, 206b of the front middle support member 205 of the spanner bar 204 can clip into the front rotating joints 216a, 216b under a pushing force and can be unclipped from the front rotating joints 216a, 216b under a pulling force. In a similar manner, the first and second ends 208a, 208b of the rear middle support member 207 of the spanner bar 204 can clip into the rear rotating joints 217a, 217b under a pushing force and can be unclipped from the rear rotating joints 217a, 217b under a pulling force. To collapse the unit 200, the spanner bar 204 can be detached from either one or both of the front member 202 and/or rear member 203 of the frame structure 201, as will be described in greater detail below.

Referring to FIGS. 9a-b, the frame structure 201 supports the containment materials 250 defining the exterior and interior surfaces of the unit 200, including containment materials 250 for the front 251, the first side 252, the second side 253, the top 254 and the rear 255 of the unit 200. Some portions of the containment materials 250 can be wrapped outside of frame structure 201, while other portions of the containment materials 250 can be within the frame structure 201. In the present example, the containment materials 250 are wrapped around the exterior of the front and rear members 202, 203, however, the spanner bar 204 is on the exterior of the containment materials 250 on the top 254 of the unit 200. Thus, the spanner bar 204 can additionally be used as a handle for carrying the unit 200 in the expanded state.

Referring to FIGS. 13a-b, the frame structure 201 further supports a webbing and tether structure 270 comprising webbing 271 fixed at a first end to the base structure 224 and run up the front of the unit 200, around the front member 202 of the frame structure 201, and across the top of the unit 200 to a second end fixed to the rear member 203 of the frame structure 201, to be described in greater detail below.

The frame structure 201 can be formed from extruded metal tubing, e.g., aluminum, similar to the first exemplary embodiment. The aluminum tubing provides a rigid frame structure 201 that is sufficiently strong to make the unit 200 robust but sufficiently flexible to absorb the force of an animal impact and deform to reduce the impact on the animal, as described in further detail below with regard to FIG. 13c.

### Base Structure

FIGS. 10a-b show the base structure 224 of the unit 200 of the second exemplary embodiment. The base structure 224 includes a top part 225 and a bottom part 234 that nest together with the top part 225 sliding into the bottom part 234. FIG. 10a shows the base structure 224 with the top part 225 nested with the bottom part 234; FIG. 10b shows the bottom part 234 of the base structure 224.

The top part 225 and the bottom part 234 can be molded, for example, from plastic. The top part 225 includes a bottom 226 and a frame including a front portion 227, side portions 228 (a first side portion 228a and a second side portion 228b) and a rear portion 229. On the front corners of the top part 225 (on the front portion 227 near the intersection of the front portion 227 and the first side portion 228a; and on the front portion 227 near the intersection of the front portion 227 and the second side portion 228b) are respective front recesses 230 (a first front recess 230a and a second front recess 230b) extending through the top part 225 for receiving and coupling to the front rotating actuators 220. Similarly, on the rear corners of the top part 225 (on the rear portion 229 near the intersection of the rear portion 229 and the first side portion 228a; and on the rear portion 229 near the intersection of the rear portion 229 and the second side portion 228b) are respective rear recesses 231 (a first rear recess 231a and a second rear recess 231b) extending through the top part 225 for receiving and coupling to the rear rotating joints 217. Similar to the first exemplary embodiment, the rear recesses 231 are raised relative to the front recesses 230, as shown in FIGS. 9b and 10a.

The bottom part 234 includes a bottom 235 and a frame including a front portion 236, side portions 237 (a first side portion 237a and a second side portion 237b) and a rear portion 238. In the rear portion 238 is a cutout portion 239 in the bottom 235 and rear portion 238 that contains the latch system 240 for the second exemplary embodiment, as described further below with regard to FIGS. 11a-d. The bottom part 234 further includes a lock 246 for the latch system 240 in a recess in the bottom 235.

### Latch System

The latch system 240 of the second exemplary embodiment comprises pivoting rigid latches. It will be appreciated that the latches can comprise sliding retractable rigid latches as described above in the first exemplary embodiment. The latch system 240 is located at the bottom of the unit 200 and can be accessed by a user from the exterior of the unit 200 to transition (pivot) the latches 242 into and/or out of the base structure 224 and/or to slide the latches 242 from a first position on the first side of the unit 200 to a second position on a second side of the unit 200.

FIGS. 11a-d show the latch system 240 of the unit 200 of the second exemplary embodiment. FIG. 11a shows the latch system 240 without the base structure 224; FIG. 11b shows a bottom view of the latch system 240 mounted in the bottom part 234 of the base structure 224 with the latches 242 pivoted into the extended position on a first side of the unit 200; FIG. 11c shows a bottom view of the latch system 240 with the latches 242 pivoted into the retracted position on the first side of the unit 200; FIG. 11d shows a bottom view of the latch system 240 with the latches 242 pivoted into the extended position on a second side of the unit 200.

The latch system 240 includes a rod 241 mounted to the rear portion 238 of the bottom part 234 within the bottom cutout 239. Two rigid latches 242 (e.g., a first latch 242a and a second latch 242b) are slidably and rotatably coupled to the rod 241, such that the latches 242 can slide along the length of the rod 241 and pivot about the rod 241. The first and second latches 242a, 242b are connected with a rigid member therebetween so that a constant distance is maintained between the first and second latches 242a, 242b. The latches 242 have latching ends 243 for connecting to anchor points, e.g., steel frame structure, in the vehicle.

The latch system 240 further includes two brackets 244 (a first bracket 244a and a second bracket 244b) fixed around the rod 241. The brackets 244 prevent lateral movement of the latches 242 when the latches 242 are pivoted out in the extended position. The brackets 244 further include connection features 245 for coupling the webbing 271 to the bottom part 234, as will be described in further detail below with regard to FIGS. 13a-c.

As shown in the bottom views of FIGS. 11b-d, the latch system 240 further includes a lock 246 for locking and/or unlocking the latches 242. In FIG. 11b, the latches 242 are unlocked and positioned on the second side of the unit 200. In FIG. 11c, the latches 242 are pivoted into the bottom cutout 239 of the rear portion 238 of the bottom part 234 of the base structure 224. The latches 242 can be coupled to the lock 246 and locked in the retracted position. Alternatively, the latches 242 can remain unlocked and slide to the first side of the unit 200. In FIG. 11d, the latches are pivoted out of the bottom cutout 239 on the first side of the unit 200.

### Expanding/Collapsing

The unit 200 can be transitioned between an expanded state and a collapsed state, similar to the first exemplary embodiment. In the expanded state, the frame structure 201 provides a rigid frame for supporting the containment materials 250 and the webbing and tether structure 270 and defining aspects of the interior/exterior of the unit 200. In the collapsed state, the frame structure 201, the containment materials 250 and the webbing and tether structure 270 are folded into, substantially flush with, or adjacent to the base structure 120 to provide a slim profile for ease of portability.

When the unit 200 is in the expanded state for transporting an animal in a vehicle, the spanner bar 204 extends rigidly from the front rotating joints 216 of the front member 202 to the rear rotating joints 217 of the rear member 203. The front rotating joints 216 are oriented orthogonally to the front member 202 to direct the front middle support member 205 toward the rear. The rear middle support member 207 is received in the rear rotating joints 217 that are oriented orthogonally to the rear member 203 toward the front.

When either the ends 206a, 206b of the front middle support member 205 or the first and second ends 208a, 208b of the rear middle support member 207 are separated from the front and rear rotating joints 216, 217, e.g., to collapse the unit 200, the front rotating joints 216 can be rotated 90 degrees and oriented toward the bottom of the unit 200 and/or the rear rotating joints 217 can be rotated 90 degrees and oriented toward the bottom of the unit 200. If the spanner bar 204 remains connected, the rotation of the rear rotating joints 217 will bring the spanner bar 204 within, substantially flush with, or adjacent to the member (e.g., front member 202 or rear member 203) to which it is connected. Alternatively, the spanner bar 204 can be detached from both the front and rear members 202, 203 and removed completely.

The front rotating actuators 220 can then be rotated 90 deg and oriented toward the rear so that the front member 202 is received within, substantially flush with, or adjacent to the base structure 224, whereupon the rear rotating actuators 221 can be rotated 90 degrees and oriented toward the front so that the rear member 203 is substantially flush with or adjacent to the collapsed front member 202. As noted above, the rear member 203 is slightly shorter than the front member 202 and the rear rotating actuators 221 are raised relative to the front rotating actuators 220 such that, when the unit 200 is collapsed, the rear member 203 fits snugly against and/or within the collapsed front member 202. The front and rear rotating actuators 220, 221 can be locked in either of the positions described above, e.g., oriented so that the front member 202 extends toward the top of the unit 200 and defines a front surface of the unit 200 and the rear member 203 extends toward the top of the unit 200 and defines a rear surface of the unit 200 (the expanded state) or oriented so that the front member 202 extends toward the rear of the unit 200 and the rear member 203 extends toward the front of the unit 200 (the collapsed state). Thus, the frame structure 201 can be locked in the expanded state to provide a rigid frame defining the interior/exterior of the unit 200 and the frame structure 201 can be locked in the collapsed state for ease of transportation and/or storage of the unit 200.

FIG. 12 shows the unit 200 of the second exemplary embodiment transitioning from an expanded state into a collapsed state. In 260, the unit 200 is in the expanded state. The spanner bar 204 is connected to the front and rear members 202, 203 forming a rigid connection between the members. To disengage the spanner bar 204, the ends 206 of the front middle support member 205 of the spanner bar 204 are disengaged from the front member 202. Alternatively, the ends 208 of the rear middle support member 207 can be disengaged from the rear member 203. In 261, the front member 202 is collapsed toward the base structure 224 via the front rotating actuators 220. In 262, the front member 202 is stored substantially flush with the base structure 224 while in 263, the spanner bar 204 is collapsed toward the rear member 203 via the rear rotating joints 217. In 264, the spanner bar 204 folds under the rear member 203. Finally, in 265, the rear member 203 is collapsed toward the base structure 224 via the rear rotating actuators 221. In 266, the rear member 203 is stored substantially flush with the base structure 224.

### Webbing and Tether

The unit 200 is reinforced with a webbing 271 and a tether structure 270 that provides additional reinforcement to the unit 200 when it is installed in a vehicle. The webbing 271 extends across the bottom, front and top of the unit 200 to absorb the force that could be applied to the unit 200 in the event of a car crash, e.g., if the animal inside is thrown against the interior of the unit. The tether 280 on the top/rear of the unit 200 is configured to be secured to an anchor point in the vehicle. Those skilled in the art will understand that any known connectors for coupling to vehicle anchor points may be used for any of the connections described in regard to the exemplary embodiments. These features, in combination with the latches 242 rigidly mounted to the base structure 224 of the unit 200, provide a continuous loop of protection around the unit 200, e.g., 360 degrees of support. Alternatively, with any of the embodiments described herein, the loop of protection may extend only around 270 degrees as the back of the seat on which the unit 200 is mounted can provide protection for events in which the animal is thrown rearward.

FIG. 13a shows the webbing and tether structure 270 for the unit 200 of the second exemplary embodiment assembled with the frame structure 201 and the base structure 224. The webbing 271 includes a first span 271a and a second span 271b that extend from rear bracket attachment points 272 (a first rear bracket attachment point 272a and a second rear bracket attachment point 272b) in the latch system 240 of the base structure 224 to a rear frame attachment point 278 on the spanner bar 204 or the rear member 203 of the frame structure 201. Each of the first and second spans 271a, 271b includes a bottom portion 273 extending through the bottom part 234 of the base structure 224 around the bottom 226 of the top part 225. The webbing 271 continues to a wrapping 274 at which it wraps around the top part 225 of the base structure 224 and continues into front portions 275.

The webbing 271 then wraps 276 around the front member 202 of the frame structure 201. The webbing 271 continues to a top portion 277 and the first and second spans 271a, 271b are joined at a rear frame attachment point 278 that may be on the spanner bar 204 or the rear member 203. In an aspect, the rear bracket attachment points 272 can be defined by the brackets 244 of the latch system 240. The brackets 244 can be rigidly fixed to the base structure 224, such that when the latches 242 are connected to the anchor structure in the vehicle, a rigid continuous loop is formed that extends from the anchor structure in the vehicle to an end of the webbing 271.

The frame structure 201 further supports a tether 280 fixed to either the spanner bar 204 or the rear member 203. The tether 280 can extend from the top/rear of the unit 200 and attach to an anchor structure in the vehicle, e.g., on the back of the seat. In an aspect, the tether 280 can be directly connected to the webbing 271 on one end, and the tether 280 can be configured to attach to the anchor structure in the vehicle on the other end.

FIG. 13b shows a diagram of the unit 200 of the second exemplary embodiment installed in a vehicle. As shown, the latches 242 are connected at their latching ends 243 to the steel frame of the car. The connector 281 at the end of the tether 280 is wrapped from the rear member 203 of the frame structure 201 to an anchor point on the back of the seat. This forms a full loop of protection from the latches 242 through the webbing 271, and finally through the tether 280 attached to the anchor on the back of the seat.

FIG. 13c shows the unit 200 deflecting under the force of a car crash. Those skilled in the art will understand that the deformation of the unit 200 will be substantially similar to that of the unit 100 when subjected to similar forces. As seen in FIG. 13c, in the initial state the side view of the unit 200 presents as substantially square in cross-section with the frame structure 201 and webbing 271 extending along substantially similar paths over the front and top surfaces of the unit 200. Upon impact, the animal is thrown forward impacting the webbing 271 and pushing the webbing 271 forward out of line with the frame structure 201. At the same time, as the webbing 271 moves forward beyond the front of the frame structure 201 (i.e., stretching of the webbing is minimal), the webbing 271 pushes the front of the frame structure 201 rearward while the base remains in the same position as it is coupled to the anchor points. Thus, in this position the top of the frame structure 201 is further rearward and slightly lower while the sides of the frame structure 201 have rotated (counterclockwise in this view) to accommodate the motion of the top of the frame structure 201.

FIG. 14 shows the installation of the unit 200 in a vehicle. In 285, the unit 200 is collapsed so that it may fit through the vehicle door. In 286, the latches are pivoted into the expended position and attached to the steel frame of the vehicle. In 287, the unit 200 is unfolded. In 288, the unit 200 is fully unfolded.

### Third Embodiment

FIGS. 15a-b show views of an animal containment unit 300 according to a third exemplary embodiment. Similar to the unit 200 of the second exemplary embodiment described above, the unit 300 of the third exemplary embodiment is generally six-sided (although any other arrangement that provides the desired space for containing the animal may be used) and is described with regard to a front, a rear, a first side (e.g., left side, relative to a front view), a second side (e.g., right side, relative to a front view), a bottom and a top. These sides are labeled in FIGS. 15a-b and omitted in the subsequent figures.

The unit 300 of the third exemplary embodiment has certain features similar to the unit 200 described for the second exemplary embodiment, including certain aspects of the frame structure, base structure, latch system, containment materials and webbing and tether structure. However, the unit 300 of the third exemplary embodiment comprises certain actuation mechanisms different from those of the second exemplary embodiment as will be described in detail below. It is noted that the containment materials and webbing and tether structure of the third exemplary embodiment may be arranged similarly to those of the second exemplary embodiment and are not shown in FIGS. 15a-b. FIG. 15a shows a perspective view of the unit 300; FIG. 15b shows a bottom view of the unit 300.

The unit 300 comprises a frame structure 301 coupled to and supported by a base structure 320. The frame structure 301 includes a front member 302, a rear member 303, and at least one middle member, such as an X-bar 304 for example, connecting the front member 302 and the rear member 303 when the unit 300 is in the expanded state, to be described in further detail below with regard to FIG. 16. The front member 302 and the rear member 303 of the third exemplary embodiment may be shaped similarly to the front member 202 and the rear member 203 of the second exemplary embodiment. In this example, the front member 302 additionally includes recesses (e.g., slots) for receiving pins 310 of the X-bar 304 to attach the X-bar 304 to the front member 302, to be described below.

The X-bar 304 comprises a front portion 305, a middle portion 306 and a rear portion 307. The front portion 305 of this embodiment is attached to the front member 302 of the frame structure 301, and extends in two lengths toward the rear/middle and join at the middle portion 306, and also extends from the middle portion 306 to the rear portion 307 in two lengths for attachment to the rear member 303 of the frame structure 301, forming a shape similar to an X.

The X-bar 304 can be detachable from either or both of the front member 302 and/or the rear member 303, in a manner similar to the spanner bar 204 of the unit 200 of the second exemplary embodiment. In this example, the X-bar 304 is detachable from the front member 302. The X-bar 304 can be detached from the front member 302 via an X-bar release actuator 309. Alternatively, or in addition, a joint may be formed at the middle portion 306 of the X-bar 304 at the interface between the front portion 305 and the rear portion 307 such that the first portion 305 is hingedly connected or pivotable relative to the rear portion 307 which remaining connected thereto.

FIG. 16 shows the X-bar 304 of the frame structure 301 of the unit 300 of the third exemplary embodiment. The X-bar 304 includes two pins 308 (one pin 308 at the front-facing end of each length of the front portion 305 of the X-bar 304) that are translatable (e.g., extendable and retractable) relative to the front portion 305 of the X-bar 304. The pins 308 are connected to the X-bar release actuator 309 via respective cables running through the front portion 305. The X-bar release actuator 309 comprises a plunger that can be pressed into and/or withdrawn from the middle portion 306 of the X-bar 304 by a user. To attach the X-bar 304 to the front member 302 the X-bar release actuator 309 can be withdrawn from the middle portion 306, pushing the cables outward (toward the front member 302) and into the recesses of the front member 302. To release the X-bar 304 from the front member 302, the X-bar release actuator 309 is depressed into the middle portion 306, pulling the cables inward (away from the front member 302) and retracting the pins 308 from the recesses of the front member 302. When the X-bar 304 is released the unit 300 can be folded down into the collapsed state in a manner similar to that described above for the unit 200 of the second exemplary embodiment.

The unit 300 further includes a base structure 320. Similar to the base structure 224 of the second exemplary embodiment. The base structure 320 of the third exemplary embodiment comprises a top part and a bottom part that can be, for example, molded from plastic and nested together. Located in a rear portion of the bottom part is a cutout portion that contains the latch system 330 of the third exemplary embodiment. The latch system 330 of the third exemplary embodiment comprises pivoting rigid latches 332 slidably mounted to a rod 331 comprising two brackets 336 fixed around the rod 331, similarly to the latch system 240 of the unit 200 of the second exemplary embodiment. The latches 332 are slidable along the rod 331 between a first position on the first side of the unit 300 and a second position on the second side of the unit 300. The latches 332 comprise latching ends 333 configured to be attached to anchor points in the vehicle in a known manner. The latch system 330 of the third exemplary embodiment comprises a latch release actuator 340 for releasing the latches 332 from vehicle anchor points, a first latch unlock actuator 342 to allow the latches 332 to rotate into the extended position (e.g., a use position), and a second latch unlock actuator 344 to allow the latches 332 to rotate into the retracted position (e.g., a stored position).

FIGS. 17a-c show the latch system 330 on the bottom of the unit 300 of the third exemplary embodiment including a latch release actuator 340, a first latch unlock actuator 342 and a second latch unlock actuator 344. FIG. 17a shows an arrangement for a latch release actuator 340; FIG. 17b shows an arrangement for a first latch unlock actuator 342; FIG. 17c shows an arrangement for a second latch unlock actuator 344.

As shown in FIG. 17a, the latch release actuator 340 is connected to three actuator projections 341 adjacent to the rod 331 at locations along the base structure 320 where the latches 332 can be extended, e.g., adjacent to the brackets 336. The actuator projections 341 of this embodiment are connected to the latch release actuator 340, e.g., via cables, so that actuating the latch release actuator 340 (e.g., pulling the latch release actuator 340 toward the front of the unit 300 translates the actuator projections 341 toward the front of the unit 300.

Each of the latches 332 includes one or more actuator slots 334 that can couple to the actuator projections 341 when the latches 332 are in the extended position. For example, when the latches 332 are in the first position on the first side of the unit, the actuator projection 341 on the first side is received in the actuator slot 334 of the latch 332 on the first side and the actuator projection 341 in the middle is received in the actuator slot 334 of the latch 332 in the middle; and when the latches 332 are in the second position on the second side of the unit, the actuator projection 341 on the second side is received in the actuator slot 334 of the latch 332 on the second side and the actuator projection 341 in the middle is received in the actuator slot 334 of the latch 332 in the middle. When the latch release actuator 340 is actuated, the movement of the actuator projections 341 within the actuator slots 334 releases the latches 332 (e.g., the latching ends 333 thereof) from the anchor points within the vehicle. Accordingly, the latch release actuator 340 can release the latches 332 when the latches 332 are in any position (e.g., the first position or the second position).

As shown in FIG. 17b, the first latch unlock actuator 342 is connected to a projection 343 that can connect to either of the latches 332 (e.g., the latching end 333 thereof) to retain the latches 332 in the withdrawn (stored) position. The first latch unlock actuator 342 can be actuated (e.g., slid or pulled) to retract the projection 343 and unlock the latches 332 so that the latches 332 are free to rotate into the extended (use) position.

As shown in FIG. 17c, the second latch unlock actuator 344 is connected to a pin 345 that can be received in a pin receiving hole 335 of either of the latches 332 when the latches 332 are in the extended (use) position. When the pin 345 is received in the pin receiving hole 335 the latches 332 are locked in the extended position. Both latches 332 include the pin receiving hole 335, therefore, only one pin 345 is required to lock the latches 332. The second latch unlock actuator 344 can be actuated (e.g., slid or pulled) to retract the pin 345 from the pin receiving hole 335 of the latch 332 to allow the latches 332 to freely rotate, e.g., transition the latches 332 into the withdrawn position.

It will be appreciated by those skilled in the art that changes may be made to the embodiments described above without departing from the inventive concept thereof. It should further be appreciated that structural features and methods associated with one of the embodiments can be incorporated into other embodiments. It is understood, therefore, that this invention is not limited to the particular embodiment disclosed, but rather modifications are also covered within the scope of the present invention as defined by the appended claims.

### Fourth Exemplary Embodiment

FIGS. 18a-c, 19 show views of an animal containment unit 400 according to a fourth exemplary embodiment. Similar to the unit 300 of the third exemplary embodiment described above, the unit 400 of the fourth exemplary embodiment is generally six-sided (although any other arrangement that provides the desired space for containing the animal may be used) and is described with regard to a front, a rear, a first side (e.g., left side, relative to a front view), a second side (e.g., right side, relative to a front view), a bottom and a top. These sides are labeled in FIGS. 18a-c and omitted in the subsequent figures.

The unit 400 of the fourth exemplary embodiment includes a number of alternative embodiments for various features of the animal containment units 100, 200, 300. The unit 400 has certain features similar to the unit 300 described for the third exemplary embodiment, including certain aspects of the frame structure, base structure, latch system, containment materials and webbing and tether structure. The alternative embodiments described for the fourth exemplary embodiment may be implemented with the unit 300 or with other types of animal containment units and the various features described for the unit 400 can be interchanged among the embodiments in any suitable manner or may be implemented in other designs for animal containment units and the present disclosure is not limited to the specific arrangements described for the unit 400 of the fourth exemplary embodiment. FIG. 18a shows a perspective view of the unit 400; FIG. 18b shows a side view of the unit 400; FIG. 18c shows a top view of the unit 400; FIG. 19 shows a view of the unit 400 with containment materials 406 removed showing the first and second body panels 407, 408 defining an inflated shape for the unit 400.

The unit 400 comprises a frame structure 401 coupled to and supported by a base structure 405. The frame structure 401 includes a front member 402, a rear member 403, and an X-bar 404 connecting the front member 402 and the rear member 403 when the unit 400 is in the expanded state. The front member 402 and the rear member 403 of the fourth exemplary embodiment may be shaped similarly to the front member 302 and the rear member 303 of the third exemplary embodiment, respectively. The X-bar 404 may also be shaped similarly to the X-bar 304 described above for the third exemplary embodiment. The exemplary embodiments include modifications for attach/release actuation of the X-bar 404 to be described below. The unit 400 comprises containment materials 406 supported by the frame structure 401 with an exterior having an inflated shape configured to house an animal as described above.

A first body panel 407 surrounds the front member 402 on its front side and a second body panel 408 surrounds the rear member 403 on its rear side. The first and second body panels 407, 408 have a rounded shape although different spatial arrangements may also be employed. The first and second body panels 407, 408 are designed so that the X-bar 404 can suitably attach to the front and rear members 402, 403.

As noted in one or more of the previously disclosed embodiments, containment materials 406 positioned about the frame structure 401 may define the exterior and/or the interior of the unit 400. The containment materials 406 include one or more of a front 482, first side 484, second side 486, top 488, and rear 490 of the unit 400. In an embodiment, the front 482, first side 484, second side 486, top 488, and rear 490 are integrally formed as a single unit, making installation and removal of the containment materials 406 more efficient for a user.

As previously noted, one or more of the containment materials 406, such as the front 482 for example, may include a window through which an animal arranged within the interior of the unit 400 may view the outside of the unit 400 and an owner can view the interior of the unit 400. Alternatively, or in addition, one or more of the containment materials may include a material having openings formed therein, such as mesh or a screen for example, that provides visibility to the interior of the unit 400. One or more of the containment materials 406 may include an opening 494 for accessing the interior of the unit 400, e.g., to place an animal inside or remove the animal therefrom. A door 496 may be movable relative to the unit 400 to selectively seal or block a portion of the opening 494, thereby retaining an animal within the interior of the unit 400. In an embodiment, the door 496 is integrally formed with the corresponding portion of the containment materials 406. In such embodiments, the door 496 may be pivotable to selectively expose and seal the opening 494. For example, the side 484 may include a door 496 and the door 496 may be zippered relative to an adjacent portion of the side 484 to selectively seal the opening 494. In other embodiments, the door 496 is separable from the unit 400.

In some embodiments, additional soft goods may be connectable to the unit 400 to protect an animal therein in the event of a crash event or impact. In the non-limiting embodiment of FIGS. 32A and 32B, an impact absorption pad 500, such as formed from a thick foam or other cushioned material for example, is removably installable about the unit 400. As shown, the impact absorption pad 500 may be installed about the opening 494. In such embodiments, a size and shape of the impact absorption pad 500 may be complementary to the door 496 and/or the opening 494. In an embodiment, the impact absorption pad 500 is connected to the door 496 itself and therefore is movable with the door 496 relative to the unit 400. In other embodiments, the impact absorption pad 500 is directly connectable to the containment material 406, such as surrounding the opening 494. The impact absorption pad 500 may be removably connectable to containment material or the door 496 via any suitable connection mechanism(s), including but not limited to magnets, hook and loop fasteners (e.g., VelcroTM), snaps, and hook and eye fasteners for example. In an embodiment, a first portion of the connection mechanisms may be arranged about an edge or about the periphery of the impact absorption pad 500 and a second portion of the connection mechanism may be arranged about a perimeter of the door 496, or about the edge of the containment material defining the opening 494.

Alternatively, or in addition to the impact absorption pad 500, a safety net 510 may be connectable to the unit 400, such as adjacent to an opening 494 or door 496. The safety net 510 may be formed via one or more pieces of webbing 512. In the illustrated, non-limiting embodiment shown in FIGS. 33A and 33B, the webbing 512 of the safety net 510 includes a first lateral span 514a and a second lateral span 514b extendable generally between the front member 402 and/or first body panel 407 and the rear member 403 and/or second body panel 408. Although the first and second spans 514a, 514b are illustrated as being vertically offset and parallel to one another, embodiments where the first and second spans 514a, 514b are arranged at another angle are also within the scope of the disclosure. The webbing 512 may additionally include one or more cross-members 516 connected to some or each of the one or more spans 514. As shown, the at least one cross-member 516 may be oriented substantially orthogonally to the first and second spans 514a, 514b. In combination, the one or more spans 514 and the one or more cross-members 516 of the webbing 512 cooperate to sufficiently block an opening 494 to prevent an animal from being thrown from the unit 400 through the opening 494.

The safety net 510 is removably connectable to the unit 400 to allow an animal to enter or exit from the interior of the unit 400 when desired. The safety net 510 is connectable to the unit 400 in any suitable manner. In an embodiment, the safety net 510 is attachable to the unit 400 via at least one quick disconnect mechanism 520. As shown, the quick disconnect mechanism 520 may include one or more clasps, carabiners, or hooks 522 arranged at the ends of the lateral spans 514a, 514b. The quick disconnect mechanism 520 may additionally include a plurality of connectors 524, such as D-rings for example, attached to or integral with the unit 400. In the illustrated, non-limiting embodiment, the connectors 524 are rigidly mounted or attached to the frame structure 401. Some of the connectors 524 (e.g., the lower two in an exemplary embodiment) may alternatively be connected to the base structure 405. It should be appreciated that the impact absorption pad 500 and safety net 510 as illustrated and described may be suitable for use with any embodiment of an animal containment unit disclosed herein.

The latching system for the unit 400 is similar to that of the unit 300 of the third exemplary embodiment except that the latching system of the unit 400 includes a secondary latch release mechanism. In some animal containment units, when the latches are connected to the vehicle seat, they are generally released by an actuator accessible in the front of the containment unit. In some animal containment units, when the latches are not locked in place (e.g., rotational position), the actuator in the front of the unit cannot release the latches from the vehicle.

FIGS. 20a-b show a secondary latch release mechanism of the unit 400. FIG. 20a shows rigid latches 409 comprising a secondary latch release 410 with dual indicators, e.g., colored parts indicating red or green for attached/released. The latches 409 include indicator windows 411 for viewing the indicators through the latch 409. The secondary latch release 410 is configured to release the respective latch 409 from a support structure in the vehicle. The secondary latch release 410 can be included on each rigid latch 409 as a secondary release mechanism. The primary release mechanism includes a latch release actuator, such as the latch release actuator 340 shown on unit 300. It will be appreciated that the unit 400 can include either one of the latch release actuator 340and the secondary latch release 410, or both of the latch release actuator 340 and the secondary latch release 410. The secondary latch release 410 can provide a user with another way of releasing a latch 409 from the support structure in the vehicle. For example, if the latch release actuator 340 fails to release the latch 409, the user can release the latch 409 using the secondary latch release 410.

FIG. 20b shows a lead-in 412 ensuring the latch 409 is secure in a connect position. The connect position is a desired position of the latch 409 when connecting the unit 400 with the support structure of the vehicle. As shown, the latch 409 is rotated to the connect position and secured in position by the lead-in 412. The lead-in 412 can include a slanted surface, a beveled surface, or other angled surface. As the latch 409 is rotated to the connect position, contact between the latch 409 and the angled surface of the lead-in 412 causes the lead-in 412 to translate toward an unlocked position. After the latch 409 is in the connect position, the lead-in 412 can translate toward a locked position, securing the latch 409 in the connect position. In an aspect, the lead-in 412 is biased toward the locked position. To release the latch 409 from the connect position, a position release actuator 413 can be actuated. When the position release actuator 413 is actuated, the lead-in 412 is transitioned from the locked position to the unlocked position, allowing the latch 409 to rotate out of the connect position.

Additionally, the latches 409 can be projected from the base 405 at angles different than directly rearward (relative to, e.g., the base 405 of the unit 400), as described in previous embodiments. As would be understood by those skilled in the art, a steeper latch angle may facilitate latching the unit 400 despite variations in vehicle latches and seat angles and can help the unit 400 to stay level in the vehicle despite variations in seat geometry. FIGS. 21a-b show a steep latch angle of the unit 400. FIG. 21a shows a side view of the latch 409 extending at an angle from the base 405. FIG. 21b shows an angle of the unit 400 installed in an exemplary vehicle.

The X-bar 404 can be designed for improved crash dynamics and improved customer set up. The X-bar 404 includes an actuator 413 to release the X-bar 404 from the front member 402 or the rear member 403 to, e.g., collapse the unit, as described in the previous embodiments above.

FIGS. 22a-e show an actuator 413 configured to release the X-bar 404 from the frame structure 401, e.g., the front member 402 and/or the rear member 403. The X-bar 404 of this embodiment includes a release actuator 413 on one or both members. In this example, the actuator 413 is attached to a first portion 414 of the X-bar 404 attached to the frame structure 401, as opposed to the middle portion 415 of the bar. FIGS. 22a-b show views of the X-bar 404 including the actuator 413 comprising two pins 416 configured to be received in correspondingly shaped holes 418 on the ends 417 of the middle portion 415 of the X-bar 404. FIG. 22c shows the ends 417 of the middle portion 415 of the X-bar 404 separated from the actuator 413 and the first portion 414 of the X-bar 404 attached to the frame structure 401. FIG. 22d shows the ends 417 of the middle portion 415 of the X-bar 404 attached to the frame structure 401 via the pins 416. FIG. 22e shows a ramped surface 419 of the pins 416 for auto-lock with the holes 418 on the ends 417.

Further features are added to the unit 400 to improve its portability and enhance user experience.

FIGS. 23a-b show a flexible folding lock 420 fixed to the base 405 of the unit 400 and attachable to a portion of the containment materials 406 when the unit 400 is collapsed. FIG. 23a shows the lock 420 attached to the containment materials 406. The lock 420 is rotatably fixed to the base 405 via a pin. The lock 420 can be made of Hytrel 4069. FIG. 23b shows the lock 420 detached from the containment materials 406 and in a storage position to be used when not in use.

FIGS. 23c-e show another aspect for a flexible folding lock 420′ fixed to a portion of the containment materials 406 and attachable to the base 405 of the unit 400 when the unit 400 is collapsed. The lock 420′ includes a protrusion 431′ that connects with a corresponding recess 433′ located on the base 405. The protrusion 431′ can be positioned within the recess 433′ to lock the unit 400 in the storage position.

FIGS. 23f-g show another aspect for a flexible folding lock 420″ fixed to a portion of the containment materials 406 and attachable to the base 405 of the unit 400 when the unit 400 is collapsed. The lock 420″ can include a recess 433″ and the base 405 can include a corresponding protrusion 431″. The protrusion 431′ can be positioned within the recess 433′ to lock the unit 400 in the storage position.

FIGS. 23h-j show another aspect for a flexible folding lock 420″′ fixed to a portion of the containment materials 406 and attachable to the base 405 of the unit 400 when the unit 400 is collapsed. The lock 420′″ includes a protrusion 431″′ that connects with a corresponding notch or recess 433″′ located on the base 405.

FIGS. 24a-b show a handle 421 on the front of the unit 400 for carrying the unit 400. The handle 421 can be attached to the base 405 or to the containment materials 406. The handle 421 can be part of the webbing and tether system of the unit 400.

FIGS. 25a-b show a foot 422 on the base 405 that allows the unit 400 to stand upright.

FIGS. 24c-d show the handle 421 connected to a front portion of the base 405. Ends of the handle 421 can extend through first and second openings 435 and 437 defined by the base 405 and into an interior of the base 405. A gripping portion 436 of the handle 421 is positioned on an exterior of the base 405 for gripping by a user. Each respective end of the handle 421 can connect with a corresponding boss 438 and 440 on the interior of the base 405 to secure the handle 421 to the base 405.

In some animal containment units, it is difficult to replace the containment materials. Thus, additional features were added to the unit 400 to facilitate the removal and replacement of the containment materials 406. Furthermore, as would be understood by those skilled in the art, the removability of the containment materials 406 also allows the user to remove the containment materials 406 for cleaning after which the same containment materials 406 may be replaced on the unit 400.

FIGS. 26a-c show a progression of steps for removing the containment materials 406 from the unit 400. FIG. 26a shows the containment materials 406 (with the frame structure 401 underneath) and top portion 423 of the base 405 lifted off a bottom portion 424 the base 405. FIG. 26b shows boards 425 (e.g., formed of polyethelene (PE)) with holes on the bottom edges of the containment materials 406 being unhooked from the top portion 423 of the base 405. FIG. 26c shows the containment materials 406 being lifted off the frame structure 401 and top portion 423 of the base 405.

FIGS. 27a-b show details for removing the containment materials 406 from the unit 400. FIG. 27a shows a bottom view of the base 405 (bottom portion 424). The bottom portion 424 of the base 405 includes a number of screws, e.g., 8 screws, for attaching to the top portion 423. The user may remove these 8 screws and lift the top portion 423, the frame structure 401 and the containment materials 406 off the bottom portion 424. FIG. 27b shows a view of the top portion 423 of the base 405, the frame structure 401 and the containment materials 406 lifted off of the bottom portion 424. The user can then disconnect the webbing and tether structure 426 from the bottom portion 424. The bottom portion 424 can include PE board 427 to cover components in the bottom portion 424.

In the non-limiting embodiment of FIG. 27b, the webbing and tether structure includes webbing having two tethers or spans (e.g., a first tether 426a and a second tether 426b) that extend from front attachment points 530, such as at the bottom portion 424. In some embodiments, such as shown in FIGS. 34a and 35a, one or more cross-members 532 extend between and are connected to the first and second tethers 426a, 426b.

FIGS. 29-30 show tether guides 470 and 472 connected to the frame structure 401. In an aspect, the tether guides 470 and 472 are connected on a top portion of the front member 402. The tether guides 470 and 472 can receive the tethers 426 to align the tethers 426 on the unit 400 and to keep the tethers 426 in place. The tether guides 470 and 472 can also help reduce loading on the front member 402 when an outward force is applied to the front of the unit 400 during, for example, a collision. Accordingly, each of the first and second tethers 426a, 426b may extend from the base 405, wrap about the front 482 of the containment materials 406, through the tether guides 470 and 472, and connect to the tether disconnect 450. In some embodiments, the first and second tethers 426a, 426b are integrally formed via a single piece of webbing such that a handle, such as handle 421 for example, is formed by the tethers 426 adjacent to the top of the unit 400. In other embodiments, the distal end of the tethers 426a, 426b are connectable via a tether disconnect 450.

FIGS. 28a-c and FIG. 34a-b show a tether disconnect 450 connected between the tethers 426 and a vehicle seat 451. The tether disconnect 450 can include a first connector 452, a second connector 454, a first tether portion 456, and a second tether portion 458. The first and second connector 452 and 454 can be connected to ends of the first tether portion 456. The first and second connectors 452 and 454 can detachably connect to corresponding first and second connectors 460 and 462 connected on ends of tethers 426. The detachable connection between the tether disconnect 450 and the tethers 426 allows a user to quickly disconnect the unit 400 from the vehicle seat 451. The first and second connectors 452 and 454 of the tether disconnect 450 and the first and second connectors 460 and 462 of the tethers 426 can include, for example, strap buckles, side-release buckles, snap clips, bolt snaps, carabiners, or other type of connector to quickly and securely attach the tethers 426 to the tether disconnect 450.

Referring now to FIGS. 36 and 37, an example of a connector 452, 454 of the tether disconnect 450 is illustrated. Also shown is a connector 460, 462 of the tethers 426 configured to couple to a respective connector 452, 454. The connectors 452, 454 may include a housing 540 and an end of the first tether portion 456 of the tether connector 450 may be coupled thereto. A buckle tongue 542 may be contained by and protrude beyond an end 544 of the housing 540, such as opposite from the end 546 that receives the first tether portion 456 of the tether connector 450 for example. In an embodiment, an opening or groove 548 is formed in a portion of the buckle tongue 542 external to the housing 540.

The connector 460, 462 of the tether 426 may similarly include a housing 550 to which an end of the tether 426 is connected. In an embodiment, the housing 550 includes an opening 552 extending inwardly from an end 554 of the housing 550, such as opposite from the end that receives the tether 426. The opening 552 may be sized such that the buckle tongue 542 is insertable therein. An engagement member 556, such as arranged within the housing 550, may be receivable within the opening 552 formed in the buckle tongue 542 to couple the buckle tongue 542 to the housing 550. The engagement member 556 may be resilient or may be operably coupled to a biasing member 558 such that the engagement member 556 is movable to selectively engage the opening 552 of the buckle tongue 542. In the illustrated, non-limiting embodiment, the engagement member 556 protrudes at an angle towards the area within which the buckle tongue 542 is received. Accordingly, as the buckle tongue 542 is inserted into the housing 550, the buckle tongue 542 contacts and applies a force to the engagement member 556 opposing its bias. As a result, the engagement member 556 deflects away from or out of the path of movement of the buckle tongue 542. Once the buckle tongue 542 reaches a position where the opening 548 is aligned with the engagement member 556, the force opposing the bias of the engagement member 556 is removed. As a result, the engagement member 556 will bias back to its original position and the engagement between the engagement member 556 and the opening 548 will restrict movement of the buckle tongue 542 away from the connector 460, 462.

The connector 460, 462 may additionally include an actuator 560, such as a button for example, operable to selectively oppose the bias of the engagement member 556, such as to disconnect the connector 452, 454. In the illustrated, non-limiting embodiment, the actuator 560 is movable in a direction oriented perpendicular to the direction of movement of the buckle tongue 542. Such movement allows for the buckle interface to have a more compact profile. However, embodiments where the actuator 560 is movable in another manner or direction, for example where the actuator is rotatable, are also within the scope of the disclosure. An operator can operate the actuator 560, which in turn will move the engagement member 556 out of engagement with the buckle tongue 542. In such a position, the buckle tongue 542 is freely movable, and therefore may be separated or disconnected from the connector 460, 462. It should be appreciated that the interface between the connectors 452, 454 and the connectors 460, 462 illustrated and described herein is intended as an example only and that any removably couplable interface is contemplated herein.

The first tether portion 456 can be slidably connected to the second tether portion 458. The slidable connection between the first and second tether portion 456 and 458 allows the tether disconnect 450 to “self-center” when the tether disconnect 450 connects the unit 400 to the vehicle seat 451. For example, with reference to FIGS. 28b and 28c, when the tether disconnect 450 is connected to the vehicle seat 451 along an axis offset from a central axis of the unit 400, the slidable connection allows the first tether portion 456 to move to a position relative to the second tether portion 458 to maintain a taut connection between the first tether portion 456 and the tethers 426.

When the tether disconnect 450 is disconnected from the tethers 426, the tether disconnect 450 can remain in the vehicle, while the unit 400 is removed from the vehicle. During installation, the unit 400 can be placed on the vehicle seat 451, the latches 409 can be connected to the vehicle support structure, and the tether disconnect 450 can be connected to the tethers 426. The tether disconnect 450 facilitates installation by not requiring the user to connect the tethers 426 direction to the vehicle seat 451 every time the unit 400 is installed in the vehicle. In an aspect, when the first and second connectors 460 and 462 on the ends of the tethers 426 are disconnected from the tether disconnect 450, the first and second connectors 460 and 462 can be connected to respective connectors (not shown) on the containment materials 406. The connection of the connectors 460 and 462 to the containment materials 406 can prevent the tethers from moving around during transport outside of the vehicle and can help prevent potential strangulation issues.

FIGS. 29 and 31 show step members 476 and 478 positioned on the base 405. The step members 476 and 478 can be formed as part of the base 405, or alternatively, can be connected and secured to the base 405. The step members 476 and 478 can tailor the containment materials 406 to form the first and second sides of the unit 400. The step members 476 and 478 can also hold side door flaps (not shown) of the containment materials 406 in place and provide support for an outer wall of the base 405.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A unit for containing animals on a seat of a vehicle, comprising:
a base structure including a base, the base including a front portion and a rear portion;
a frame structure including:
a front member coupled to the front portion of base;
a rear member coupled to the rear portion of the base; and
containment materials extending at least partially about the frame structure; and
a webbing structure comprising at least first and second spans of webbing, each of the spans comprising a first end coupled to a respective first anchor point defined by the base structure, the spans extending from the respective first anchor point about an exterior of the frame structure and wrapping around the front member to respective second ends of the spans, the second end of each of the spans being configured to couple to a rigid connection on or adjacent to the seat of the vehicle so that the webbing extends about the frame structure along a desired path configured to restrain a pet contained within the unit.

2. The unit of claim 1, wherein the front member comprises a first end coupled to the front portion of the base on a first side and a second end coupled to the front portion of the base on a second side, the front member of the frame structure being shaped in a curve to define in part a front of the unit and define in part a top of the unit and the rear member comprises a first end coupled to the rear portion of the base on the first side and a second end coupled to the rear portion of the base on the second side, the rear member of the frame structure being shaped in a curve to define in part a rear of the unit and define in part the top of the unit, wherein the spans extend along a top portion of the containment materials covering the top of the unit to a second end coupled to a second anchor point.

3. The unit of claim 1, wherein the base structure further includes a base frame mounted to the base and wherein the base frame includes a front member and the first ends of the spans of webbing are coupled to the front member of the base frame interior to the base.

4. The unit of claim 3, wherein the first ends of the spans of webbing are sewn to the front member of the base frame.

5. The unit of claim 3, wherein the containment materials include front containment materials defining in part the front of the unit and supported at least in part by the front member of the frame structure, a front potion of the containment materials covering the front of the unit, the front portion of the containment materials comprising an exterior surface and an interior surface, the unit further including a top portion of the containment materials covering the top of the unit and supported at least in part by the front member and the rear member of the frame structure.

6. The unit of claim 5, where the spans of webbing are woven through at least part of the front containment materials so that a portion the spans are exterior to the exterior surface of the front containment materials and a further portion of the spans are interior to the exterior surface of the front containment materials.

7. The unit of claim 6, wherein the containment materials comprise at least two layers and the spans of webbing are woven through a first one of the layers and are not woven through a second one of the layers.

8. The unit of claim 3, wherein the spans wrap around an exterior surface of the front member of the base frame.

9. The unit of claim 1, wherein the frame structure further comprises:
a first middle member and a second middle member, each comprising a first end coupled to the front member and a second end coupled to the rear member, the first and second middle members being exterior to an exterior surface of the containment materials, and wherein the first span of webbing extends across the exterior surface of the containment materials along the first middle member and the second span of webbing extends across the exterior surface of the containment materials along the second middle member.

10. The unit of claim 9, wherein the first middle members and the second middle member of the frame structure each include ring structures through which the spans of webbing are run.

11. The unit of claim 10, wherein the first middle members and the second middle member of the frame structure each comprise a front middle member and a rear middle member detachable via a sliding actuator, the sliding actuator being translatable between a first position, where the sliding actuator is slid over the front middle member and detaches from the rear middle member, and a second position, where the sliding actuator is slid over the rear middle member and attaches the front middle member and the rear middle member, and wherein, when the sliding actuator is translated, the ring structures of the sliding actuator slide over the spans of webbing.

12. The unit of claim 1, further comprising:
a tether structure comprising at least two spans, each of the spans of the tether structure comprising a first end coupled to the rear member, the second ends of the spans joining together at a joint, the tether structure further comprising a unitary span extending from a first end at the joint to a second end on which a tether latch is adjustably positioned,
wherein the tether latch is configured to attach to the rigid connection on or adjacent to the seat of the vehicle.

13. The unit of claim 12, wherein the first ends of the spans of the tether structure are adjacent to the second ends of the spans of webbing.

14. The unit of claim 12, wherein the first ends of the spans of the tether structure are sewn around the rear member.

15. The unit of claim 9, wherein the first ends of the spans of webbing are coupled to rigid brackets at the rear portion of the base.

16. The unit of claim 15, wherein the spans extend from the first end interior to the base structure, wrap around a front portion of the base structure and continue exterior to the exterior surface of a front portion of the containment materials covering the front of the unit.

17. The unit of claim 1, wherein the rigid connection on or adjacent to the seat of the vehicle is a first rigid connection, the unit further comprising:
latches coupled to the frame structure, the latches being configured to couple the frame structure to a second rigid connection on or adjacent to the seat of the vehicle.

18. The unit of claim 17, wherein the second rigid connection is spaced from the first rigid connection.

19. The unit of claim 1, wherein the second ends of the first and second spans of webbing are configured to directly couple to the rigid connection on or adjacent to the seat of the vehicle.

20. A unit for containing animals on a seat of a vehicle, comprising:
a base structure including a base, the base including a front portion and a rear portion; and
a frame structure that transitions between an expanded state and a collapsed state, the frame structure including:
a front member comprising a first end and a second end, the first and second ends of the front member being rotatably coupled to the front portion of the base, the front member being shaped to define in part a front of the unit and define in part a top of the unit when the frame structure is in the expanded state,
a rear member comprising a first end and a second end, the first and second ends of the rear member being rotatably coupled to the rear portion of the base, the rear member being shaped to define in part a rear of the unit and define in part the top of the unit when the frame structure is in the expanded state,
at least one middle member comprising a first end rotatably coupled to either the front member or the rear member via a rotating joint and a second end that, when the frame structure is in the expanded state, is attached to a corresponding part of the frame structure such that a connection is made between the front member and the rear member via the at least one middle member and, when the frame structure is to be transitioned into the collapsed state, the front member and the rear member are rotated to a collapsed position in which the at least one middle member is within or substantially flush with the front member or the rear member.

21. The unit of claim 20, wherein when the frame structure is to be transitioned into the collapsed state, the second end of the at least one middle member is detached from the corresponding part of the frame structure.

22. The unit of claim 20, wherein the at least one middle member comprises two middle members, each comprising a front middle member and a rear middle member detachable via a sliding actuator, the sliding actuator being translatable between a first position in which the sliding actuator is slid over the front middle member and detached from the rear middle member, and a second position in which the sliding actuator is slid over the rear middle member and to attach the front middle member to the rear middle member.

23. The unit of claim 22, wherein the sliding actuator comprises a first opening and a second opening for receiving a button extending off an exterior of the front middle member, wherein, in the first position, the button is received in the first opening and, in the second position, the button is received in the second opening.

24. The unit of claim 20, further comprising:
a first front rotating actuator rotatably coupled to the front portion of the base on a first side, a second front rotating actuator rotatably coupled to the front portion of the base on a second side, a first rear rotating actuator rotatably coupled to the rear portion of the base on the first side, and a second rear rotating actuator rotatably coupled to the rear portion of the base on the second side.

25. The unit of claim 24, wherein, after the at least one middle member is brought to the collapsed position, the first and second front rotating actuators are rotated to a stowed position in which the front member is within or flush with the base structure or with the rear member and the first and second rear rotating actuators are rotated to bring the rear member within or flush with the base structure or with the front member.

26. The unit of claim 24, wherein the first and second rear rotating actuators are positioned relative to the base higher than the first and second front rotating actuators so that, when the frame structure is in the collapsed state, the rear member lies flush on top of the front member.

27. The unit of claim 24, wherein the first and second front rotating actuators are lockable in a first position in which the front member of the frame structure extends orthogonally to the base and a second position in which the front member extends parallel to the base and wherein the first and second rear rotating actuators are lockable in a first position in which the rear member of the frame structure extends orthogonally to the base and a second position and wherein the rear member extends parallel to the base.

28. The unit of claim 20, wherein the at least one middle member is detachable from either the front member or the rear member while remaining attached to the other one of the front member or the rear member so that the at least one middle member can be rotated with the rotating joint.

29. The unit of claim 28, wherein the at least one middle member is detachable from either the front member or the rear member via a release actuator mounted to the at least one middle member.

30. The unit of claim 29, wherein the release actuator withdraws at least one pin extending off the at least one middle member from a corresponding recess in the front member or the rear member.

31-92. (canceled)
